(19) United States
(12) Patent Application Publication
(10) Pub. No.: US 2018/0338120 A1
(43) Pub. Date: Nov. 22, 2018

(54) INTELLIGENT EVENT SUMMARY, NOTIFICATIONS, AND VIDEO PRESENTATION FOR AUDIO/VIDEO RECORDING AND COMMUNICATION DEVICES

(71) Applicant: Amazon Technologies, Inc., Seattle, WA (US)

(72) Inventors: Elliott Lemberger, Santa Monica, CA (US); John Modestine, Los Angeles, CA (US); Michael Jason Mitura, Los Angeles, CA (US)

(21) Appl. No.: 15/986,376

(22) Filed: May 22, 2018

Related U.S. Application Data
(60) Provisional application No. 62/618,522, filed on Jan. 17, 2018.
(60) Provisional application No. 62/509,712, filed on May 22, 2017.

(51) Int. Cl. H04N 7/18; G06K 9/00

(52) U.S. Cl. CPC H04N 7/186; H04N 7/188; G06K 2009/00738; G06K 9/00771; G06K 9/00362; G06K 9/00718

(57) ABSTRACT

A plurality of events may be captured by a set of audio/video (A/V) recording and communication devices. First video data of a first event and second video data of a second event may be received. The first video data and the second video data may be analyzed to determine characteristics associated with the first video data and the second video data. The first event and the second event may be prioritized based on the characteristics determined from the analysis of the first video data and the second video data to create an ordered list. The ordered list may include a first list entry that corresponds to the first event and a second list entry that corresponds to the second event. The ordered list may then be transmitted to a client device for display on a display of the client device.

### CROSS-REFERENCE TO RELATED APPLICATIONS

This application claims priority to provisional application Ser. No. 62/618,522, filed on Jan. 17, 2018, and provisional application Ser. No. 62/509,712, filed on May 22, 2017, the entire contents of which are hereby incorporated by reference

### TECHNICAL FIELD

The present embodiments relate to audio/video (A/V) recording and communication devices, including A/V recording and communication doorbells and A/V recording and communication security cameras. In particular, the present embodiments relate to improvements in the functionality of A/V recording and communication devices that strengthen the ability of such devices to reduce crime and enhance public safety.

### BACKGROUND

Home security is a concern for many homeowners and renters. Those seeking to protect or monitor their homes often wish to have video and audio communications with visitors, for example, those visiting an external door or entryway. Audio/Video (A/V) recording and communication devices, such as doorbells and security cameras, provide this functionality, and can also aid in crime detection and prevention. For example, audio and/or video captured by an A/V recording and communication device can be uploaded to the cloud and recorded on a remote server. Subsequent review of the A/V footage can aid law enforcement in capturing perpetrators of home burglaries and other crimes. Further, the presence of one or more A/V recording and communication devices on the exterior of a home, such as a doorbell unit at the entrance to the home, acts as a powerful deterrent against would-be burglars.

### SUMMARY

The various embodiments of the present intelligent event summary, notifications, and video presentation for audio/video (A/V) recording and communication devices have several features, no single one of which is solely responsible for their desirable attributes. Without limiting the scope of the present embodiments as expressed by the claims that follow, their more prominent features now will be discussed briefly. After considering this discussion, and particularly after reading the section entitled “Detailed Description,” one will understand how the features of the present embodiments provide the advantages described herein.

One aspect of the present embodiments includes the realization that conventional methods of presenting events generated by one or more A/V recording and communication devices (e.g., to a user) do not analyze the content of the events, and do not attempt to determine, based on the content analysis, whether any of the events are more important (or less important) to the user. For instance, conventional methods present events recorded by the A/V recording and communication device(s) in a chronological list, typically with the most recent event at the top of the list. This conventional presentation method treats all events equally, without considering whether some of the events may be of greater interest to the user than others. Consequently, events of greater importance may get lost in the process, and may not even be noticed by the user. The present embodiments solve this problem by analyzing the content of the video footage associated with each event and/or data associated with the video footage, and then generating and/or applying a set of rules to rank the events relative to one another. The ranked events are then presented to the user as an ordered list in decreasing order of interest or importance to the user (e.g., with the most interesting/important event at the top of the list). The user is thus more likely to notice important events, because they are presented more prominently in the ordered list. The set of rules may be defined by the user and/or by the system. Certain of the present embodiments may learn dynamically which events, such as which types or classes of events, are typically of greatest interest or importance to the user, and adjust the set of rules (and/or adjust the application of the set of rules) accordingly so that the ranking process may improve with each iteration.

Another aspect of the present embodiments includes the realization that conventional methods of providing event notifications (e.g., alerts sent to a client device of a user) provide the same type of notification every time a triggering event occurs (e.g., when an event is captured by an A/V recording and communication device). Conventional methods do not consider that some events may be more urgent, and/or may be of greater interest to the user, than others. Consequently, notifications for urgent or important events may get lost in the process, and may not even be noticed by the user, or may only be noticed after significant time has passed, by which time the event may no longer be urgent or important.

The present embodiments solve this problem by generating an alert type for each event based on a set of rules, where events that are more urgent and/or more likely to be of interest or to be considered important by the user are assigned an alert type that is designed to be more likely to be noticed by the user. The user is thus more likely to receive urgent or important notifications in a timely manner. The set of rules may be defined by the user and/or by the system. Certain of the present embodiments may learn dynamically which events, such as which types or classes of events, are typically of greatest interest or importance to the user, and adjust the set of rules accordingly so that the process of assigning an alert type to each event may improve with each iteration.

Another aspect of the present embodiments includes the realization that conventional methods of presenting video streams from multiple cameras (e.g., cameras of different A/V recording and communication devices) do not consider that some video streams may be more urgent, and/or may be of greater interest to the user, than others. Consequently, video streams that contain urgent or important content may get drowned out by video streams that contain little, if any, urgent or important content. Further, when multiple video streams are transmitted and/or presented simultaneously, bandwidth limitations may degrade the quality of one or more of the video streams, or may prevent any of the streams from being presented at all.

The present embodiments solve these problems by prioritizing the video streams based on a set of rules, and then transmitting and/or presenting the video streams according to their relative priorities. The set of rules may assign higher priority to video streams that are more urgent and/or more likely to be of interest or to be considered important by the user, and assign lower priority to video streams that are less urgent and/or less likely to be of interest or to be considered important by the user. The user is thus more likely to notice urgent or important video streams, and problems caused by bandwidth limitations may be avoided. The set of rules may be defined by the user and/or by the system. Certain of the present embodiments may learn dynamically which video streams, such as video streams containing certain types or classes of events or people, are typically of greatest interest or importance to the user, and adjust the set of rules accordingly so that the process of prioritizing the video streams may improve with each iteration.

The present embodiments further solve the problems outlined above by generating one or more rules based on user interactions with image data generated by one or more A/V recording and communication devices. The interactions may include, for example, playing a video, pausing a video, stopping a video, restarting a video, sending a storage location indicator corresponding to the video from the client device, downloading a video, sharing a video, posting a video to a social network, interacting with an application of the client device, and/or deleting the video. These interactions may be from one specific user, from multiple users utilizing the same client device, and/or multiple users each utilizing their own client device. Image data may be displayed in an order based on the one or more rules, and communications may be sent to client devices that include storage location indicators, such as links, to videos selected based on prioritization determined based on the one or more rules.

In a first aspect, a network device is communicatively coupled to one or more audio/video (A/V) recording and communication devices, each of the one or more A/V recording and communication devices having a camera, the network device comprising: a communication module; one or more processors; and a non-transitory machine-readable memory storing a program, the program executable by at least one of the one or more processors, the program comprising instructions for: in response to one or more of the A/V recording and communication devices generating first image data, receiving, using the communication module, the first image data generated by the cameras of the one or more A/V recording and communication devices; generating, in response to the cameras of the one or more A/V recording and communication devices generating the first image data, user alerts including the first image data; transmitting, using the communication module, the user alerts to a client device associated with the one or more A/V recording and communication devices; receiving, using the communication module and from the client device, input data associated with at least one of the first image data and the user alerts, the input data representing one or more user interactions with the at least one of the first image data and the user alerts; analyzing the input data to generate one or more rules configured to prioritize the first image data accessible by the client device; in response to one of the one or more A/V recording and communication devices generating second image data, receiving, using the communication module, the second image data generated by the cameras of the one of the one or more A/V recording and communication devices; ranking, based on the one or more rules, the second image data with respect to the first image data; transmitting, using the communication module and to the client device, ranking data configured to cause a first indicator associated with the second image data to be prioritized over one or more second indicators associated with the first image data.

In an embodiment of the first aspect, the one or more A/V recording and communication devices include a first A/V recording and communication device associated with the client device and a second A/V recording and communication device not associated with the client device.

In another embodiment of the first aspect, the program further comprises instructions for determining that the first image data includes at least one similarity to the second image data.

In another embodiment of the first aspect, the first image data includes a duration and wherein a rule of the one or more rules is based on an amount of the duration of the first image data displayed by the client device.

In another embodiment of the first aspect, a rule of the one or more rules is based on a number of times the first image data is displayed by the client device.

In another embodiment of the first aspect, a rule of the one or more rules is based on a number of times a storage location indicator corresponding to the first image data is sent from the client device.

In another embodiment of the first aspect, a rule of the one or more rules is based on a determination that the first image data has been downloaded to the client device or another device associated with the client device.

In another embodiment of the first aspect, a rule of the one or more rules is based on a determination that at least one of the first image data and a storage location indicator corresponding to the first image data is posted to a social network.

In another embodiment of the first aspect, a rule of the one or more rules is based on a determination that an application associated with display of the first image data receives additional user input after the first image data is displayed.

In another embodiment of the first aspect, a rule of the one or more rules is based on a determination that the first image data is deleted from the client device.

In another embodiment of the first aspect, a rule of the one or more rules is based on a determination that the first image data has not been displayed by the client device.

In another embodiment of the first aspect, the program further comprises instructions for: determining, based on data indicating a location of an object within the first image data, a classification associated with the first image data; and wherein a rule of the one or more rules is based on the classification.

In another embodiment of the first aspect, the program further comprises instructions for: determining, based on data indicating detection of motion in a zone associated with at least one of the one or more the A/V recording and communication devices, a classification associated with the first image data; and wherein a rule of the one or more rules is based on the classification.

In another embodiment of the first aspect, the program further comprises instructions for: determining, based on data indicating a time of day at which the first image data was generated, a classification associated with the first image data; and wherein a rule of the one or more rules is based on the classification.

In another embodiment of the first aspect, the program further comprises instructions for: determining, based on data indicating an amount of time that motion was detected by at least one of the one or more A/V recording and communication devices, a classification associated with the first image data; and wherein a rule of the one or more rules is based on the classification.

In another embodiment of the first aspect, the program further comprises instructions for: determining, based on weather data indicating at least one of a temperature, presence of rain, presence of snow, presence of sun, and presence of clouds at a location associated with at least one of the one or more A/V recording and communication devices, a classification associated with the first image data; and wherein a rule of the one or more rules is based on the classification.

In another embodiment of the first aspect, the program further comprises instructions for: determining, based on data indicating an event type associated with an event causing the first image data to be displayed, a classification associated with the first image data; and wherein a rule of the one or more rules is based on the classification.

In another embodiment of the first aspect, the program further comprises instructions for: determining, based on a user profile associated with the client device, a classification associated with the first image data; and wherein a rule of the one or more rules is based on the classification.

In another embodiment of the first aspect, a rule of the one or more rules is based on scheduling data indicating that at least one of the user alerts was transmitted during a period of time corresponding to an appointment that is located away from a location associated with at least one of the one or more A/V recording and communication devices.

In another embodiment of the first aspect, the program further comprises instructions for: determining a classification associated with a first portion of the first image data; selecting at least a second portion of the first image data based on the first portion of the first image data being associated with the classification; and transmitting, using the communication module and to the client device, a communication including storage location indicators associated with the second portion of the first image data.

In another embodiment of the first aspect, the program further comprises instructions for: identifying, based on the first image data, an object depicted in the first image data; determining that the object is located at a location outside a predefined zone of a field of view of a camera, of the cameras, that generated the first image data; determining that the object has been prioritized over at least one other object; and transmitting, using the communication module and to the client device, data representing a request to modify the predefined zone to include the location.

In another embodiment of the first aspect, the transmitting the data is based on the number of times the object is detected outside the predefined zone being above a threshold number of times.

In another embodiment of the first aspect, the program further comprises instructions for: identifying, based on the first image data, an object depicted in the first image data; determining that the object is located at a location within a predefined zone of a field of view of a camera, of the cameras, that generated the first image data; determining that at least one other object is prioritized over the object; and transmitting, using the communication module and to the client device, data representing a request to modify the predefined zone to exclude the location.

In a second aspect, a method for use with one or more audio/video (A/V) recording and communication devices, each of the one or more A/V recording and communication devices having a camera, comprises: in response to one or more of the A/V recording and communication devices generating first image data, receiving the first image data generated by the cameras of the one or more A/V recording and communication devices; generating, in response to the cameras of the one or more A/V recording and communication devices generating the first image data, user alerts including the first image data; transmitting the user alerts to a client device associated with the one or more A/V recording and communication devices; receiving, from the client device, input data associated with at least one of the first image data and the user alerts, the input data representing one or more user interactions with the at least one of the first image data and the user alerts; analyzing the input data to generate one or more rules configured to prioritize the first image data accessible by the client device; in response to one of the one or more A/V recording and communication devices generating second image data, receiving the second image data generated by the cameras of the one of the one or more A/V recording and communication devices; analyzing at least the second image data using the one or more rules; ranking, based on the analyzing, the second image data with respect to additional image data; transmitting, to the client device, ranking data configured to cause a first indicator associated with the second image data to be prioritized over one or more second indicators associated with the additional image data.

In an embodiment of the second aspect, the additional image data comprises at least one of the first image data and third image data generated by the cameras of the one or more A/V recording and communication devices.

In another embodiment of the second aspect, the one or more A/V recording and communication devices include a first A/V recording and communication device associated with the client device and a second A/V recording and communication device not associated with the client device.

In another embodiment of the second aspect, the method further comprises determining that the first image data includes at least one similarity to the second image data.

In another embodiment of the second aspect, the first image data includes a duration and wherein a rule of the one or more rules is based on an amount of the duration of the first image data displayed by the client device.

In another embodiment of the second aspect, a rule of the one or more rules is based on a number of times the first image data is displayed by the client device.

In another embodiment of the second aspect, a rule of the one or more rules is based on a number of times a storage location indicator corresponding to the first image data is sent from the client device.

In another embodiment of the second aspect, a rule of the one or more rules is based on a determination that the first image data has been downloaded to the client device or another device associated with the client device.

In another embodiment of the second aspect, a rule of the one or more rules is based on a determination that at least one of the first image data and a storage location indicator corresponding to the first image data is posted to a social network.

In another embodiment of the second aspect, a rule of the one or more rules is based on a determination that an application associated with display of the first image data receives additional user input after the first image data is displayed.

In another embodiment of the second aspect, a rule of the one or more rules is based on a determination that the first image data is deleted from the client device.

In another embodiment of the second aspect, wherein a rule of the one or more rules is based on a determination that the first image data has not been displayed by the client device.

In another embodiment of the second aspect, the method further comprises: determining, based on data indicating a location of an object within the first image data, a classification associated with the first image data; and wherein a rule of the one or more rules is based on the classification.

In another embodiment of the second aspect, the method further comprises: determining, based on data indicating detection of motion in a zone associated with at least one of the one or more the A/V recording and communication devices, a classification associated with the first image data; and wherein a rule of the one or more rules is based on the classification.

In another embodiment of the second aspect, the method further comprises: determining, based on data indicating a time of day at which the first image data was generated, a classification associated with the first image data; and wherein a rule of the one or more rules is based on the classification.

In another embodiment of the second aspect, the method further comprises: determining, based on data indicating an amount of time that motion was detected by at least one of the one or more A/V recording and communication devices, a classification associated with the first image data; and wherein a rule of the one or more rules is based on the classification.

In another embodiment of the second aspect, the method further comprises: determining, based on weather data indicating at least one of a temperature, presence of rain, presence of snow, presence of sun, and presence of clouds at a location associated with at least one of the one or more A/V recording and communication devices, a classification associated with the first image data; and wherein a rule of the one or more rules is based on the classification.

In another embodiment of the second aspect, the method further comprises: determining, based on data indicating an event type associated with an event causing the first image data to be displayed, a classification associated with the first image data; and wherein a rule of the one or more rules is based on the classification.

In another embodiment of the second aspect, the method further comprises: determining, based on a user profile associated with the client device, a classification associated with the first image data; and wherein a rule of the one or more rules is based on the classification.

In another embodiment of the second aspect, a rule of the one or more rules is based on scheduling data indicating that at least one of the user alerts was transmitted during a period of time corresponding to an appointment that is located away from a location associated with at least one of the one or more A/V recording and communication devices.

In another embodiment of the second aspect, the method further comprises: determining a classification associated with a first portion of the first image data; selecting at least a second portion of the first image data based on the first portion of the first image data being associated with the classification; and transmitting, to the client device, a communication including storage location indicators associated with the second portion of the first image data.

In another embodiment of the second aspect, the method further comprises: identifying, based on the first image data, an object depicted in the first image data; determining that the object is located at a location outside a predefined zone of a field of view of a camera, of the cameras, that generated the first image data; determining that the object has been prioritized over at least one other object; and transmitting, to the client device, data representing a request to modify the predefined zone to include the location.

In another embodiment of the second aspect, the transmitting the data is based on the number of times the object is detected outside the predefined zone being above a threshold number of times.

In another embodiment of the second aspect, the method further comprises: identifying, based on the first image data, an object depicted in the first image data; determining that the object is located at a location within a predefined zone of a field of view of a camera, of the cameras, that generated the first image data; determining that at least one other object is prioritized over the object; and transmitting, to the client device, data representing a request to modify the predefined zone to exclude the location.

In a third aspect, a network device communicatively coupled to one or more an audio/video (A/V) recording and communication devices, each of the one or more A/V recording and communication devices having a camera, the network device comprises: a communication module; one or more processors; and a non-transitory machine-readable memory storing a program, the program executable by at least one of the one or more processors, the program comprising instructions for: receiving, using the communication module, first image data generated by the cameras; transmitting, using the communication module, the first image data to a client device associated with the one or more A/V recording and communication devices; receiving, using the communication module and from the client device, input data associated with the first image data, the input data representing an interaction with the first image data; and generating a rule based on the input data, wherein the rule is configured to prioritize second image data that is accessible by the client device.

In an embodiment of the third aspect, the program further comprises instructions for: receiving, using the communication module, the second image data generated by at least one of the cameras; ranking, using the rule, the second image data with respect to the first image data; and transmitting, using the communication module and to the client device, ranking data configured to cause a first indicator associated with the second image data to be prioritized over one or more second indicators associated with the first image data.

In another embodiment of the third aspect, the program further comprises instructions for: receiving, using the communication module, the second image data generated by at least one of the cameras; receiving, using the communication module, third image data generated by at least one of the cameras; ranking, using the rule, the second image data with respect to the third image data; and transmitting, using the communication module and to the client device, ranking data configured to cause a first indicator associated with the second image data to be prioritized over a second indicator associated with the third image data.

In another embodiment of the third aspect, the one or more A/V recording and communication devices include a first A/V recording and communication device associated with the client device and a second A/V recording and communication device not associated with the client device.

In another embodiment of the third aspect, the program further comprises instructions for determining that the first image data includes at least one similarity to the second image data.

In another embodiment of the third aspect, the first image data includes a duration and wherein the rule is based on an amount of the duration of the first image data displayed by the client device.

In another embodiment of the third aspect, the rule is based on a number of times the first image data is displayed by the client device.

In another embodiment of the third aspect, the rule is based on a number of times a storage location indicator corresponding to the first image data is sent from the client device.

In another embodiment of the third aspect, the rule is based on a determination that the first image data has been downloaded to the client device or another device associated with the client device.

In another embodiment of the third aspect, the rule is based on a determination that at least one of the first image data and a storage location indicator corresponding to the first image data is posted to a social network.

In another embodiment of the third aspect, the rule is based on a determination that an application associated with display of the first image data receives additional user input after the first image data is displayed.

In another embodiment of the third aspect, the rule is based on a determination that the first image data is deleted from the client device.

In another embodiment of the third aspect, the rule is based on a determination that the first image data has not been displayed by the client device.

In another embodiment of the third aspect, the program further comprises instructions for: determining, based on data indicating a location of an object within the first image data, a classification associated with the first image data; and wherein the rule is based on the classification.

In another embodiment of the third aspect, the program further comprises instructions for: determining, based on data indicating detection of motion in a zone associated with at least one of the one or more the A/V recording and communication devices, a classification associated with the first image data; and wherein the rule is based on the classification.

In another embodiment of the third aspect, the program further comprises instructions for: determining, based on data indicating a time of day at which the first image data was generated, a classification associated with the first image data; and wherein the rule is based on the classification.

In another embodiment of the third aspect, the program further comprises instructions for: determining, based on data indicating an amount of time that motion was detected by at least one of the one or more A/V recording and communication devices, a classification associated with the first image data; and wherein the rule is based on the classification.

In another embodiment of the third aspect, the program further comprises instructions for: determining, based on weather data indicating at least one of a temperature, presence of rain, presence of snow, presence of sun, and presence of clouds at a location associated with at least one of the one or more A/V recording and communication devices, a classification associated with the first image data; and wherein the rule is based on the classification.

In another embodiment of the third aspect, the program further comprises instructions for: determining, based on data indicating an event type associated with an event causing the first image data to be displayed, a classification associated with the first image data; and wherein the rule is based on the classification.

In another embodiment of the third aspect, the program further comprises instructions for: determining, based on a user profile associated with the client device, a classification associated with the first image data; and wherein the rule is based on the classification.

In another embodiment of the third aspect, the rule is based on scheduling data indicating that at least one of the user alerts was transmitted during a period of time corresponding to an appointment that is located away from a location associated with at least one of the one or more A/V recording and communication devices.

In another embodiment of the third aspect, the program further comprises instructions for: determining a classification associated with a first portion of the first image data; selecting at least a second portion of the first image data based on the first portion of the first image data being associated with the classification; and transmitting, using the communication module and to the client device, a communication including storage location indicators associated with the second portion of the first image data.

In another embodiment of the third aspect, the program further comprises instructions for: identifying, based on the first image data, an object depicted in the first image data; determining that the object is located at a location outside a predefined zone of a field of view of a camera, of the cameras, that generated the first image data; determining that the object has been prioritized over at least one other object; and transmitting, using the communication module and to the client device, data representing a request to modify the predefined zone to include the location.

In another embodiment of the third aspect, the transmitting the data is based on the number of times the object is detected outside the predefined zone being above a threshold number of times.

In another embodiment of the third aspect, the program further comprises instructions for: identifying, based on the first image data, an object depicted in the first image data; determining that the object is located at a location within a predefined zone of a field of view of a camera, of the cameras, that generated the first image data; determining that at least one other object is prioritized over the object; and transmitting, using the communication module and to the client device, data representing a request to modify the predefined zone to exclude the location.

In a fourth aspect, a method for use with one or more an audio/video (A/V) recording and communication devices, each of the one or more A/V recording and communication devices having a camera, comprises: receiving first image data generated by the cameras; transmitting the first image data to a client device associated with the one or more A/V recording and communication devices; receiving, from a client device, input data associated with the first image data, the input data representing an interaction with the first image data; and generating a rule based on the input data, wherein the rule is configured to prioritize second image data that is accessible by the client device.

In an embodiment of the fourth aspect, the method further comprises: receiving the second image data generated by at least one of the cameras; ranking, using the rule, the second image data with respect to the first image data; and transmitting, to the client device, ranking data configured to cause a first indicator associated with the second image data to be prioritized over one or more second indicators associated with the first image data.

In another embodiment of the fourth aspect, the method further comprises: receiving the second image data generated by at least one of the cameras; receiving third image data generated by at least one of the cameras; ranking, using the rule, the second image data with respect to the third image data; and transmitting, to the client device, ranking data configured to cause a first indicator associated with the second image data to be prioritized over a second indicator associated with the third image data.

In another embodiment of the fourth aspect, the one or more A/V recording and communication devices include a first A/V recording and communication device associated with the client device and a second A/V recording and communication device not associated with the client device.

In another embodiment of the fourth aspect, the method further comprises determining that the first image data includes at least one similarity to the second image data.

In another embodiment of the fourth aspect, the first image data includes a duration and wherein the rule is based on an amount of the duration of the first image data displayed by the client device.

In another embodiment of the fourth aspect, the rule is based on a number of times the first image data is displayed by the client device.

In another embodiment of the fourth aspect, the rule is based on a number of times a storage location indicator corresponding to the first image data is sent from the client device.

In another embodiment of the fourth aspect, the rule is based on a determination that the first image data has been downloaded to the client device or another device associated with the client device.

In another embodiment of the fourth aspect, the rule is based on a determination that at least one of the first image data and a storage location indicator corresponding to the first image data is posted to a social network.

In another embodiment of the fourth aspect, the rule is based on a determination that an application associated with display of the first image data receives additional user input after the first image data is displayed.

In another embodiment of the fourth aspect, the rule is based on a determination that the first image data is deleted from the client device.

In another embodiment of the fourth aspect, the rule is based on a determination that the first image data has not been displayed by the client device.

In another embodiment of the fourth aspect, the method further comprises: determining, based on data indicating a location of an object within the first image data, a classification associated with the first image data; and wherein the rule is based on the classification.

In another embodiment of the fourth aspect, the method further comprises: determining, based on data indicating detection of motion in a zone associated with at least one of the one or more the A/V recording and communication devices, a classification associated with the first image data; and wherein the rule is based on the classification.

In another embodiment of the fourth aspect, the method further comprises: determining, based on data indicating a time of day at which the first image data was generated, a classification associated with the first image data; and wherein the rule is based on the classification.

In another embodiment of the fourth aspect, the method further comprises: determining, based on data indicating an amount of time that motion was detected by at least one of the one or more A/V recording and communication devices, a classification associated with the first image data; and wherein the rule is based on the classification.

In another embodiment of the fourth aspect, the method further comprises: determining, based on weather data indicating at least one of a temperature, presence of rain, presence of snow, presence of sun, and presence of clouds at a location associated with at least one of the one or more A/V recording and communication devices, a classification associated with the first image data; and wherein the rule is based on the classification.

In another embodiment of the fourth aspect, the method further comprises: determining, based on data indicating an event type associated with an event causing the first image data to be displayed, a classification associated with the first image data; and wherein the rule is based on the classification.

In another embodiment of the fourth aspect, the method further comprises: determining, based on a user profile associated with the client device, a classification associated with the first image data; and wherein the rule is based on the classification.

In another embodiment of the fourth aspect, the rule is based on scheduling data indicating that at least one of the user alerts was transmitted during a period of time corresponding to an appointment that is located away from a location associated with at least one of the one or more A/V recording and communication devices.

In another embodiment of the fourth aspect, the method further comprises: determining a classification associated with a first portion of the first image data; selecting at least a second portion of the first image data based on the first portion of the first image data being associated with the classification; and transmitting, to the client device, a communication including storage location indicators associated with the second portion of the first image data.

In another embodiment of the fourth aspect, the method further comprises: identifying, based on the first image data, an object depicted in the first image data; determining that the object is located at a location outside a predefined zone of a field of view of a camera, of the cameras, that generated the first image data; determining that the object has been prioritized over at least one other object; and transmitting, to the client device, data representing a request to modify the predefined zone to include the location.

In another embodiment of the fourth aspect, the transmitting the data is based on the number of times the object is detected outside the predefined zone being above a threshold number of times.

In another embodiment of the fourth aspect, the method further comprises: identifying, based on the first image data, an object depicted in the first image data; determining that the object is located at a location within a predefined zone of a field of view of a camera, of the cameras, that generated the first image data; determining that at least one other object is prioritized over the object; and transmitting, to the client device, data representing a request to modify the predefined zone to exclude the location.

In a fifth aspect, a method comprises: in response to an audio/video (A/V) recording and communication device detecting motion, receiving first image data generated by a camera of the A/V recording and communication device, the first image data depicting a first source of the motion in a field of view of the camera; causing the image data to be displayed on a display; receiving an input indicating an interaction by a user with the image data; generating input data corresponding to the input; transmitting the input data to a network device; in response to the A/V recording and communication device detecting motion, receiving second image data generated by the camera of the A/V recording and communication device, the second image data depicting a second source of motion in the field of view of the camera; receiving ranking data from the network device, the ranking data indicating a ranking of the second image data with respect to at least one of the first image data and additional image data accessible by the client device, the ranking data based on the input data; and causing display of indicators associated with the second image data and at least one of the first image data and the additional image data such that the indicators are displayed in an order that is based on the ranking data.

In an embodiment of the fifth aspect, the first image data and the second image data are received from the first A/V recording and communication device via at least one of a backend device and a hub device.

In another embodiment of the fifth aspect, the ranking data is received via at least one of a backend device and a hub device.

In another embodiment of the fifth aspect, the input comprises first input, and the method further comprises: receiving data representing a request to modify a predefined zone of the field of view of the camera, the request based on an indication that an object detected outside the predefined zone is prioritized over at least one other object; receiving second input representing a response to the request, the response indicating authorization to modify the predefined zone; and causing the predefined zone to be modified based on the receiving the second input.

In another embodiment of the fifth aspect, the order that the indicators are displayed indicates a duration of time that at least one of the first image data and the additional image data is displayed on the display.

In another embodiment of the fifth aspect, the order that the indicators are displayed indicates a number of times at least one of the first image data and the additional image data has been displayed.

In another embodiment of the fifth aspect, the order that the indicators are displayed indicates that at least one of the first image data and the additional image data has been downloaded.

In another embodiment of the fifth aspect, the order that the indicators are displayed indicates that a storage location indicator associated with at least one of the first image data and the additional image data has been posted to a social network.

In another embodiment of the fifth aspect, the order that the indicators are displayed indicates that at least one of the first image data and the additional image data has been deleted.

In another embodiment of the fifth aspect, the order that the indicators are displayed indicates a number of times at least one of the first image data and the additional image data has been displayed.

In a sixth aspect, non-transitory machine-readable memory storing a program, the program executable by at least one of one or more processors, the program comprising instructions for: in response to an audio/video (A/V) recording and communication device detecting motion, receiving first image data generated by a camera of the A/V recording and communication device, the first image data depicting a first source of the motion in a field of view of the camera; causing the image data to be displayed on a display; receiving an input indicating an interaction by a user with the image data; generating input data corresponding to the input; transmitting the input data to a network device; in response to the A/V recording and communication device detecting motion, receiving second image data generated by the camera of the A/V recording and communication device, the second image data depicting a second source of the motion in the field of view of the camera; receiving ranking data from the network device, the ranking data indicating a ranking of the second image data with respect to at least one of the first image data and additional image data accessible by the client device, the ranking data based on the input data; and causing display of indicators associated with the second image data and at least one of the first image data and the additional image data such that the indicators are displayed in an order that is based on the ranking data.

In an embodiment of the sixth aspect, the first image data and the second image data are received from the first A/V recording and communication device via at least one of a backend device and a hub device.

In another embodiment of the sixth aspect, the ranking data is received via at least one of a backend device and a hub device.

In another embodiment of the sixth aspect, the input comprises first input, and the program further comprises instructions for: receiving data representing a request to modify a predefined zone of the field of view of the camera, the request based on an indication that an object detected outside the predefined zone is prioritized over at least one other object; receiving second input representing a response to the request, the response indicating authorization to modify the predefined zone; and causing the predefined zone to be modified based on the receiving the second input.

In another embodiment of the sixth aspect, the order that the indicators are displayed indicates a duration of time that at least one of the first image data and the additional image data is displayed on the display.

In another embodiment of the sixth aspect, the order that the indicators are displayed indicates a number of times at least one of the first image data and the additional image data has been displayed.

In another embodiment of the sixth aspect, the order that the indicators are displayed indicates that at least one of the first image data and the additional image data has been downloaded.

In another embodiment of the sixth aspect, the order that the indicators are displayed indicates that a storage location indicator associated with at least one of the first image data and the additional image data has been posted to a social network.

In another embodiment of the sixth aspect, the order that the indicators are displayed indicates that at least one of the first image data and the additional image data has been deleted.

In another embodiment of the sixth aspect, the order that the indicators are displayed indicates a number of times at least one of the first image data and the additional image data has been displayed.

In a seventh aspect, a method comprises: receiving an input indicating an interaction by a user with image data displayed via a display; generating input data corresponding to the input; transmitting the input data to a network device; receiving, from the network device, ranking data based on the input data and indicating a ranking of the image data with respect to additional image data accessible by a client device; and displaying indicators associated with the image data and the additional image data, the indicators displayed in an order that is based on the ranking data.

In an embodiment of the seventh aspect, the ranking data is received via at least one of a backend device and a hub device.

In another embodiment of the seventh aspect, the input comprises first input, and the method further comprises: receiving data representing a request to modify a predefined zone of the field of view of a camera from which the image data was generated, the request based on an indication that an object detected outside the predefined zone is prioritized over at least one other object; receiving second input representing a response to the request, the response indicating authorization to modify the predefined zone; and causing the predefined zone to be modified based on the receiving the second input.

In another embodiment of the seventh aspect, the order indicates a duration of time that at least one of the first image data and the additional image data is displayed on the display.

In another embodiment of the seventh aspect, the order indicates a number of times at least one of the first image data and the additional image data has been displayed.

In another embodiment of the seventh aspect, the order indicates that at least one of the first image data and the additional image data has been downloaded.

In another embodiment of the seventh aspect, the order indicates that a storage location indicator associated with at least one of the first image data and the additional image data has been posted to a social network.

In another embodiment of the seventh aspect, the order indicates that at least one of the first image data and the additional image data has been deleted.

In another embodiment of the seventh aspect, the order indicates a number of times at least one of the first image data and the additional image data has been displayed.

In an eighth aspect, non-transitory machine-readable memory storing a program, the program executable by at least one of one or more processors, the program comprises instructions for: receiving an input indicating an interaction by a user with image data displayed via a display; generating input data corresponding to the input; transmitting the input data to a network device; receiving, from the network device, ranking data based on the input data and indicating a ranking of the image data with respect to additional image data accessible by a client device; and displaying indicators associated with the image data and the additional image data, the indicators displayed in an order that is based on the ranking data.

In an embodiment of the eighth aspect, the ranking data is received via at least one of a backend device and a hub device.

In another embodiment of the eighth aspect, the input comprises first input, and the program further comprises instructions for: receiving data representing a request to modify a predefined zone of the field of view of a camera from which the image data was generated, the request based on an indication that an object detected outside the predefined zone is prioritized over at least one other object; receiving second input representing a response to the request, the response indicating authorization to modify the predefined zone; and causing the predefined zone to be modified based on the receiving the second input.

In another embodiment of the eighth aspect, the order indicates a duration of time that at least one of the first image data and the additional image data is displayed on the display.

In another embodiment of the eighth aspect, the order indicates a number of times at least one of the first image data and the additional image data has been displayed.

In another embodiment of the eighth aspect, the order indicates that at least one of the first image data and the additional image data has been downloaded.

In another embodiment of the eighth aspect, the order indicates that a storage location indicator associated with at least one of the first image data and the additional image data has been posted to a social network.

In another embodiment of the eighth aspect, the order indicates that at least one of the first image data and the additional image data has been deleted.

In another embodiment of the eighth aspect, the order indicates a number of times at least one of the first image data and the additional image data has been displayed.

In a ninth aspect, a method for presenting a plurality of events generated by a set of audio/video (A/V) recording and communication devices is provided, the method comprising receiving the plurality of events from the set of A/V recording and communication devices, each of the events associated with video footage captured by a camera of an A/V recording and communication device in the set of A/V recording and communication devices; analyzing the video footage for each of the events to determine at least one characteristic, from among a plurality of characteristics, associated with each of the events; prioritizing the plurality of events based on a set of rules related to the characteristics to create an ordered list, the ordered list including a plurality of list entries, each of the list entries corresponding to one of the events; and transmitting the ordered list to a client device associated with the set of A/V recording and communication devices for display on a display of the client device.

In an embodiment of the ninth aspect, at least some of the list entries are out of chronological order.

In another embodiment of the ninth aspect, analyzing the video footage to determine the at least one characteristic comprises class detection, class detection comprising identifying a class of an object in the video footage.

In another embodiment of the ninth aspect, the class of the object is one of a person, a parcel, an animal, or a vehicle.

In another embodiment of the ninth aspect, analyzing the video footage further comprises class recognition, class recognition comprising identifying a particular member of the identified class.

In another embodiment of the ninth aspect, identifying the particular member of the identified class comprises using biometric data.

In another embodiment of the ninth aspect, the biometric data comprises facial recognition data.

In another embodiment of the ninth aspect, identifying the particular member of the identified class comprises using computer vision.

In another embodiment of the ninth aspect, the method further comprises receiving a user tag of the object.

In another embodiment of the ninth aspect, the user tag is used to assign a priority to a video that includes the object.

In another embodiment of the ninth aspect further comprises transmitting the user tag of the object to a backend device.

In another embodiment of the ninth aspect, the backend device comprises a database.

In another embodiment of the ninth aspect, the method further comprises transmitting the user tag of the object to at least one of the A/V recording and communication devices in the set of A/V recording and communication devices.

In another embodiment of the ninth aspect, the method further comprises transmitting the user tag of the object to another A/V recording and communication device that is not a member of the set of A/V recording and communication devices.

In another embodiment of the ninth aspect, prioritizing the events based on the set of rules comprises assigning a higher priority to a first set of events, from among the plurality of events, that are associated with video footage that shows one or more persons, and assigning a lower priority to a second set of events, from among the plurality of events, that are associated with video footage that doesn't show any persons.

In another embodiment of the ninth aspect, prioritizing the events based on the set of rules further comprises assigning a higher priority to events, from among the first set of events, that are associated with video footage that shows one or more specific or predetermined persons, and assigning a lower priority to events, from among the first set of events, that are associated with video footage that does not show the one or more specific or predetermined persons.

In another embodiment of the ninth aspect, prioritizing the events based on the set of rules comprises assigning a higher priority to events, from among the first set of events, that are associated with video footage that does not show one or more specific or predetermined persons, and assigning a lower priority to events, from among the first set of events, that are associated with video footage that does show the one or more specific or predetermined persons.

In another embodiment of the ninth aspect, prioritizing the events based on the set of rules comprises assigning a higher priority to a set of events, from among the plurality of events, when video footage associated with the set of events shows a same person appearing in more than a predefined number of videos recorded within a predefined length of time.

In another embodiment of the ninth aspect, prioritizing the events based on the set of rules comprises assigning priorities to the events based on priorities assigned to the A/V recording and communication devices that generated the events.

In another embodiment of the ninth aspect, prioritizing the events based on the set of rules comprises assigning a higher priority to events, from among the plurality of events, that are associated with video footage that shows motion, and assigning a lower priority to events, from among the plurality of events, that are associated with video footage that does not show motion.

In another embodiment of the ninth aspect, prioritizing the events based on the set of rules comprises prioritizing the events based on an amount of bandwidth required to transmit each of the events to the client device.

In another embodiment of the ninth aspect, prioritizing the events based on the set of rules comprises assigning priorities to the events based on a time of day when the video footage associated with the events was recorded.

In another embodiment of the ninth aspect, prioritizing the events based on the set of rules comprises assigning priorities to the events based on a location of the client device.

In another embodiment of the ninth aspect, the method further comprises dynamically learning, based on user behavior observed over time, a set of user preferences for prioritizing the events.

In another embodiment of the ninth aspect, dynamically learning the set of user preferences for prioritizing the events comprises tracking an amount of time that the user spends viewing video footage associated with the events that include one or more of the plurality of characteristics.

In another embodiment of the ninth aspect, the plurality of characteristics comprises at least one of video footage that shows one or more persons, video footage that shows one or more specific or predetermined persons, and video footage that shows motion.

In another embodiment of the ninth aspect, prioritizing the events based on the set of rules comprises assigning a higher priority to events, from among the plurality of events, that are associated with video footage that shows a person acting suspiciously.

In another embodiment of the ninth aspect, the person acts suspiciously when the person carries at least one of a weapon and a burglary tool.

In another embodiment of the ninth aspect, the method further comprises identifying the weapon or the burglary tool in the video footage that includes the person acting suspiciously by using a computer vision process.

In another embodiment of the ninth aspect, the computer vision process is performed by a backend server.

In another embodiment of the ninth aspect, a rule in the set of rules is specified by a user.

In another embodiment of the ninth aspect, at least one A/V recording and communication device in the set of A/V recording and communication devices comprises one of a security camera and a video doorbell.

In another embodiment of the ninth aspect, the set of A/V recording and communication devices comprises at least two A/V recording and communication devices.

In a tenth aspect, a method for displaying a plurality of events generated by a set of audio/video (A/V) recording and communication devices is provided, the method comprising receiving, from a backend server, at a client device associated with the set of A/V recording and communication devices, an ordered list, the ordered list including a plurality of list entries, each of the list entries corresponding to one of a plurality of events from the set of A/V recording and communication devices, each of the events comprising video footage captured by a camera of an A/V recording and communication device in the set of A/V recording and communication devices, wherein the events in the ordered list are prioritized according to a set of rules related to characteristics of the video footage corresponding to each of the events, and wherein at least some of the list entries are out of chronological order; and displaying, on a display of the client device, the ordered list of events.

In an embodiment of the tenth aspect, displaying the events comprises displaying the events on the display of the client device in response to a request from a user to view the events.

In another embodiment of the tenth aspect, the method further comprises displaying a highest ranked event on the display of the client device prior to receiving the request from the user.

In another embodiment of the tenth aspect, the request from the user comprises the user opening an application executing on the client device, the application associated with the set of A/V recording and communication devices.

In another embodiment of the tenth aspect, receiving the ordered list of events comprises receiving an email containing the ordered list of events.

In another embodiment of the tenth aspect, at least one rule in the set of rules is specified by a user.

In another embodiment of the tenth aspect, the method further comprises receiving a user tag of a person shown in the video footage associated with an event from among the plurality of events.

In another embodiment of the tenth aspect, the method further comprises transmitting the user tag of the person to the backend server to be stored in a database.

In another embodiment of the tenth aspect, the events are prioritized based on the set of rules by assigning a higher priority to a first set of events, from among the plurality of events, that are associated with video footage that shows one or more persons, and assigning a lower priority to a second set of events, from among the plurality of events, that are associated with video footage that doesn't show any persons.

In another embodiment of the tenth aspect, prioritizing the events based on the set of rules further comprises assigning a higher priority to events, from among the first set of events, that are associated with video footage that shows one or more specific or predetermined persons, and assigning a lower priority to events, from among the first set of events, that are associated with video footage that does not show the one or more specific or predetermined persons.

In another embodiment of the tenth aspect, prioritizing the events based on the set of rules comprises assigning a higher priority to events, from among the first set of events, that are associated with video footage that does not show one or more specific or predetermined persons, and assigning a lower priority to events, from among the first set of events, that are associated with video footage that does show the one or more specific or predetermined persons.

In another embodiment of the tenth aspect, prioritizing the events based on the set of rules comprises assigning a higher priority to a set of events, from among the plurality of events, when video footage associated with the set of events shows a same person appearing in more than a predefined number of videos recorded within a predefined length of time.

In another embodiment of the tenth aspect, prioritizing the events based on the set of rules comprises assigning priorities to the events based on priorities assigned to the A/V recording and communication devices that generated the events.

In another embodiment of the tenth aspect, prioritizing the events based on the set of rules comprises assigning a higher priority to events, from among the plurality of events, that are associated with video footage that shows motion, and assigning a lower priority to events, from among the plurality of events, that are associated with video footage that does not show motion.

In another embodiment of the tenth aspect, prioritizing the events based on the set of rules comprises assigning priorities to the events based on a time of day when the video footage associated with the events was recorded.

In another embodiment of the tenth aspect, prioritizing the events based on the set of rules comprises assigning priorities to the events based on a location of the client device.

In an eleventh aspect, a method for notifying a user of an event generated by an audio/video (A/V) recording and communication device is provided, the method comprising receiving the event from the A/V recording and communication device, the event including video footage captured by a camera of the A/V recording and communication device; assigning to the event an alert type from among a plurality of alert types based on a set of rules, the set of rules including at least one of a rule related to a content of the video footage, a rule related to a characteristic of the video footage, a rule related to the A/V recording and communication device, and a rule related to a user associated with the A/V recording and communication device; and transmitting, to a client device associated with the A/V recording and communication device, an alert of the assigned alert type.

In an embodiment of the eleventh aspect, one rule related to the content of the video footage comprises whether or not the video footage shows a person.

In another embodiment of the eleventh aspect, assigning to the event the alert type comprises analyzing the video footage to determine whether or not the video footage shows the person.

In another embodiment of the eleventh aspect, one rule related to the content of the video footage comprises whether or not the video footage shows a specific person.

In another embodiment of the eleventh aspect, assigning to the event the alert type comprises analyzing the video footage to determine whether or not the video footage shows the specific person.

In another embodiment of the eleventh aspect, one rule related to the characteristic of the video footage comprises a distance between the A/V recording and communication device and an object shown in the video footage.

In another embodiment of the eleventh aspect, one rule related to the characteristic of the video footage comprises a time of day when the video footage was captured.

In another embodiment of the eleventh aspect, one rule related to the content and/or the characteristic of the video footage comprises whether or not the event associated with the video footage is atypical.

In another embodiment of the eleventh aspect, one rule related to the A/V recording and communication device comprises a location of the A/V recording and communication device.

In another embodiment of the eleventh aspect, one rule related to the user associated with the A/V recording and communication device comprises a location of the user.

In another embodiment of the eleventh aspect, the plurality of alert types comprises at least one of a custom urgent alert sound, an alert that repeats until acknowledged, directly opening a live video feed on a display of the client device without any user input, and flashing a light and/or the display of the client device.

In another embodiment of the eleventh aspect, the alert is a first alert and the alert type is a first alert type, the method further comprising transmitting, to a light associated with the A/V recording and communication device, a second alert of a second alert type.

In another embodiment of the eleventh aspect, the light is inside a property at which the A/V recording and communication device is installed, and wherein the second alert type comprises turning the light inside the property on.

In another embodiment of the eleventh aspect, the light comprises a colored light capable of emitting different colors of light based on different types of alerts received by the light.

In another embodiment of the eleventh aspect, the alert is a first alert and the alert type is a first alert type and the method further comprises identifying a location of the user, and transmitting, to a wired phone line associated with the location of the user, a second alert of a second alert type.

In another embodiment of the eleventh aspect, wherein the second alert type comprises dialing the wired phone line and providing a prerecorded message.

In a twelfth aspect, a method for notifying a user of an event generated by an audio/video (A/V) recording and communication device is provided, the method comprising receiving, from a backend server, at a client device associated with the A/V recording and communication device, an alert related to the event generated by the A/V recording and communication device, the event including video footage captured by a camera of the A/V recording and communication device; determining an alert type, from among a plurality of alert types, of the alert, wherein the alert type is based on a set of rules, the set of rules including at least one of a rule related to a content of the video footage, a rule related to a characteristic of the video footage, a rule related to the A/V recording and communication device, and a rule related to a user associated with the A/V recording and communication device; and emitting the alert of the determined alert type.

In an embodiment of the twelfth aspect, one rule related to the content of the video footage comprises whether or not the video footage shows a person.

In another embodiment of the twelfth aspect, one rule related to the content of the video footage comprises whether or not the video footage shows a specific person.

In another embodiment of the twelfth aspect, the specific person is identified by the user.

In another embodiment of the twelfth aspect, the user identifies the specific person by tagging the specific person in video footage associated with another event.

In another embodiment of the twelfth aspect, one rule related to the characteristic of the video footage comprises a distance between the A/V recording and communication device and an object shown in the video footage.

In another embodiment of the twelfth aspect, one rule related to the characteristic of the video footage comprises a time of day when the video footage was captured.

In another embodiment of the twelfth aspect, one rule related to the content and/or the characteristic of the video footage comprises whether or not the event associated with the video footage is atypical.

In another embodiment of the twelfth aspect, one rule related to the A/V recording and communication device comprises a location of the A/V recording and communication device.

In another embodiment of the twelfth aspect, one rule related to the user associated with the A/V recording and communication device comprises a location of the user.

In another embodiment of the twelfth aspect, the plurality of alert types comprises at least one of a custom urgent alert sound, an alert that repeats until acknowledged, directly opening a live video feed on a display of the client device without any user input, and flashing a light and/or the display of the client device.

In another embodiment of the twelfth aspect, the alert is a first alert and the alert type is a first alert type, and the method further comprises receiving a second alert related to another event generated by the A/V recording and communication device; determining a second alert type, from among the plurality of alert types, of the second alert; and emitting the second alert of the determined second alert type, wherein emitting the first alert comprises emitting a first sound while emitting the second alert comprises emitting a second different sound.

In another embodiment of the twelfth aspect, the client device comprises a smartphone, and wherein emitting the alert of the determined alert type comprises emitting the alert through a speaker of the smartphone.

In a thirteenth aspect, a method for transmitting a plurality of video streams from a set of audio/video (A/V) recording and communication devices is provided, the method comprising receiving the video streams from the set of A/V recording and communication devices; prioritizing the video streams based on a set of rules, wherein a first one of the video streams is assigned a first priority and a second one of the video streams is assigned a second priority, the first priority being higher than the second priority; and transmitting the video streams to a client device associated with the set of A/V recording and communication devices for display on a display of the client device, wherein the first video stream is transmitted before the second video stream.

In an embodiment of the thirteenth aspect, the method further comprises, before transmitting the video streams to the client device, receiving a request from the client device to view the video streams.

In another embodiment of the thirteenth aspect, the first video stream is a live video stream.

In another embodiment of the thirteenth aspect, the second video stream is a prerecorded video stream.

In another embodiment of the thirteenth aspect, the method further comprises transmitting a third video stream to the client device.

In another embodiment of the thirteenth aspect, the first and third video streams are transmitted to the client device simultaneously for simultaneous display on the display of the client device.

In another embodiment of the thirteenth aspect, prioritizing the video streams based on the set of rules comprises assigning a higher priority to a first set of video streams from among the plurality of video streams that show one or more persons, and assigning a lower priority to a second set of video streams from among the plurality of video streams that do not show any persons.

In another embodiment of the thirteenth aspect, prioritizing the video streams based on the set of rules further comprises assigning a higher priority to video streams from among the first set of video streams that show one or more specific or predetermined persons, and assigning a lower priority to video streams from among the first set of video streams that do not show any of the one or more specific or predetermined persons.

In another embodiment of the thirteenth aspect, prioritizing the video streams based on the set of rules comprises assigning a higher priority to video streams from among the plurality of video streams that do not show one or more specific or predetermined persons, and assigning a lower priority to video streams from among the plurality of video streams that do show the one or more specific or predetermined persons.

In another embodiment of the thirteenth aspect, prioritizing the video streams based on the set of rules comprises assigning a higher priority to video streams from among the plurality of video streams when those video streams show a same person appearing in more than a predefined number of the video streams within a predefined length of time.

In another embodiment of the thirteenth aspect, prioritizing the video streams based on the set of rules comprises assigning priorities to the video streams based on priorities assigned to the A/V recording and communication devices.

In another embodiment of the thirteenth aspect, prioritizing the video streams based on the set of rules comprises assigning a higher priority to video streams from among the plurality of video streams that show motion, and assigning a lower priority to video streams from among the plurality of video streams that do not show motion.

In another embodiment of the thirteenth aspect, prioritizing the video streams based on the set of rules comprises assigning priorities to the video streams based on an amount of bandwidth required to transmit each of the video streams to the client device.

In another embodiment of the thirteenth aspect, prioritizing the video streams based on the set of rules comprises assigning a higher priority to video streams from among the plurality of video streams that have a transmit bandwidth that does not exceed a predefined capacity.

In another embodiment of the thirteenth aspect, the predefined capacity comprises a user's network bandwidth capacity.

In another embodiment of the thirteenth aspect, prioritizing the video streams based on the set of rules comprises assigning priorities to the video streams based on a time of day when each of the video streams was recorded.

In another embodiment of the thirteenth aspect, prioritizing the video streams based on the set of rules comprises assigning priorities to the video streams based on a location of the client device.

In another embodiment of the thirteenth aspect, prioritizing the video streams based on the set of rules comprises assigning a higher priority to video streams from among the plurality of video streams that are transmitted from a first subset of the A/V recording and communication devices that are armed, and assigning a lower priority to video streams from among the plurality of video streams that are transmitted from a second subset of the A/V recording and communication devices that are not armed.

In another embodiment of the thirteenth aspect, the method further comprises dynamically learning, based on user behavior observed over time, a set of user preferences for prioritizing the video streams.

In another embodiment of the thirteenth aspect, dynamically learning the set of user preferences for prioritizing the video streams comprises tracking an amount of time that the user spends viewing video streams from among the plurality of video streams that include one or more characteristics.

In another embodiment of the thirteenth aspect, the one or more characteristics comprise at least one of video footage that shows one or more persons, video footage that shows one or more specific or predetermined persons, and video footage that shows motion.

In another embodiment of the thirteenth aspect, prioritizing the video streams based on the set of rules comprises assigning a higher priority to video streams from among the plurality of video streams that show a person acting suspiciously.

In another embodiment of the thirteenth aspect, the person acting suspiciously comprises the person carrying at least one of a weapon and a burglary tool.

In another embodiment of the thirteenth aspect, the method further comprises identifying the weapon or the burglary tool in the video stream that includes the person acting suspiciously by using a computer vision process.

In another embodiment of the thirteenth aspect, the computer vision process is performed by a backend server.

In another embodiment of the thirteenth aspect, a rule in the set of rules is specified by a user.

In another embodiment of the thirteenth aspect, at least one A/V recording and communication device in the set of A/V recording and communication devices comprises one of a security camera and a video doorbell.

In another embodiment of the thirteenth aspect, the set of A/V recording and communication devices comprises at least two A/V recording and communication devices.

In another embodiment of the thirteenth aspect, the method further comprises transmitting a subset of the video streams to the client device in a sequential order when the video streams in the subset include video footage captured by two or more of the A/V recording and communication devices in the sequential order.

In a fourteenth aspect, a method for displaying a plurality of video streams from a set of audio/video (A/V) recording and communication devices is provided, the method comprising receiving, at a client device associated with the set of A/V recording and communication devices, the video streams from a backend server; prioritizing the video streams based on a set of rules, wherein a first one of the video streams is assigned a first priority and a second one of the video streams is assigned a second priority, the first priority being higher than the second priority; and displaying the video streams on a display of the client device, wherein the first video stream is displayed before the second video stream.

In an embodiment of the fourteenth aspect, the first video stream is a live video stream.

In another embodiment of the fourteenth aspect, the second video stream is a prerecorded video stream.

In another embodiment of the fourteenth aspect, the method further comprises, before receiving the video streams from the backend server, receiving a request from a user to view the video streams.

In another embodiment of the fourteenth aspect, the method further comprises displaying the first video stream along with a third video stream on the display of the client device simultaneously, wherein the third video stream is assigned a third priority less than or equal to the first priority assigned to the first video stream.

In another embodiment of the fourteenth aspect, simultaneous displaying of the first and third video streams comprises displaying the first video stream on a first portion of the display of the client device and displaying the second video stream on a second portion of the display.

In another embodiment of the fourteenth aspect, prioritizing the video streams based on the set of rules comprises assigning a higher priority to a first set of video streams from among the plurality of video streams that show one or more persons, and assigning a lower priority to a second set of video streams from among the plurality of video streams that do not show any persons.

In another embodiment of the fourteenth aspect, prioritizing the video streams based on the set of rules further comprises assigning a higher priority to video streams from among the first set of video streams that show one or more specific or predetermined persons, and assigning a lower priority to video streams from among the first set of video streams that do not show any of the one or more specific or predetermined persons.

In another embodiment of the fourteenth aspect, prioritizing the video streams based on the set of rules comprises assigning a higher priority to video streams from among the plurality of video streams that do not show one or more specific or predetermined persons, and assigning a lower priority to video streams from among the plurality of video streams that do show the one or more specific or predetermined persons.

In another embodiment of the fourteenth aspect, prioritizing the video streams based on the set of rules comprises assigning a higher priority to video streams from among the plurality of video streams when those video streams show a same person appearing in more than a predefined number of the video streams within a predefined length of time.

In another embodiment of the fourteenth aspect, prioritizing the video streams based on the set of rules comprises assigning priorities to the video streams based on priorities assigned to the A/V recording and communication devices.

In another embodiment of the fourteenth aspect, prioritizing the video streams based on the set of rules comprises assigning a higher priority to video streams from among the plurality of video streams that show motion, and assigning a lower priority to video streams from among the plurality of video streams that do not show motion.

In another embodiment of the fourteenth aspect, prioritizing the video streams based on the set of rules comprises assigning priorities to the video streams based on a time of day when each of the video streams was recorded.

In another embodiment of the fourteenth aspect, prioritizing the video streams based on the set of rules comprises assigning priorities to the video streams based on a location of the client device.

In another embodiment of the fourteenth aspect, prioritizing the video streams based on the set of rules comprises assigning a higher priority to the video streams from among the plurality of video streams that are transmitted from a first subset of the A/V recording and communication devices that are armed, and assigning a lower priority to video streams from among the plurality of video streams that are transmitted from a second subset of the A/V recording and communication devices that are not armed.

In another embodiment of the fourteenth aspect, the method further comprises dynamically learning, based on user behavior observed over time, a set of user preferences for prioritizing the video streams.

In another embodiment of the fourteenth aspect, dynamically learning the set of user preferences for prioritizing the video streams comprises tracking an amount of time that the user spends viewing video streams from among the plurality of video streams that include one or more of the characteristics.

In another embodiment of the fourteenth aspect, the one or more characteristics comprise at least one of video footage that shows one or more persons, video footage that shows one or more specific or predetermined persons, and video footage that shows motion.

In another embodiment of the fourteenth aspect, prioritizing the video streams based on the set of rules comprises assigning a higher priority to video streams from among the plurality of video streams that show a person acting suspiciously.

In another embodiment of the fourteenth aspect, the person acting suspiciously comprises the person carrying at least one of a weapon and a burglary tool.

In another embodiment of the fourteenth aspect, the method further comprises identifying the weapon or the burglary tool in the video stream that includes the person acting suspiciously by using a computer vision process.

In another embodiment of the fourteenth aspect, a rule in the set of rules is specified by a user.

In another embodiment of the fourteenth aspect, at least one A/V recording and communication device in the set of A/V recording and communication devices comprises one of a security camera and a video doorbell.

In another embodiment of the fourteenth aspect, the set of A/V recording and communication devices comprises at least two A/V recording and communication devices.

In another embodiment of the fourteenth aspect, the method further comprises displaying a subset of the video streams from the backend server in a sequential order when the video streams in the subset comprise video footage captured by two or more of the A/V recording and communication devices in the sequential order.

### BRIEF DESCRIPTION OF THE DRAWINGS

The various embodiments of the present intelligent event summary, notifications, and video presentation for audio/video (A/V) recording and communication devices now will be discussed in detail with an emphasis on highlighting the advantageous features. These embodiments depict the novel and non-obvious intelligent event summary, notifications, and video presentation for A/V recording and communication devices shown in the accompanying drawings, which are for illustrative purposes only. These drawings include the following figures, in which like numerals indicate like parts:

FIG. 1 is a functional block diagram illustrating an example system for streaming and storing A/V content captured by an A/V recording and communication device, and for providing notifications to one or more users, according to various aspects of the present disclosure;

FIG. 2 is a flowchart illustrating a process for streaming and storing A/V content from an A/V recording and communication device according to various aspects of the present disclosure;

FIG. 3 is a front view of an example A/V recording and communication doorbell, according to an aspect of the present disclosure;

FIG. 4 is a rear view of the A/V recording and communication doorbell of FIG. 3;

FIG. 5 is a functional block diagram of the components of the A/V recording and communication doorbell of FIGS. 3 and 4;

FIG. 6 is an upper front perspective view of an A/V recording and communication security camera according to various aspects of the present disclosure;

FIG. 7 is a functional block diagram of the components of the A/V recording and communication security camera of FIG. 6;

FIG. 8 is a functional block diagram of the components of a floodlight controller with A/V recording and communication features according to various aspects of the present disclosure;

FIG. 9 is an upper front perspective view of a floodlight controller with A/V recording and communication features according to various aspects of the present disclosure;

FIG. 10 is a front elevation view of the floodlight controller with A/V recording and communication features of FIG. 9 in combination with a floodlight device according to various aspects of the present disclosure;

FIG. 11 is a functional block diagram illustrating a system for communicating in a network according to various aspects of the present disclosure;

FIG. 12 is a functional block diagram illustrating one embodiment of an A/V recording and communication device according to various aspects of the present disclosure;

FIG. 13 is a functional block diagram illustrating one embodiment of a smart-home hub device according to various aspects of the present disclosure;

FIG. 14 is a functional block diagram illustrating one embodiment of a backend device according to various aspects of the present disclosure;

FIG. 15 is a functional block diagram illustrating one embodiment of a client device according to various aspects of the present disclosure;

FIG. 16 is a flowchart illustrating a process for ranking the events generated by one or more A/V recording and communication devices, according to some aspects of the present disclosure;

FIG. 17 is a flowchart illustrating a process for receiving identification data about an event and determining a ranking for the event, according to the present embodiments.

FIG. 18 illustrates an example of a summary of recent events displayed on a display of a client device by an application associated with one or more A/V recording and communication devices, according to various aspects of the present disclosure;

FIG. 19 is a flowchart illustrating a process for presenting a summary of recent events generated by one or more A/V recording and communication devices, according to some aspects of the present disclosure;

FIG. 20 illustrates an example of a dynamic rule that learns, over time, which events generated by one or more A/V recording and communication devices may have more value to a user, according to various aspects of the present disclosure;

FIG. 21 illustrates an example of an explicit rule for ranking an event recorded by an A/V recording and communication device based on the content of the event, according to various aspects of the present disclosure;

FIG. 22 is a flowchart illustrating a process for providing notifications to a user for the events generated by one or more A/V recording and communication devices, according to various aspect of the present disclosure;

FIG. 23 is a schematic diagram of a structure, illustrating an example of notifying persons present at a property, as well as an authorized person associated with the property, about a high ranked event, such as suspicious activity at, or near, the property, according to some aspects of the present embodiments;

FIG. 24 is a flowchart illustrating a process for transmitting to a client device one or more videos from among a plurality of videos recorded by one or more A/V recording and communication devices, based on a ranking assigned to each video, according to various aspect of the present disclosure;

FIG. 25 illustrates an example of displaying, on a display of a client device, videos that are currently being recorded, or have been previously recorded, by one or more A/V recording and communication devices based on the rankings assigned to the videos, according to various aspects of the present disclosure;

FIG. 26 is a screenshot of a map illustrating neighborhoods according to various aspects of the present disclosure;

FIG. 27 is a screenshot of a graphical user interface (GUI) illustrating aspects of a process for accessing and updating neighborhood settings according to various aspects of the present disclosure;

FIG. 28 illustrates an example user interface showing display of ranked events and/or event indicators according to various aspects of the present disclosure;

FIG. 29 illustrates an example user interface showing display of a communication with suggested videos based on ranking data according to various aspects of the present disclosure;

FIG. 30 illustrates an example of motion zone modification based on ranking data according to various aspects of the present disclosure;

FIGS. 31-34 are flowcharts illustrating processes for intelligent event summary, notifications, and video presentation for A/V recoding and communication devices according to various aspects of the present disclosure;

FIG. 35 is a functional block diagram of a client device on which example embodiments may be implemented according to various aspects of the present disclosure; and

FIG. 36 is a functional block diagram of a general-purpose computing system on which example embodiments may be implemented according to various aspects of present disclosure.

### DETAILED DESCRIPTION

The following detailed description describes the present embodiments with reference to the drawings. In the drawings, reference numbers label elements of the present embodiments. These reference numbers are reproduced below in connection with the discussion of the corresponding drawing features.

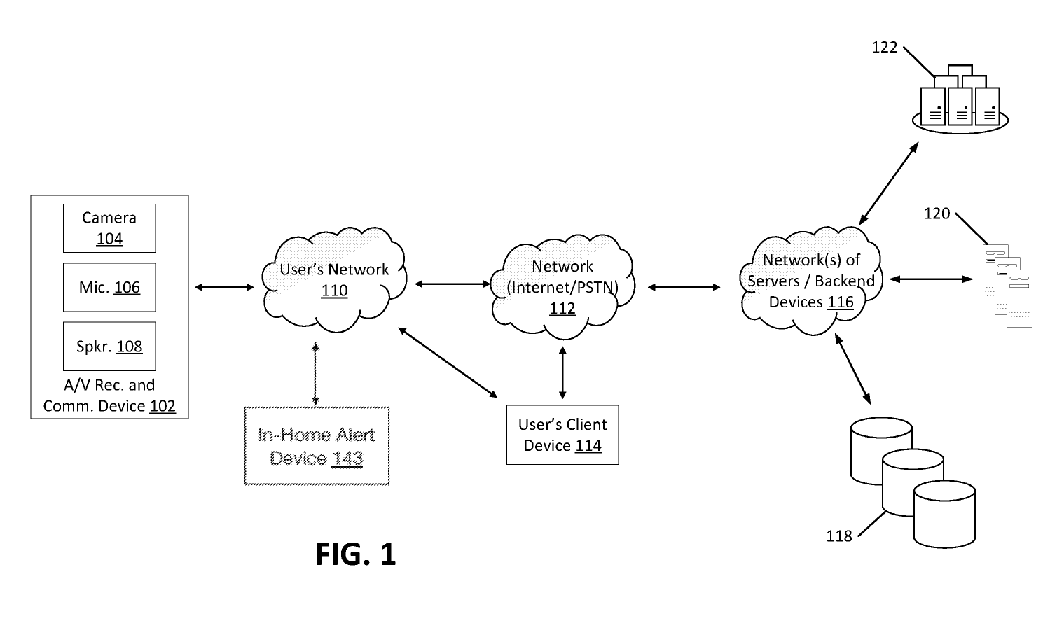

With reference to FIG. 1, the present embodiments include an audio/video (A/V) recording and communication device 102. While the present disclosure provides numerous examples of methods and systems including A/V recording and communication doorbells, the present embodiments are equally applicable for A/V recording and communication devices other than doorbells. For example, the present embodiments may include one or more A/V recording and communication security cameras instead of, or in addition to, one or more A/V recording and communication doorbells. An example A/V recording and communication security camera may include substantially all of the structure and/or functionality of the doorbells described herein, but without the front button and related components. In other examples, the present embodiments may include one or more A/V recording and communication floodlight controllers instead of, or in addition to, one or more A/V recording and communication doorbells.

The A/V recording and communication device 102 may be located near the entrance to a structure (not shown), such as a dwelling, a business, a storage facility, etc. The A/V recording and communication device 102 may include a camera 104, a microphone 106, and/or a speaker 108. The camera 104 may comprise, for example, a high definition (HD) video camera, such as one capable of capturing video images at an image display resolution of 722p, or 1080p, 4K, or any other image display resolution. While not shown, the A/V recording and communication device 102 may also include other hardware and/or components, such as a housing, a communication component (which may facilitate wired and/or wireless communication with other devices), one or more motion sensors (and/or other types of sensors), a button, etc. The A/V recording and communication device 102 may further include similar componentry and/or functionality as the wireless communication doorbells described in US Patent Application Publication Nos. 2015/0022620 (application Ser. No. 14/499,828) and 2015/0022618 (application Ser. No. 14/334,922), both of which are incorporated herein by reference in their entireties as if fully set forth herein.

With further reference to FIG. 1, the A/V recording and communication device 102 communicates with a user's network 110, which may be for example a wired and/or wireless network. If the user's network 110 is wireless, or includes a wireless component, the network 110 may be a Wi-Fi network compatible with the IEEE 802.11 standard and/or other wireless communication standard(s). The user's network 110 may be connected to another network 112, which may comprise, for example, the Internet and/or a public switched telephone network (PSTN). As described below, the A/V recording and communication device 102 may communicate with the user's client device 114 via the user's network 110 and the network 112 (Internet/PSTN). The user's client device 114 may comprise, for example, a mobile device (which may also be referred to as a cellular device), such as a smartphone, a personal digital assistant (PDA), and/or another communication device. The user's client device 114 comprises a display (not shown) and related components capable of displaying streaming and/or recorded video images. The user's client device 114 may also comprise a speaker and related components capable of broadcasting streaming and/or recorded audio, and may also comprise a microphone.

The A/V recording and communication device 102 may also communicate, via the user's network 110 and the network 112 (Internet/PSTN), with a network(s) 116 of servers and/or backend devices, such as (but not limited to) one or more remote storage devices 118 (which may be referred to interchangeably as “cloud storage device(s)”), one or more backend servers 120, and/or one or more backend APIs 122. While FIG. 1 illustrates the storage devices 118, the server 120, and the backend APIs 122 as components separate from the network 116, it is to be understood that the storage devices 118, the server 120, and/or the backend APIs 122 may be components of the network 116.

The network 116 may be any wireless network or any wired network, or a combination thereof, configured to operatively couple the above-mentioned components, devices, and systems as shown in FIG. 1. For example, the network 116 may include one or more of the following: a PSTN (public switched telephone network), the Internet, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1,T3, E1 or E3 line, a Digital Data Service (DDS) connection, a DSL (Digital Subscriber Line) connection, an Ethernet connection, an ISDN (Integrated Services Digital Network) line, a dial-up port such as a V.90, V.34, or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), LTE, VoLTE, LoRaWAN, LPWAN, RPMA, LTE Cat-“X” (e.g. LTE Cat 1, LTE Cat 0, LTE CatM1, LTE Cat NB1), CDMA (Code Division Multiple Access), TDMA (Time Division Multiple Access), FDMA (Frequency Division Multiple Access), and/or OFDMA (Orthogonal Frequency Division Multiple Access) cellular phone networks, Global Navigation Satellite Systems (GNSS), such as Global Positioning System (GPS), CDPD (cellular digital packet data), RIM (Research in Motion, Limited) duplex paging network, Bluetooth radio, or an IEEE 802.11-based radio frequency network. The network can further include or interface with any one or more of the following: RS-232 serial connection, IEEE-4024 (Firewire) connection, Fibre Channel connection, IrDA (infrared) port, SCSI (Small Computer Systems Interface) connection, USB (Universal Serial Bus) connection, or other wired or wireless, digital or analog, interface or connection, mesh or Digi® networking.

According to one or more aspects of the present embodiments, when a person (who may be referred to interchangeably as “visitor”) arrives at an area including the A/V recording and communication device 102, the A/V recording and communication device 102 may detect the visitor's presence and may begin capturing video images within a field of view of the camera 104. The A/V recording and communication device 102 may additionally, or alternatively, capture audio through the microphone 106. The A/V recording and communication device 102 may detect the visitor's presence by detecting motion using the camera 104 and/or a motion sensor, and/or by detecting that the visitor has pressed a front button of the A/V recording and communication device 102, such as when the A/V recording and communication device 102 is a doorbell.

In response to the detection of the visitor, the A/V recording and communication device 102 may transmit an alert to the user's client device 114 (FIG. 1) via the user's network 110 and the network 112. The A/V recording and communication device 102 may also transmit streaming video, and may also transmit streaming audio, to the user's client device 114. If the user answers the alert, two-way audio communication may then occur between the visitor and the user through the A/V recording and communication device 102 and the user's client device 114. The user may view the visitor throughout the duration of the call, but the visitor cannot see the user (unless the A/V recording and communication device 102 includes a display, which it may in some embodiments).

The image data corresponding to video images captured by the camera 104 of the A/V recording and communication device 102 (and the audio captured by the microphone 106) may be uploaded to the cloud and recorded on the remote storage device 118 (FIG. 1). In some embodiments, the video and/or audio may be recorded on the remote storage device 118 even if the user chooses to ignore the alert sent to his or her client device 114.

The user's network 110 is also connected to one or more alert devices, such as the in-home alert device 143. The alert device 143 may comprise any type of device that is capable of providing audible and/or visual alerts. In some aspects of the present embodiments, the alert device 143 may comprise one or more colored light bulbs that are capable of emitting light in different colors (e.g., RGB color changing LED (light-emitting diode) lights such as smart LED bulbs). The alert device 143 may also comprise one or more speakers that are capable of generating different sounds and/or verbal warnings. Some of the present embodiments may include a combination of colored lights and speakers as in-home alert devices.

With further reference to FIG. 1, the system may further comprise a backend API 122 including one or more components. A backend API (application programming interface) may comprise, for example, a server (e.g. a real server, or a virtual machine, or a machine running in a cloud infrastructure as a service), or multiple servers networked together, exposing at least one API to client(s) accessing it. These servers may include components such as application servers (e.g. software servers), depending upon what other components are included, such as a caching layer, and/or database layers, and/or other components. A backend API may, for example, comprise many such applications, each of which communicate with one another using their public APIs. In some embodiments, the API backend may hold the bulk of the user data and offer the user management capabilities, leaving the clients to have very limited state.

The backend API 122 illustrated FIG. 1 may include one or more APIs. An API is a set of routines, protocols, and tools for building software and applications. An API expresses a software component in terms of its operations, inputs, outputs, and underlying types, defining functionalities that are independent of their respective implementations, which allows definitions and implementations to vary without compromising the interface. Advantageously, an API may provide a programmer with access to an application's functionality without the programmer needing to modify the application itself, or even understand how the application works. An API may be for a web-based system, an operating system, or a database system, and it provides facilities to develop applications for that system using a given programming language. In addition to accessing databases or computer hardware like hard disk drives or video cards, an API may ease the work of programming GUI components. For example, an API may facilitate integration of new features into existing applications (a so-called “plug-in API”). An API may also assist otherwise distinct applications with sharing data, which may help to integrate and enhance the functionalities of the applications.

The backend API 122 illustrated in FIG. 1 may further include one or more services (also referred to as network services). A network service is an application that provides data storage, manipulation, presentation, communication, and/or other capability. Network services are often implemented using a client-server architecture based on application-layer network protocols. Each service may be provided by a server component running on one or more computers (such as a dedicated server computer offering multiple services) and accessed via a network by client components running on other devices. However, the client and server components may both be run on the same machine. Clients and servers may have a user interface, and sometimes other hardware associated with them.

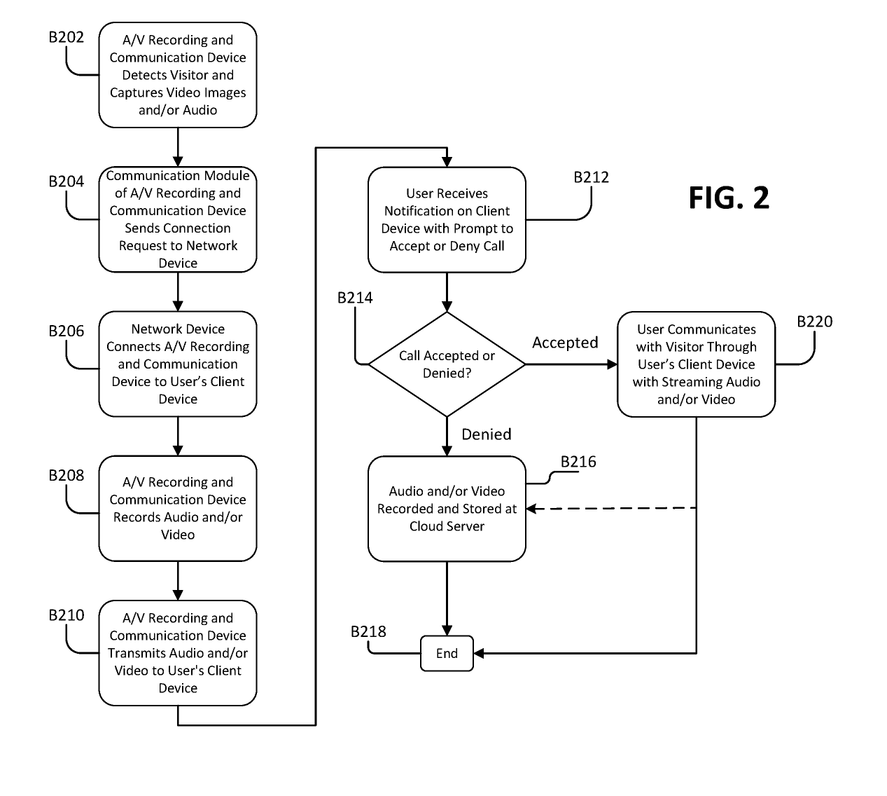

FIG. 2 is a flowchart illustrating a process for streaming and storing A/V content from one or more A/V recording and communication devices, such as A/V recording and communication device 102 from FIG. 1, according to various aspects of the present disclosure. At block B202, the A/V recording and communication device 102 detects the visitor's presence and captures video images within a field of view of the camera 104. The A/V recording and communication device 102 may also capture audio through the microphone 106. As described above, the A/V recording and communication device 102 may detect the visitor's presence by detecting motion using the camera 104 and/or a motion sensor, and/or by detecting that the visitor has pressed a front button of the A/V recording and communication device 102 (if the A/V recording and communication device 102 is a doorbell). Also, as described above, the video recording/capture may begin when the visitor is detected, or may begin earlier, as described below.

At block B204, a communication module of the A/V recording and communication device 102 may transmit a connection request, via the user's network 110 and the network 112, to a device in the network 112. For example, the network device to which the request is sent may be a server such as the server 120. The server 120 may comprise a computer program and/or a machine that waits for requests from other machines or software (clients) and responds to them. A server typically processes data. One purpose of a server is to share data and/or hardware and/or software resources among clients. This architecture is called the client-server model. The clients may run on the same computer or may connect to the server over a network. Examples of computing servers include database servers, file servers, mail servers, print servers, web servers, game servers, and/or application servers. The term server may be construed broadly to include any computerized process that shares a resource to one or more client processes. In other examples, the network device to which the request is sent may be an API such as the backend API 122, described above.

In response to the request, at block B206 the network device may connect the A/V recording and communication device 102 to the user's client device 114 through the user's network 110 and the network 112. At block B208, the A/V recording and communication device 102 may capture available audio and/or video data using the camera 102, the microphone 104, and/or any other device/sensor available. At block B210, the audio and/or video data corresponding to the audio and/or video, respectively, may be transmitted (streamed) from the A/V recording and communication device 102 to the user's client device 114 via the user's network 110 and the network 112. At block B212, the user may receive a notification on his or her client device 114 with a prompt to either accept or deny the call.

At block B214, the process determines whether the user has accepted or denied the call. If the user denies the notification, then the process advances to block B216, where the audio and/or video data may be recorded and stored at a cloud server. The session may then end at block B218 and the connection between the A/V recording and communication device 102 and the user's client device 114 may be terminated. If, however, the user accepts the notification, then at block B220 the user may communicate with the visitor through the user's client device 114 while audio and/or video data captured by the camera 104, the microphone 106, and/or other devices/sensors is streamed to the user's client device 114. At the end of the call, the user may terminate the connection between the user's client device 114 and the A/V recording and communication device 102 and the session ends at block B218. In some embodiments, the audio and/or video data may be recorded and stored at a cloud server (block B216) even if the user accepts the notification and communicates with the visitor through the user's client device 114.

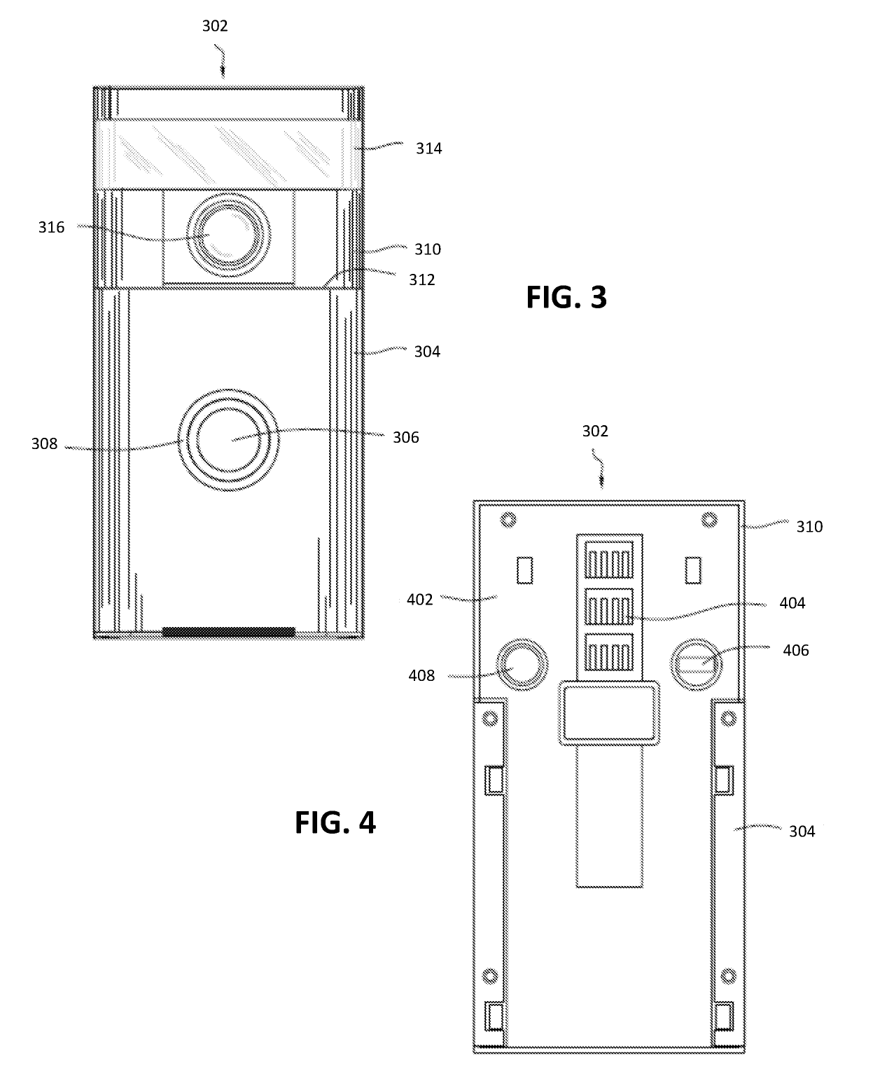

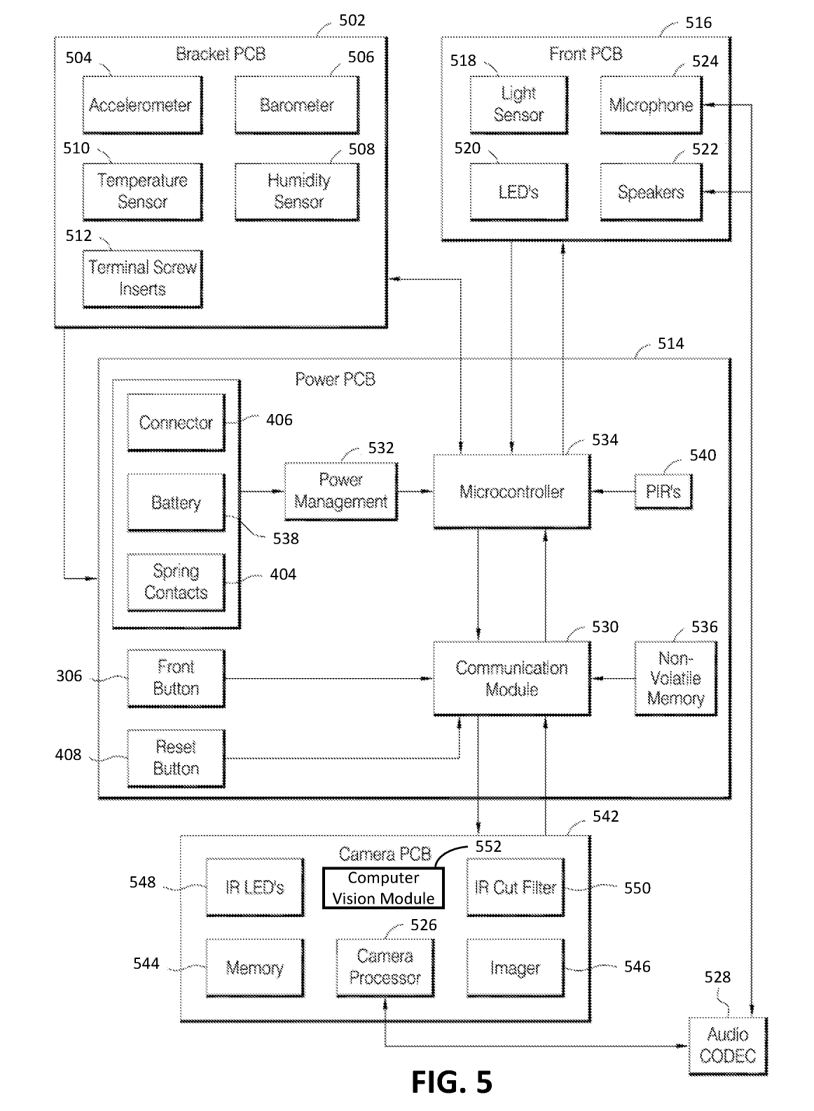

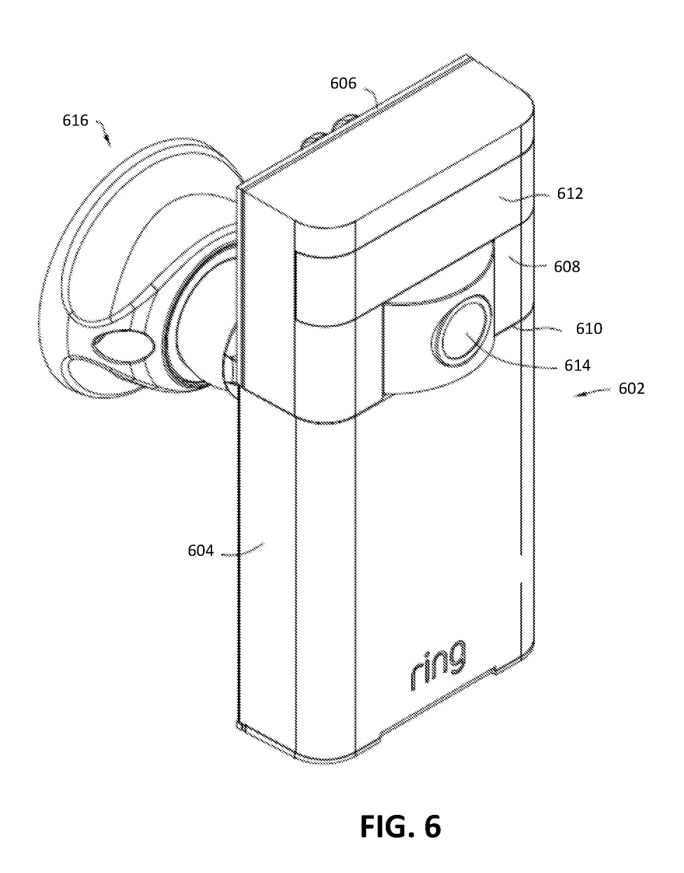

FIGS. 3-5 illustrate an audio/video (A/V) communication doorbell 302 (also referred to a “doorbell 302”) according to aspects of present embodiments. FIG. 3 is a front view, FIG. 4 is a rear view, and FIG. 5 is a functional block diagram of the components within or in communication with the doorbell 302. With reference to FIG. 3, the doorbell 302 may include a faceplate 304 mounted to a back plate 402 (FIG. 4). The faceplate 304 may comprise any suitable material, including, without limitation, metals, such as brushed aluminum or stainless steel, metal alloys, or plastics. The faceplate 304 protects the internal contents of the doorbell 302 and serves as an exterior front surface of the doorbell 302.

With reference to FIG. 3, the faceplate 304 may include a button 306 and a light pipe 308. The button 306 and the light pipe 308 may have various profiles that may or may not match the profile of the faceplate 304. The light pipe 308 may comprise any suitable material, including, without limitation, transparent plastic, that is capable of allowing light produced within the doorbell 302 to pass through. The light may be produced by one or more light-emitting components, such as light-emitting diodes (LED's), contained at least partially within the doorbell 302, as further described below. The button 306 may make contact with a button actuator (not shown) located within the doorbell 302 when the button 306 is pressed by a visitor. When actuated, the button 306 may trigger one or more functions of the doorbell 302, as further described below.

With further reference to FIG. 3, the doorbell 302 may further include an enclosure 310 that engages the faceplate 304. In the illustrated embodiment, the enclosure 310 abuts an upper edge 312 of the faceplate 304, but in alternative embodiments one or more gaps between the enclosure 310 and the faceplate 304 may facilitate the passage of sound and/or light through the doorbell 302. The enclosure 310 may comprise any suitable material, but in some embodiments the material of the enclosure 310 preferably permits infrared light to pass through from inside the doorbell 302 to the environment and vice versa. The doorbell 302 may further include a lens 314. In some embodiments, the lens 314 may comprise a Fresnel lens, which may be patterned to deflect incoming light into one or more infrared sensors located within the doorbell 302. The doorbell 302 may further include a camera 316, which may capture video and generate image data when activated, as described below.

FIG. 4 is a rear view of the doorbell 302, according to aspects of the present embodiments. As illustrated, the enclosure 310 may extend from the front of the doorbell 302 around to the back thereof and may fit snugly around a lip of the back plate 402. The back plate 402 may comprise any suitable material, including, without limitation, metals, such as brushed aluminum or stainless steel, metal alloys, or plastics. The back plate 402 may protect the internal contents, or a portion thereof, of the doorbell 302 and may serve as an exterior rear surface of the doorbell 302. The faceplate 304 may extend from the front of the doorbell 302 and at least partially wrap around the back plate 402, thereby allowing a coupled connection between the faceplate 304 and the back plate 402. The back plate 402 may have indentations in its structure to facilitate the coupling.

With further reference to FIG. 4, spring contacts 404 may provide power to the doorbell 302 when mated with other conductive contacts connected to a power source. The spring contacts 404 may comprise any suitable conductive material, including, without limitation, copper, and may be capable of deflecting when contacted by an inward force, for example the insertion of a mating element. The doorbell 302 may further comprise a connector 406, such as a micro-universal serial bus (micro-USB) or other connector, whereby power and/or data may be supplied to and from the components within the doorbell 302. A reset button 408 may be located on the back plate 402, and may make contact with a button actuator (not shown) located within the doorbell 302 when the reset button 408 is pressed. When the reset button 408 is pressed, it may trigger one or more functions, as described below.

FIG. 5 is a functional block diagram of the components within or in communication with the doorbell 302, according to aspects of the present embodiments. A bracket printed circuit board (PCB) 502 may comprise an accelerometer 504, a barometer 506, a humidity sensor 508, and/or a temperature sensor 510. The accelerometer 504 may be one or more sensors capable of sensing motion and/or acceleration. The barometer 506 may be one or more sensors capable of determining the atmospheric pressure of the surrounding environment in which the bracket PCB 502 may be located. The humidity sensor 508 may be one or more sensors capable of determining the amount of moisture present in the atmospheric environment in which the bracket PCB 502 may be located. The temperature sensor 510 may be one or more sensors capable of determining the temperature of the ambient environment in which the bracket PCB 502 may be located. The bracket PCB 502 may be located outside the housing of the doorbell 302 so as to reduce interference from heat, pressure, moisture, and/or other stimuli generated by the internal components of the doorbell 302.

With further reference to FIG. 5, the bracket PCB 502 may further comprise terminal screw inserts 512, which may be configured to receive terminal screws (not shown) for transmitting power to electrical contacts on a mounting bracket (not shown). The bracket PCB 502 may be electrically and/or mechanically coupled to the power PCB 514 through the terminal screws, the terminal screw inserts 512, the spring contacts 404, and the electrical contacts. The terminal screws may receive electrical wires located at the surface to which the doorbell 302 is mounted, such as the wall of a building, so that the doorbell can receive electrical power from the building's electrical system. Upon the terminal screws being secured within the terminal screw inserts 512, power may be transferred to the bracket PCB 502, and to all of the components associated therewith, including the electrical contacts. The electrical contacts may transfer electrical power to the power PCB 514 by mating with the spring contacts 404.

With further reference to FIG. 5, the front PCB 516 may comprise a light sensor 518, one or more light-emitting components, such as LED's 520, one or more speakers 522, and a microphone 524. The light sensor 518 may be one or more sensors capable of detecting the level of ambient light of the surrounding environment in which the doorbell 302 may be located. LED's 520 may be one or more light-emitting diodes capable of producing visible light when supplied with power. The speakers 522 may be any electromechanical device capable of producing sound in response to an electrical signal input. The microphone 524 may be an acoustic-to-electric transducer or sensor capable of converting sound waves into an electrical signal. When activated, the LED's 520 may illuminate the light pipe 308 (FIG. 3). The front PCB 516 and all components thereof may be electrically coupled to the power PCB 514, thereby allowing data and/or power to be transferred to and from the power PCB 514 and the front PCB 516.

The speakers 522 and the microphone 524 may be coupled to the camera processor 526 through an audio CODEC 528. For example, the transfer of digital audio from the user's client device 114 and the speakers 522 and the microphone 524 may be compressed and decompressed using the audio CODEC 528, coupled to the camera processor 526. Once compressed by audio CODEC 528, digital audio data may be sent through the communication module 530 to the network 112, routed by the one or more servers 120, and delivered to the user's client device 114. When the user speaks, after being transferred through the network 112, digital audio data may be decompressed by the audio CODEC 528 and emitted to the visitor via the speakers 522.

With further reference to FIG. 5, the power PCB 514 may comprise a power management module 532, a microcontroller 534 (which may also be referred to as “processor,” “CPU,” or “controller”), the communication module 530, and power PCB non-volatile memory 536. In certain embodiments, the power management module 532 may comprise an integrated circuit capable of arbitrating between multiple voltage rails, thereby selecting the source of power for the doorbell 302. The battery 538, the spring contacts 404, and/or the connector 406 may provide power to the power management module 532. The power management module 532 may have separate power rails dedicated to the battery 538, the spring contacts 404, and the connector 406. In some of the present embodiments, the power management module 532 may continuously draw power from the battery 538 to power the doorbell 302, while at the same time routing power from the spring contacts 404 and/or the connector 406 to the battery 538, thereby allowing the battery 538 to maintain a substantially constant level of charge. Alternatively, the power management module 532 may continuously draw power from the spring contacts 404 and/or the connector 406 to power the doorbell 302, while only drawing from the battery 538 when the power from the spring contacts 404 and/or the connector 406 is low or insufficient. Still further, the battery 538 may comprise the sole source of power for the doorbell 302. In such embodiments, the spring contacts 404 may not be connected to a source of power. When the battery 538 is depleted of its charge, it may be recharged, such as by connecting a power source to the connector 406. The power management module 532 may also serve as a conduit for data between the connector 406 and the microcontroller 534.

With further reference to FIG. 5, in certain embodiments the microcontroller 534 may comprise an integrated circuit including a processor core, memory, and programmable input/output peripherals. The microcontroller 534 may receive input signals, such as data and/or power, from the passive infrared (PIR) sensors 540, the bracket PCB 502, the power management module 532, the light sensor 518, the microphone 524, and/or the communication module 530, and may perform various functions as further described below. When the microcontroller 534 is triggered by the PIR sensors 540, the microcontroller 534 may be triggered to perform one or more functions. When the light sensor 518 detects a low level of ambient light, the light sensor 518 may trigger the microcontroller 534 to enable “night vision,” as further described below. The microcontroller 534 may also act as a conduit for data communicated between various components and the communication module 530.

With further reference to FIG. 5, the communication module 530 may comprise an integrated circuit including a processor core, memory, and programmable input/output peripherals. The communication module 530 may also be configured to transmit data wirelessly to a remote network device, and may include one or more transceivers (not shown). The wireless communication may comprise one or more wireless networks, such as, without limitation, Wi-Fi, cellular, Bluetooth, and/or satellite networks. The communication module 530 may receive inputs, such as power and/or data, from the camera PCB 542, the microcontroller 534, the button 306, the reset button 408, and/or the power PCB non-volatile memory 536. When the button 306 is pressed, the communication module 530 may be triggered to perform one or more functions. When the reset button 408 is pressed, the communication module 530 may be triggered to erase any data stored at the power PCB non-volatile memory 536 and/or at the camera PCB memory 544. The communication module 530 may also act as a conduit for data communicated between various components and the microcontroller 534. The power PCB non-volatile memory 536 may comprise flash memory configured to store and/or transmit data. For example, in certain embodiments the power PCB non-volatile memory 536 may comprise serial peripheral interface (SPI) flash memory.

With further reference to FIG. 5, the camera PCB 542 may comprise components that facilitate the operation of the camera 316. For example, an imager 546 may comprise a video recording sensor and/or a camera chip. In some of the present embodiments, the imager 546 may comprise a complementary metal-oxide semiconductor (CMOS) array, and may be capable of recording high definition (e.g., 722p, 1080p, 4K, etc.) video files. A camera processor 526 may comprise an encoding and compression chip. In some embodiments, the camera processor 526 may comprise a bridge processor. The camera processor 526 may process video recorded by the imager 546 and audio recorded by the microphone 524, and may transform this data into a form suitable for wireless transfer by the communication module 530 to a network. The camera PCB memory 544 may comprise volatile memory that may be used when data is being buffered or encoded by the camera processor 526. For example, in certain embodiments the camera PCB memory 544 may comprise synchronous dynamic random-access memory (SD RAM). IR LED's 548 may comprise light-emitting diodes capable of radiating infrared light. IR cut filter 550 may comprise a system that, when triggered, configures the imager 546 to see primarily infrared light as opposed to visible light. When the light sensor 518 detects a low level of ambient light (which may comprise a level that impedes the performance of the imager 546 in the visible spectrum), the IR LED's 548 may shine infrared light through the doorbell 302 enclosure out to the environment, and the IR cut filter 550 may enable the imager 546 to see this infrared light as it is reflected or refracted off of objects within the field of view of the doorbell. This process may provide the doorbell 302 with the “night vision” function discussed herein. As also shown in FIG. 5, the camera PCB 542 includes a computer vision module 552, which is described in greater detail below.

As discussed above, the present disclosure provides numerous examples of methods and systems including A/V recording and communication doorbells, but the present embodiments are equally applicable for A/V recording and communication devices other than doorbells. For example, the present embodiments may include one or more A/V recording and communication security cameras instead of, or in addition to, one or more A/V recording and communication doorbells. An example A/V recording and communication security camera may include substantially all of the structure and functionality of the doorbell 302, but without the front button 306 and its associated components. An example A/V recording and communication security camera may further omit other components, such as, for example, the bracket PCB 502 and its associated components.

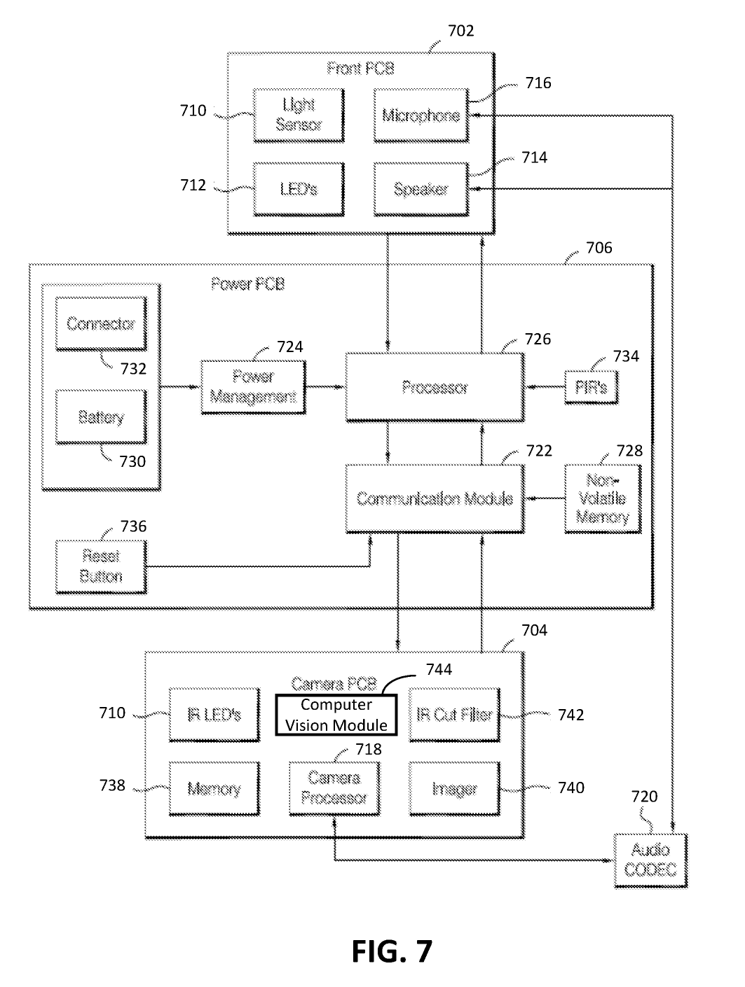

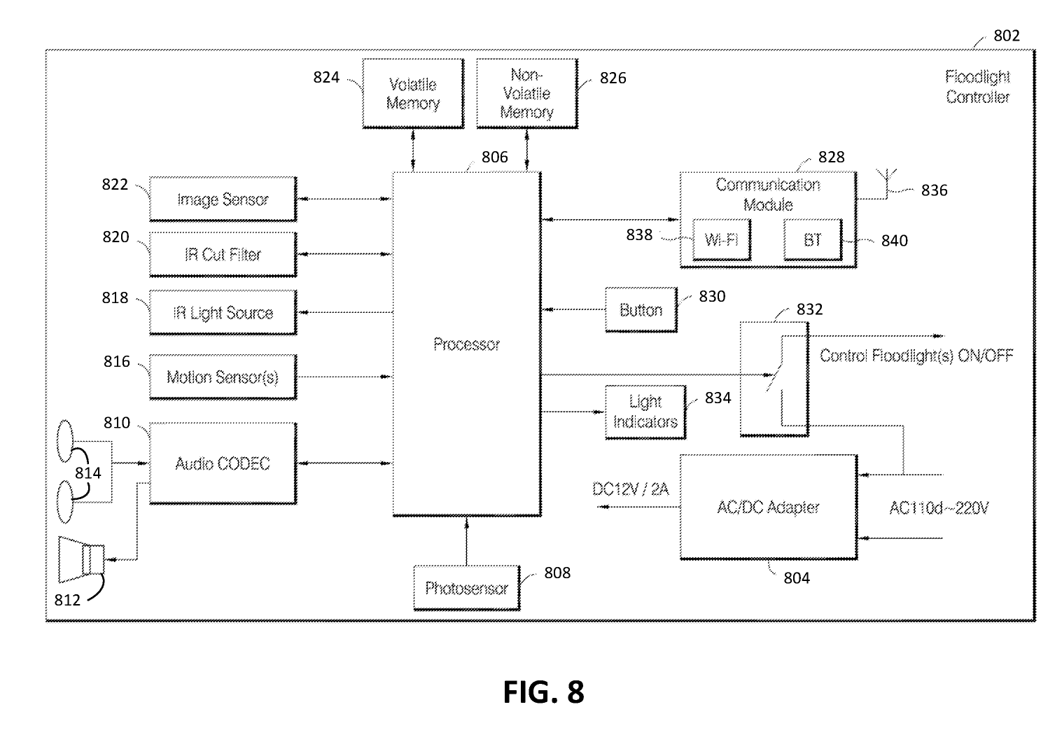

FIGS. 6 and 7 illustrate an example A/V recording and communication security camera according to various aspects of the present embodiments. With reference to FIG. 6, the security camera 602, similar to the video doorbell 302, includes a faceplate 604 that may be mounted to a back plate 606 and an enclosure 608 that engages the faceplate 604. Collectively, the faceplate 304, the back plate 402, and the enclosure 310 form a housing that may contain and protect the inner components of the security camera 602. However, unlike the video doorbell 302, the security camera 602 may not include a front button 306 for activating the doorbell. The faceplate 604 may comprise any suitable material, including, without limitation, metals, such as brushed aluminum or stainless steel, metal alloys, or plastics. The faceplate 604 may protect the internal contents of the security camera 602 and may serve as an exterior front surface of the security camera 602.

With continued reference to FIG. 6, the enclosure 608 may engage the faceplate 604 and may abut an upper edge 610 of the faceplate 604. As discussed above with reference to FIG. 3, in other examples, one or more gaps between the enclosure 608 and the faceplate 604 may facilitate the passage of sound and/or light through the security camera 602. The enclosure 608 may comprise any suitable material, but in some examples the material of the enclosure 608 preferably permits infrared light to pass through from inside the security camera 602 to the environment and vice versa. The security camera 602 further includes a lens 612. Again, similar to the video doorbell 302, in some embodiments, the lens may comprise a Fresnel lens, which may be patterned to deflect incoming light into one or more infrared sensors located within the security camera 602. The security camera 602 further includes a camera 614, which captures video data when activated, as described above and below.

With further reference to FIG. 6, the enclosure 608 may extend from the front of the security camera 602 around to the back thereof and may fit snugly around a lip (not shown) of the back plate 606. The back plate 606 may comprise any suitable material, including, without limitation, metals, such as brushed aluminum or stainless steel, metal alloys, or plastics. The back plate 606 may protect the internal contents of the security camera 602 and may serve as an exterior rear surface of the security camera 602. The faceplate 604 may extend from the front of the security camera 602 and at least partially wrap around the back plate 606, thereby allowing a coupled connection between the faceplate 604 and the back plate 606. The back plate 606 may have indentations (not shown) in its structure to facilitate the coupling.

With continued reference to FIG. 6, the security camera 602 further comprises a mounting apparatus 616. The mounting apparatus 616 may facilitate mounting the security camera 602 to a surface, such as an interior or exterior wall of a building, such as a home or office. The faceplate 604 may extend from the bottom of the security camera 602 up to just below the camera 614, and connect to the back plate 606 as described above. The lens 612 may extend and curl partially around the side of the security camera 602. The enclosure 608 may extend and curl around the side and top of the security camera 602, and may be coupled to the back plate 606 as described above. The camera 614 may protrude from the enclosure 608, thereby giving it a wider field of view. The mounting apparatus 616 may couple with the back plate 606, thereby creating an assembly including the security camera 602 and the mounting apparatus 616. The couplings described in this paragraph, and elsewhere, may be secured by, for example and without limitation, screws, interference fittings, adhesives, and/or other fasteners. Interference fittings may refer to a type of connection where a material relies on pressure and/or gravity coupled with the material's physical strength to support a connection to a different element.

FIG. 7 is a functional block diagram of the components of the A/V recording and communication security camera of FIG. 6. With reference to FIG. 7, the interior of the wireless security camera 602 comprises a plurality of printed circuit boards, including a front PCB 702, a camera PCB 704, and a power PCB 706, each of which is described below. The camera PCB 704 may comprise various components that enable the functionality of the camera 614 of the security camera 602, as described below. Infrared light-emitting components, such as infrared LED's 708, are coupled to the camera PCB 704 and may be triggered to activate when a light sensor detects a low level of ambient light. When activated, the infrared LED's 708 may emit infrared light through the enclosure 608 and/or the camera 614 out into the ambient environment. The camera 614, which may be configured to detect infrared light, may then capture the light emitted by the infrared LED's 708 as it reflects off objects within the camera's 614 field of view, so that the security camera 602 can clearly capture images at night (which may be referred to as “night vision”).

The front PCB 702 comprises various components that may enable the functionality of the audio and light components, including a light sensor 710, LED's 712, one or more speakers 714, and a microphone 716. The light sensor 710 may be one or more sensors capable of detecting the level of ambient light of the surrounding environment in which the security camera 602 may be located. The speakers 714 may be any electromechanical device capable of producing sound in response to an electrical signal input. The microphone 716 may be an acoustic-to-electric transducer or sensor capable of converting sound waves into an electrical signal. The front PCB 702 and all components thereof may be electrically coupled to the power PCB 706, thereby allowing data and/or power to be transferred to and from the power PCB 706 and the front PCB 702.

The speakers 714 and the microphone 716 may be coupled to a camera processor 718 on the camera PCB 704 through an audio CODEC 720. For example, the transfer of digital audio from the user's client device 114 and the speakers 714 and the microphone 716 may be compressed and decompressed using the audio CODEC 720, coupled to the camera processor 718. Once compressed by audio CODEC 720, digital audio data may be sent through the communication module 722 to the network 112, routed by one or more servers 120, and delivered to the user's client device 114. When the user speaks, after being transferred through the network 112, digital audio data is decompressed by audio CODEC 720 and emitted to the visitor via the speakers 714.

With continued reference to FIG. 7, the power PCB 706 comprises various components that enable the functionality of the power and device-control components, including a power management module 724, a processor 726 a communication module 722, and power PCB non-volatile memory 728. In some of the present embodiments, the power management module 724 may comprise an integrated circuit capable of arbitrating between multiple voltage rails, thereby selecting the source of power for the security camera 602. The battery 730 and/or the connector 406 may each provide power to the power management module 532. The power management module 732 (which may be similar to connector 406) may have separate power rails dedicated to the battery 730 and the connector 732. The power management module 724 may control charging of the battery 730 when the connector 732 is connected to an external source of power, and may also serve as a conduit for data between the connector 732 and the processor 726.

With further reference to FIG. 7, in certain embodiments the processor 726 may comprise an integrated circuit including a processor core, memory, and programmable input/output peripherals. The processor 726 may receive input signals, such as data and/or power, from the PIR sensors 734, the power management module 724, the light sensor 710, the microphone 716, and/or the communication module 722, and may perform various functions as further described below. When the processor 726 is triggered by the PIR sensors 734, the processor 726 may be triggered to perform one or more functions, such as initiating recording of video images via the camera 614. When the light sensor 710 detects a low level of ambient light, the light sensor 710 may trigger the processor 726 to enable “night vision,” as further described below. The processor 726 may also act as a conduit for data communicated between various components and the communication module 722.

With further reference to FIG. 7, the security camera 602 further comprises a communication module 722 coupled to the power PCB 706. The communication module 722 may facilitate communication with devices in one or more remote locations, as further described below. The communication module 722 may comprise an integrated circuit including a processor core, memory, and programmable input/output peripherals. The communication module 722 may also be configured to transmit data wirelessly to a remote network device, such as the user's client device 114, the remote storage device 118, and/or the remote server 120, and may include one or more transceivers (not shown). The wireless communication may comprise one or more wireless networks, such as, without limitation, Wi-Fi, cellular, Bluetooth, and/or satellite networks. The communication module 722 may receive inputs, such as power and/or data, from the camera PCB 704, the processor 726, the reset button 736 (which may be similar to the reset button 408), and/or the power PCB non-volatile memory 728. When the reset button 736 is pressed, the communication module 722 may be triggered to erase any data stored at the power PCB non-volatile memory 728 and/or at the camera PCB memory 738. The communication module 722 may also act as a conduit for data communicated between various components and the processor 726. The power PCB non-volatile memory 728 may comprise flash memory configured to store and/or transmit data. For example, in certain embodiments the power PCB non-volatile memory 728 may comprise serial peripheral interface (SPI) flash memory.

With continued reference to FIG. 7, the power PCB 514 further comprises the connector 406 described above and a battery 538. The connector 406 may protrude outward from the power PCB 514 and extend through a hole in the back plate 402. The battery 538, which may be a rechargeable battery, may provide power to the components of the security camera 302.

With continued reference to FIG. 7, the power PCB 706 further comprises passive infrared (PIR) sensors 734, which may be secured on or within a PIR sensor holder (not shown) that resides behind the lens 612 (FIG. 6). The PIR sensors 734 may be any type of sensor capable of detecting and communicating the presence of a heat source within their field of view. Further, alternative embodiments may comprise one or more motion sensors either in place of or in addition to the PIR sensors 734. The motion sensors may be configured to detect motion using any methodology, such as a methodology that does not rely on detecting the presence of a heat source within a field of view.

With further reference to FIG. 7, the camera PCB 704 may comprise components that facilitate the operation of the camera 614. For example, an imager 740 may comprise a video recording sensor and/or a camera chip. In some of the present embodiments, the imager 740 may comprise a complementary metal-oxide semiconductor (CMOS) array, and may be capable of recording high definition (e.g., 722p or better) video files. A camera processor 718 may comprise an encoding and compression chip. In some embodiments, the camera processor 718 may comprise a bridge processor. The camera processor 718 may process video recorded by the imager 740 and audio recorded by the microphone 716, and may transform this data into a form suitable for wireless transfer by the communication module 722 to a network. The camera PCB memory 738 may comprise volatile memory that may be used when data is being buffered or encoded by the camera processor 718. For example, in certain embodiments the camera PCB memory 738 may comprise synchronous dynamic random-access memory (SD RAM). IR LED's 708 may comprise light-emitting diodes capable of radiating infrared light. IR cut filter 742 may comprise a system that, when triggered, configures the imager 740 to see primarily infrared light as opposed to visible light. When the light sensor 710 detects a low level of ambient light (which may comprise a level that impedes the performance of the imager 740 in the visible spectrum), the IR LED's 708 may shine infrared light through the security camera 602 enclosure out to the environment, and the IR cut filter 742 may enable the imager 740 to see this infrared light as it is reflected or refracted off of objects within the field of view of the doorbell. This process may provide the security camera 602 with the “night vision” function discussed herein.

The camera PCB 704 may further include a computer vision module 744. Functionality of the computer vision module 744 is described in greater detail below.

As discussed above, the present disclosure provides numerous examples of methods and systems including A/V recording and communication doorbells, but the present embodiments are equally applicable for A/V recording and communication devices other than doorbells. For example, the present embodiments may include one or more A/V recording and communication floodlight controllers instead of, or in addition to, one or more A/V recording and communication doorbells.

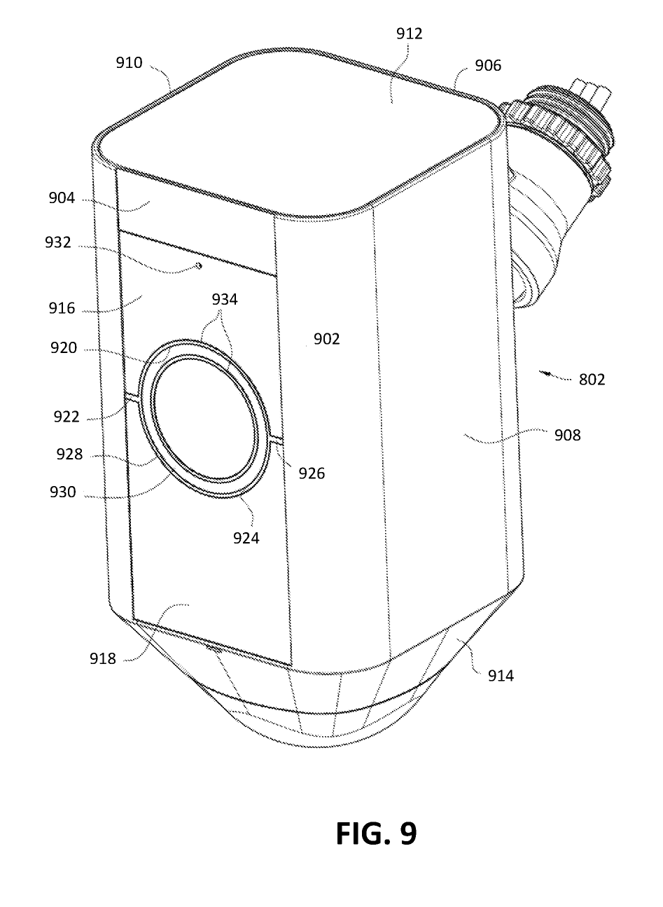

FIGS. 8-10 illustrate an example A/V recording and communication floodlight controller according to various aspects of the present embodiments. FIG. 8 is a functional block diagram illustrating various components of the floodlight controller 802 and their relationships to one another. For example, the floodlight controller 802 comprises an AC/DC adapter 804. The floodlight controller 802 is thus configured to be connected to a source of external AC (alternating-current) power, such as a household AC power supply (may also be referred to as AC mains). The AC power may have a voltage in the range of 110-220 VAC, for example. The incoming AC power may be received by the AC/DC adapter 804, which may convert the incoming AC power to DC (direct-current) and may step down the voltage from 110-220 VAC to a lower output voltage of about 12 VDC and an output current of about 2 A, for example. In various embodiments, the output of the AC/DC adapter 804 may be in a range of from about 9 V to about 15 V, for example, and in a range of from about 0.5 A to about 5 A, for example. These voltages and currents are only examples provided for illustration and are not limiting in any way.

With further reference to FIG. 8, the floodlight controller 802 further comprises other components, including a processor 806 (which may also be referred to as a controller), a photosensor 808, an audio CODEC (coder-decoder) 810, at least one speaker 812 (which may be similar to speaker 108), the at least one microphone 814 (which may be similar to microphone 106), at least one motion sensor 816, an infrared (IR) light source 818, an IR cut filter 820, an image sensor 822 (which may be a component of the camera 104, and may be referred to interchangeably as the camera 104), volatile memory 824, non-volatile memory 826, a communication module 828, a button 830, a switch 832 for controlling one or more floodlights, and a plurality of light indicators 834. Each of these components is described in detail below.

With further reference to FIG. 8, the processor 806 may perform data processing and various other functions, as described below. The processor 806 may comprise an integrated circuit including a processor core, the volatile memory 824, the non-volatile memory 826, and/or programmable input/output peripherals (not shown). The volatile memory 824 may comprise, for example, DDR3 SDRAM (double data rate type three synchronous dynamic random-access memory). The non-volatile memory 826 may comprise, for example, NAND flash memory. In the embodiment illustrated in FIG. 8, the volatile memory 824 and the non-volatile memory 826 are illustrated outside the box representing the processor 806. The embodiment illustrated in FIG. 8 is, however, merely an example, and in some embodiments the volatile memory 824 and/or the non-volatile memory 826 may be physically incorporated with the processor 806, such as on the same chip. The volatile memory 824 and/or the non-volatile memory 826, regardless of their physical location, may be shared by one or more other components (in addition to the processor 806) of the present floodlight controller 802.

With further reference to FIG. 8, the image sensor 822 (camera 104), the IR light source 818, the IR cut filter 820, and the photosensor 808 are all operatively coupled to the processor 806. As described in detail below, the IR light source 818 and the IR cut filter 820 facilitate “night vision” functionality of the image sensor 822. For example, the photosensor 808 may be configured to detect the level of ambient light about the floodlight controller 802. The processor 806 uses the input from the photosensor 808 to control the states of the IR light source 818 and the IR cut filter 820 to activate and deactivate night vision, as described below. In some embodiments, the image sensor 822 may comprise a video recording sensor or a camera chip. In some embodiments, the IR light source 818 may comprise one or more IR light-emitting diodes (LEDs).

With further reference to FIG. 8, the at least one speaker 812 and the at least one microphone 814 are operatively coupled to the audio CODEC 810, which is operatively coupled to the processor 806. The transfer of digital audio between the user and a visitor (or intruder) may be compressed and decompressed using the audio CODEC 810, as described below. The motion sensor(s) 816 is also operatively coupled to the processor 806. The motion sensor(s) 816 may comprise, for example, passive infrared (PIR) sensors, or any other type of sensor capable of detecting and communicating to the processor 806 the presence and/or motion of an object within its field of view. When the processor 806 is triggered by the motion sensor(s) 816, the processor 806 may perform one or more functions, as described below.

With further reference to FIG. 8, the communication module 828 is operatively coupled to the processor 806. The communication module 828, which may include at least one antenna 836, is configured to handle communication links between the floodlight controller 802 and other, external devices or receivers, and to route incoming/outgoing data appropriately. For example, inbound data from the antenna(s) 836 may be routed through the communication module 828 before being directed to the processor 806, and outbound data from the processor 806 may be routed through the communication module 828 before being directed to the antenna(s) 836. The communication module 828 may include one or more transceiver modules capable of transmitting and receiving data, and using, for example, one or more protocols and/or technologies, such as GSM, UMTS (3GSM), IS-95 (CDMA one), IS-2000 (CDMA 2000), LTE, FDMA, TDMA, W-CDMA, CDMA, OFDMA, Wi-Fi, WiMAX, Bluetooth, or any other protocol and/or technology. In the illustrated embodiment, the communication module 828 includes a Wi-Fi chip 838 and a Bluetooth chip 840, but these components are merely examples and are not limiting. Further, while the Wi-Fi chip 838 and the Bluetooth chip 840 are illustrated within the box representing the communication module 828, the embodiment illustrated in FIG. 8 is merely an example, and in some embodiments the Wi-Fi chip 838 and/or the Bluetooth chip 840 are not necessarily physically incorporated with the communication module 828.

In some embodiments, the communication module 828 may further comprise a wireless repeater (not shown, may also be referred to as a wireless range extender). The wireless repeater is configured to receive a wireless signal from a wireless router (or another network device) in the user's network 110 and rebroadcast the signal. Wireless devices that are not within the broadcast range of the wireless router, or that only weakly receive the wireless signal from the wireless router, may receive the rebroadcast signal from the wireless repeater of the communication module 828, and may thus connect to the user's network 110 through the floodlight controller 802. In some embodiments, the wireless repeater may include one or more transceiver modules (not shown) capable of transmitting and receiving data, and using, for example, one or more protocols and/or technologies, such as Wi-Fi (IEEE 802.11), WiMAX (IEEE 802.16), or any other protocol and/or technology.

With further reference to FIG. 8, when a visitor (or intruder) who is present in the area about the floodlight controller 802 speaks, audio from the visitor (or intruder) is received by the microphone(s) 814 and compressed by the audio CODEC 810. Digital audio data is then sent through the communication module 828 to the network 112 (FIG. 1) via the user's network 110, routed by the server 120 and/or the API 122, and delivered to the user's client device 114. When the user speaks, after being transferred through the network 112, the user's network 110, and the communication module 828, the digital audio data from the user is decompressed by the audio CODEC 810 and emitted to the visitor through the speaker 812, which may be driven by a speaker driver (not shown).

With further reference to FIG. 8, the button 830 is operatively coupled to the processor 806. The button 830 may have one or more functions, such as changing an operating mode of the floodlight controller 802 and/or triggering a reset of the floodlight controller 802. For example, when the button 830 is pressed and released, it may cause the communication module 828 of the floodlight controller 802 to enter access point (AP) mode, which may facilitate connecting the floodlight controller 802 to the user's network 110. Alternatively, or in addition, when the button 830 is pressed and held down for at least a threshold amount of time, it may trigger the erasing of any data stored at the volatile memory 824 and/or at the non-volatile memory 826, and/or may trigger a reboot of the processor 806.

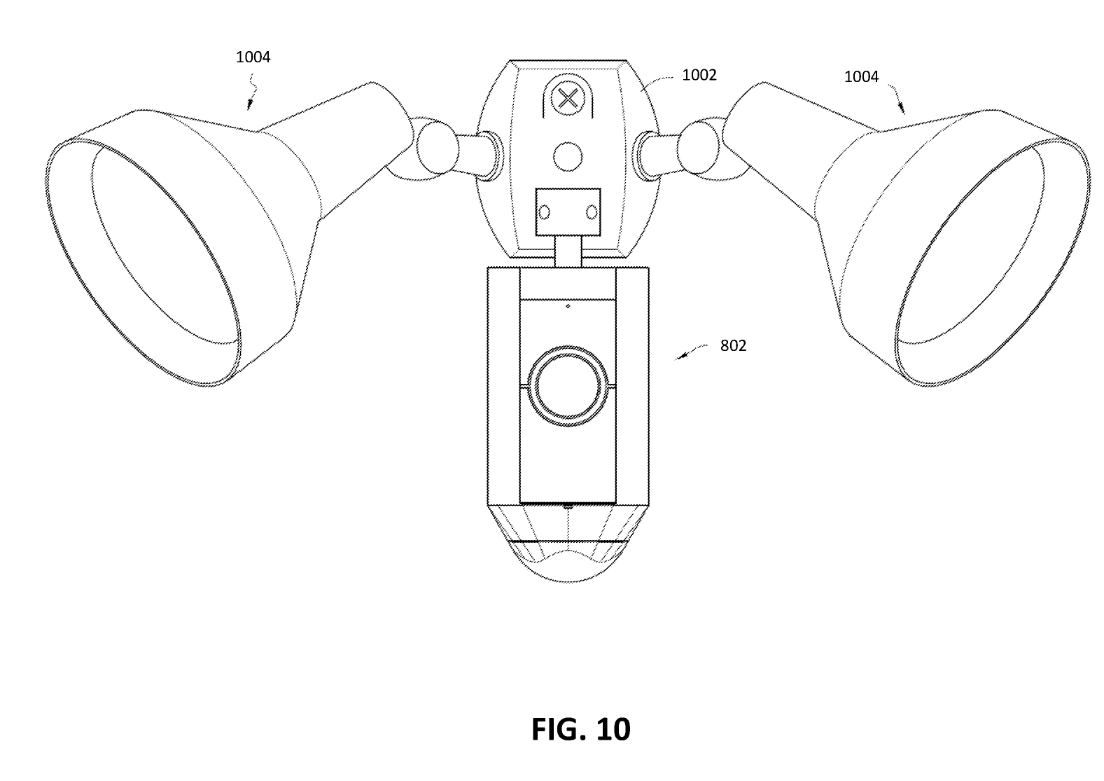

With reference to FIG. 9, the floodlight controller 802 comprises a housing 902 for containing and protecting the interior components of the floodlight controller 802. The housing 902 may include a front wall 904, a rear wall 906, opposing side walls 908, 910, an upper wall 912, and a tapered lower portion 914. The front wall 904 may include a central opening that receives an upper shield 916 and a lower grill 918. In the illustrated embodiment, front surfaces of the upper shield 916 and the lower grill 918 may be substantially flush with a front surface of the front wall 904, but in other examples these surfaces may not be flush with one another. The upper shield 916 may be substantially rectangular, and may include a semicircular indentation 920 along its lower edge 922. The lower grill 918 may be substantially rectangular, and may include a semicircular indentation 924 along its upper edge 926. Together, the semicircular indentations 920, 924 in the upper shield 916 and the lower grill 918 may form a circular opening 928 that accommodates a light pipe 930. A cover may extend across and may close an outer open end of the light pipe 930. The upper shield 916, the lower grill 918, the light pipe 930, and the cover are all described in further detail below. The camera (not shown) may be located in the circular opening 928 formed by the upper shield 916 and the lower grill 918, behind the cover, and may be surrounded by the light pipe 930.

With reference to FIG. 8, the floodlight controller 802 may further comprise the microphones 814. In the illustrated embodiment, a first one of the microphones 814 may located along the front of the floodlight controller 802 behind the upper shield 916 (FIG. 9) and a second one of the microphones 814 may be located along the left side of the floodlight controller 802 behind the left-side wall 910 (FIG. 9) of the housing 902. Including two microphones that are spaced from one another and located on different sides of the floodlight controller 802 provides the illustrated embodiment of the floodlight controller 802 with advantageous noise cancelling and/or echo cancelling for clearer audio. The illustrated embodiment is, however, just one example and is not limiting. Alternative embodiments may only include one microphone 814, or include two microphones 814 in different locations than as illustrated in FIG. 8, or may include more than two microphones 814.

With reference to FIG. 9, the upper shield 916 may include a first microphone opening 932 located in front of the first microphone 814 to facilitate the passage of sound through the upper shield 916 so that sounds from the area about the floodlight controller 802 can reach the first microphone 814. The left-side wall 910 of the housing 902 may include a second microphone opening (not shown) located in front of the second microphone 814 that facilitates the passage of sound through the left-side wall 910 of the housing 902 so that sounds from the area about the floodlight controller 802 may reach the second microphone 814.

With further reference to FIG. 9, the floodlight controller 802 may further comprise a light barrier 934 surrounding inner and outer surfaces of the light pipe 930. The light barrier 934 may comprise a substantially opaque material that prevents the light generated by the light indicators 834 from bleeding into the interior spaces of the floodlight controller 802 around the light pipe 930. The light barrier 934 may comprise a resilient material, such as a plastic, which may also advantageously provide moisture sealing at the junctures between the light pipe 930 and the upper shield 916 and the lower grill 918. Portions of the light barrier 934 may also extend between the junctures between the upper shield 916 and the lower grill 918.

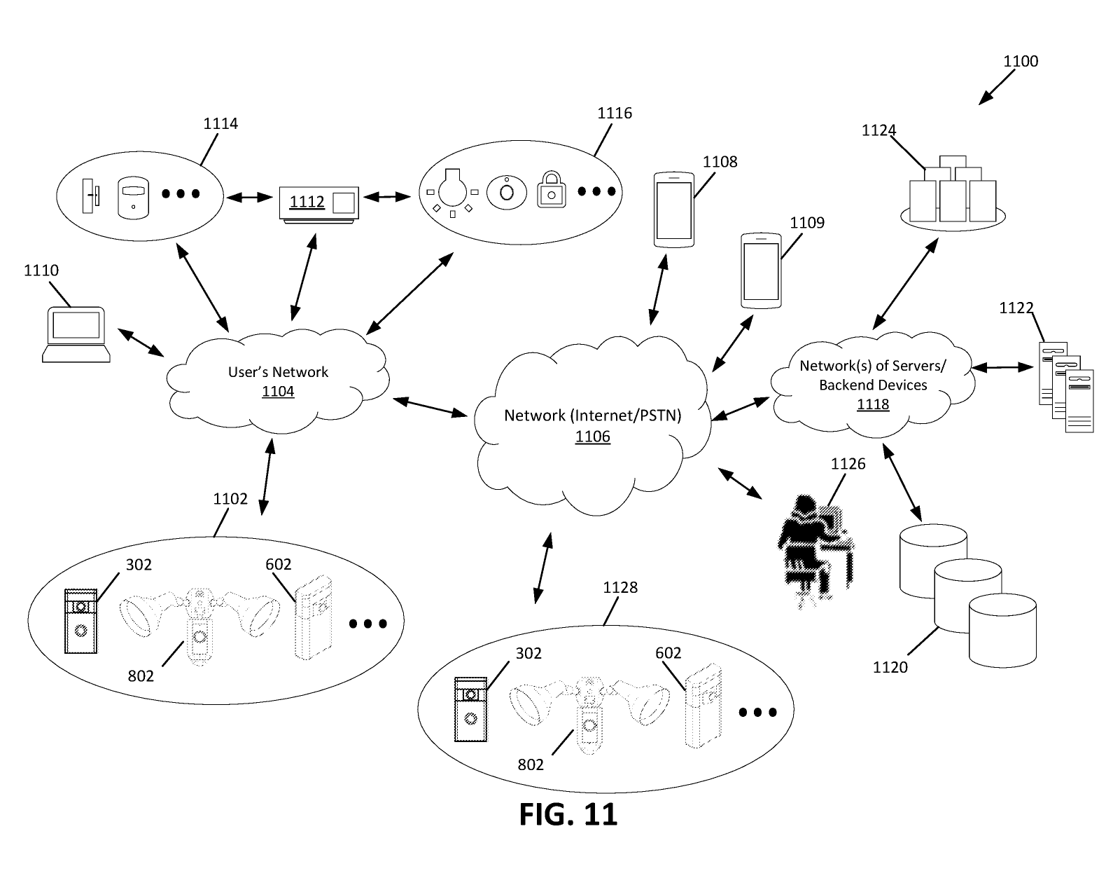

With further reference to FIG. 9, the floodlight controller 802 further comprises connecting hardware configured for connecting the floodlight controller 802 to a floodlight device 1002 (FIG. 10) and a power source (not shown). The floodlight controller 802 further comprises a plurality of wires for connecting the floodlight controller 802 to the power supply and to the floodlight(s) 1004 (FIG. 10) of the floodlight device 1002 (for enabling the floodlight controller 802 to turn the floodlight(s) 1004 on and off). In the illustrated embodiment, three wires may be used, but the illustrated embodiment is merely one example and is not limiting. In alternative embodiments, any number of wires may be provided.

Some of the present embodiments may comprise computer vision for one or more aspects, such as object and/or facial recognition. Computer vision includes methods for acquiring, processing, analyzing, and understanding images and, in general, high-dimensional data from the real world in order to produce numerical or symbolic information, e.g., in the form of decisions. Computer vision seeks to duplicate the abilities of human vision by electronically perceiving and understanding an image. Understanding in this context means the transformation of visual images (the input of the retina) into descriptions of the world that can interface with other thought processes and elicit appropriate action. This image understanding can be seen as the disentangling of symbolic information from image data using models constructed with the aid of geometry, physics, statistics, and learning theory. Computer vision has also been described as the enterprise of automating and integrating a wide range of processes and representations for vision perception. As a scientific discipline, computer vision is concerned with the theory behind artificial systems that extract information from images. The image data can take many forms, such as video sequences, views from multiple cameras, or multi-dimensional data from a scanner. As a technological discipline, computer vision seeks to apply its theories and models for the construction of computer vision systems.

One aspect of computer vision comprises determining whether or not the image data contains some specific object, feature, or activity. Different varieties of computer vision recognition include: Object Recognition (also called object classification)—One or several pre-specified or learned objects or object classes can be recognized, usually together with their 2D positions in the image or 3D poses in the scene. Identification—An individual instance of an object is recognized. Examples include identification of a specific person's face or fingerprint, identification of handwritten digits, or identification of a specific vehicle. Detection—The image data are scanned for a specific condition. Examples include detection of possible abnormal cells or tissues in medical images or detection of a vehicle in an automatic road toll system. Detection based on relatively simple and fast computations is sometimes used for finding smaller regions of interesting image data that can be further analyzed by more computationally demanding techniques to produce a correct interpretation.

Several specialized tasks based on computer vision recognition exist, such as: Optical Character Recognition (OCR)—Identifying characters in images of printed or handwritten text, usually with a view to encoding the text in a format more amenable to editing or indexing (e.g., ASCII). 2D Code Reading—Reading of 2D codes such as data matrix and QR codes. Facial Recognition. Shape Recognition Technology (SRT)—Differentiating human beings (e.g., head and shoulder patterns) from objects.

Typical functions and components (e.g., hardware) found in many computer vision systems are described in the following paragraphs. The present embodiments may include at least some of these aspects. For example, with reference to FIGS. 3-5, embodiments of the present A/V recording and communication doorbell 302 may include a computer vision module 552. In addition, with reference to FIGS. 6-7, embodiments of the present security camera 602 may include a computer vision module 744. The computer vision module 552 may include any of the components (e.g., hardware) and/or functionality described herein with respect to computer vision, including, without limitation, one or more cameras, sensors, and/or processors. In some of the present embodiments, with reference to FIGS. 3-5, the microphone 524, the camera 316, and/or the imager 546 may be components of the computer vision module 552.

Image acquisition—A digital image is produced by one or several image sensors, which, besides various types of light-sensitive cameras, may include range sensors, tomography devices, radar, ultra-sonic cameras, etc. Depending on the type of sensor, the resulting image data may be a 2D image, a 3D volume, or an image sequence. The pixel values may correspond to light intensity in one or several spectral bands (gray images or color images), but can also be related to various physical measures, such as depth, absorption or reflectance of sonic or electromagnetic waves, or nuclear magnetic resonance.

Pre-processing—Before a computer vision method can be applied to image data in order to extract some specific piece of information, it is usually beneficial to process the data in order to assure that it satisfies certain assumptions implied by the method. Examples of pre-processing include, but are not limited to re-sampling in order to assure that the image coordinate system is correct, noise reduction in order to assure that sensor noise does not introduce false information, contrast enhancement to assure that relevant information can be detected, and scale space representation to enhance image structures at locally appropriate scales.

Feature extraction—Image features at various levels of complexity are extracted from the image data. Typical examples of such features are: Lines, edges, and ridges; Localized interest points such as corners, blobs, or points; More complex features may be related to texture, shape, or motion.

Detection/segmentation—At some point in the processing a decision may be made about which image points or regions of the image are relevant for further processing. Examples are: Selection of a specific set of interest points; Segmentation of one or multiple image regions that contain a specific object of interest; Segmentation of the image into nested scene architecture comprising foreground, object groups, single objects, or salient object parts (also referred to as spatial-taxon scene hierarchy).

High-level processing—At this step, the input may be a small set of data, for example a set of points or an image region that is assumed to contain a specific object. The remaining processing may comprise, for example: Verification that the data satisfy model-based and application-specific assumptions; Estimation of application-specific parameters, such as object pose or object size; Image recognition—classifying a detected object into different categories; Image registration—comparing and combining two different views of the same object.

Decision making—Making the final decision required for the application, for example match/no-match in recognition applications.

One or more of the present embodiments may include a vision processing unit (not shown separately, but may be a component of the computer vision module 552). A vision processing unit is an emerging class of microprocessor; it is a specific type of AI (artificial intelligence) accelerator designed to accelerate machine vision tasks. Vision processing units are distinct from video processing units (which are specialized for video encoding and decoding) in their suitability for running machine vision algorithms such as convolutional neural networks, SIFT, etc. Vision processing units may include direct interfaces to take data from cameras (bypassing any off-chip buffers), and may have a greater emphasis on on-chip dataflow between many parallel execution units with scratchpad memory, like a manycore DSP (digital signal processor). But, like video processing units, vision processing units may have a focus on low precision fixed-point arithmetic for image processing.

Some of the present embodiments may use facial recognition hardware and/or software, as a part of the computer vision system. Various types of facial recognition exist, some or all of which may be used in the present embodiments.

Some face recognition algorithms identify facial features by extracting landmarks, or features, from an image of the subject's face. For example, an algorithm may analyze the relative position, size, and/or shape of the eyes, nose, cheekbones, and jaw. These features are then used to search for other images with matching features. Other algorithms normalize a gallery of face images and then compress the face data, only saving the data in the image that is useful for face recognition. A probe image is then compared with the face data. One of the earliest successful systems is based on template matching techniques applied to a set of salient facial features, providing a sort of compressed face representation.

Recognition algorithms can be divided into two main approaches, geometric, which looks at distinguishing features, or photometric, which is a statistical approach that distills an image into values and compares the values with templates to eliminate variances.

Popular recognition algorithms include principal component analysis using eigenfaces, linear discriminant analysis, elastic bunch graph matching using the Fisherface algorithm, the hidden Markov model, the multilinear subspace learning using tensor representation, and the neuronal motivated dynamic link matching.

Further, a newly emerging trend, claimed to achieve improved accuracy, is three-dimensional face recognition. This technique uses 3D sensors to capture information about the shape of a face. This information is then used to identify distinctive features on the surface of a face, such as the contour of the eye sockets, nose, and chin.

One advantage of 3D face recognition is that it is not affected by changes in lighting like other techniques. It can also identify a face from a range of viewing angles, including a profile view. Three-dimensional data points from a face vastly improve the precision of face recognition. 3D research is enhanced by the development of sophisticated sensors that do a better job of capturing 3D face imagery. The sensors work by projecting structured light onto the face. Up to a dozen or more of these image sensors can be placed on the same CMOS chip—each sensor captures a different part of the spectrum.

Another variation is to capture a 3D picture by using three tracking cameras that point at different angles; one camera pointing at the front of the subject, a second one to the side, and a third one at an angle. All these cameras work together to track a subject's face in real time and be able to face detect and recognize.

Another emerging trend uses the visual details of the skin, as captured in standard digital or scanned images. This technique, called skin texture analysis, turns the unique lines, patterns, and spots apparent in a person's skin into a mathematical space.

Another form of taking input data for face recognition is by using thermal cameras, which may only detect the shape of the head and ignore the subject accessories such as glasses, hats, or make up.

Further examples of automatic identification and data capture (AIDC) and/or computer vision that can be used in the present embodiments to verify the identity and/or authorization of a person include, without limitation, biometrics. Biometrics refers to metrics related to human characteristics. Biometrics authentication (or realistic authentication) is used in various forms of identification and access control. Biometric identifiers are the distinctive, measurable characteristics used to label and describe individuals. Biometric identifiers can be physiological characteristics and/or behavioral characteristics. Physiological characteristics may be related to the shape of the body. Examples include, but are not limited to, fingerprints, palm veins, facial recognition, three-dimensional facial recognition, skin texture analysis, DNA, palm prints, hand geometry, iris recognition, retina recognition, and odor/scent recognition. Behavioral characteristics may be related to the pattern of behavior of a person, including, but not limited to, typing rhythm, gait, and voice recognition.

The present embodiments may use any one, or any combination of more than one, of the foregoing biometrics to identify and/or authenticate a person who is either suspicious or who is authorized to take certain actions with respect to a property or expensive item of collateral. For example, with reference to FIGS. 6-7, the computer vision module 534, and/or the camera 316 and/or the processor 534 may receive information about the person using any one, or any combination of more than one, of the foregoing biometrics.

As described herein, the present embodiments analyze video footage and/or other types of data to generate one or more rules, and then apply the one or more rules to rank events that may be of importance to a user. For example, one aspect of the present embodiments includes the realization that conventional methods of presenting events generated by one or more A/V recording and communication devices (e.g., to a user) do not analyze the content of the events, and do not attempt to determine, based on the content analysis, whether any of the events are more important (or less important) to the user. For instance, conventional methods present events recorded by the A/V recording and communication device(s) in a chronological list, typically with the most recent event at the top of the list. This conventional presentation method treats all events equally, without considering whether some of the events may be of greater interest to the user than others. Consequently, events of greater importance may get lost in the process, and may not even be noticed by the user.

The present embodiments solve this problem by analyzing the content of the video footage associated with each event and/or data associated with the video footage, and then generating and/or applying a set of rules to rank the events relative to one another. The ranked events are then presented to the user as an ordered list in decreasing order of interest or importance to the user (e.g., with the most interesting/important event at the top of the list). The user is thus more likely to notice important events, because they are presented more prominently in the ordered list. The set of rules may be defined by the user and/or by the system. Certain of the present embodiments may learn dynamically which events, such as which types or classes of events, are typically of greatest interest or importance to the user, and adjust the set of rules (and/or adjust the application of the set of rules) accordingly so that the ranking process may improve with each iteration.

The present embodiments solve this problem by also generating one or more rules based on user interactions with image data generated by one or more A/V recording and communication devices. The interactions may include, for example, playing a video, pausing a video, stopping a video, restarting a video, sending a storage location indicator corresponding to the video from the client device, downloading a video, sharing a video, posting a video to a social network, interacting with an application of the client device, and/or deleting the video. These interactions may be from one specific user, from multiple users utilizing the same client device, and/or multiple users each utilizing their own client device. Image data may be displayed in an order based on the one or more rules, and communications may be sent to client devices that include storage location indicators, such as links, to videos selected based on prioritization determined based on the one or more rules.

Another aspect of the present embodiments includes the realization that conventional methods of providing event notifications (e.g., alerts sent to a client device of a user) provide the same type of notification every time a triggering event occurs (e.g., when an event is captured by an A/V recording and communication device). Conventional methods do not consider that some events may be more urgent, and/or may be of greater interest to the user, than others. Consequently, notifications for urgent or important events may get lost in the process, and may not even be noticed by the user, or may only be noticed after significant time has passed, by which time the event may no longer be urgent or important.

The present embodiments solve this problem by generating an alert type for each event based on a set of rules, where events that are more urgent and/or more likely to be of interest or to be considered important by the user are assigned an alert type that is designed to be more likely to be noticed by the user. The user is thus more likely to receive urgent or important notifications in a timely manner. The set of rules may be defined by the user and/or by the system. Certain of the present embodiments may learn dynamically which events, such as which types or classes of events, are typically of greatest interest or importance to the user, and adjust the set of rules accordingly so that the process of assigning an alert type to each event may improve with each iteration.

Another aspect of the present embodiments includes the realization that conventional methods of presenting video streams from multiple cameras (e.g., cameras of different A/V recording and communication devices) do not consider that some video streams may be more urgent, and/or may be of greater interest to the user, than others. Consequently, video streams that contain urgent or important content may get drowned out by video streams that contain little, if any, urgent or important content. Further, when multiple video streams are transmitted and/or presented simultaneously, bandwidth limitations may degrade the quality of one or more of the video streams, or may prevent any of the streams from being presented at all.

The present embodiments solve these problems by prioritizing the video streams based on a set of rules, and then transmitting and/or presenting the video streams according to their relative priorities. The set of rules may assign higher priority to video streams that are more urgent and/or more likely to be of interest or to be considered important by the user, and assign lower priority to video streams that are less urgent and/or less likely to be of interest or to be considered important by the user. The user is thus more likely to notice urgent or important video streams, and problems caused by bandwidth limitations may be avoided. The set of rules may be defined by the user and/or by the system. Certain of the present embodiments may learn dynamically which video streams, such as video streams containing certain types or classes of events or people, are typically of greatest interest or importance to the user, and adjust the set of rules accordingly so that the process of prioritizing the video streams may improve with each iteration.

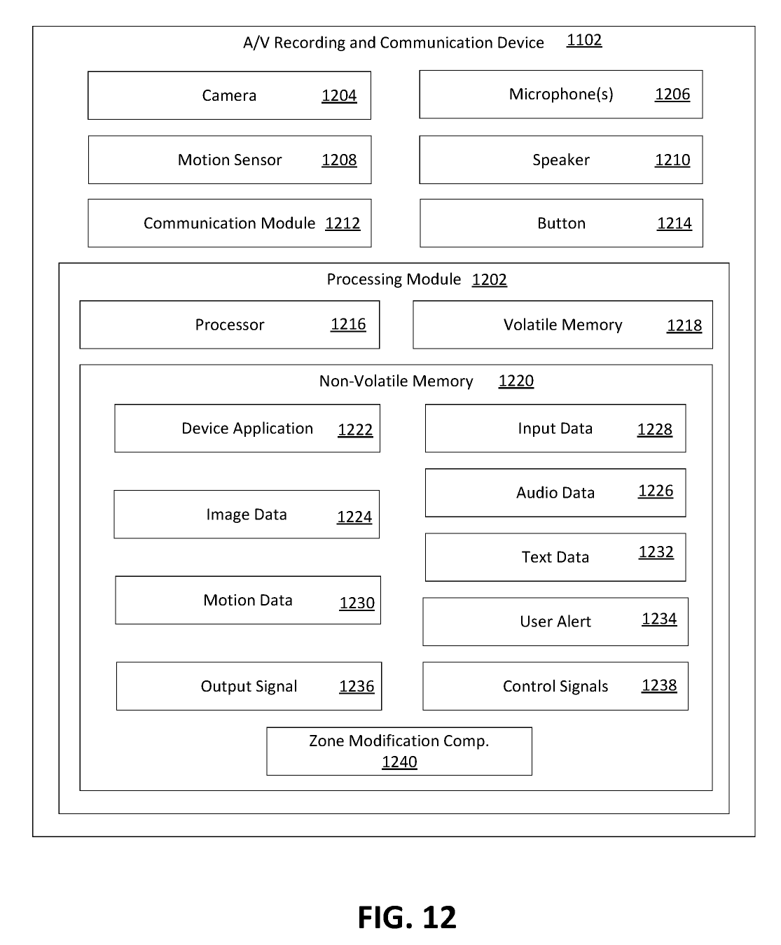

FIG. 11 is a functional block diagram illustrating a system 1100 for communicating in a network according to various aspects of the present disclosure. The system 1100 may include one or more A/V recording and communication devices 1102 configured to access a user's network 1104 (which may correspond to the user's network 110) to connect to a network (Internet/PSTN) 1106 (in some examples, the devices 1102 may be configured to connect directly to the network (Internet/PSTN) 1106, such as over a cellular connection). The one or more A/V recording and communication devices 1102 may include any or all of the components and/or functionality of the A/V recording and communication device 102 (FIGS. 1-2), the A/V recording and communication doorbell 302 (FIGS. 3-5), the security camera 602 (FIGS. 6-7), and/or the floodlight controller 802 (FIGS. 8-10).

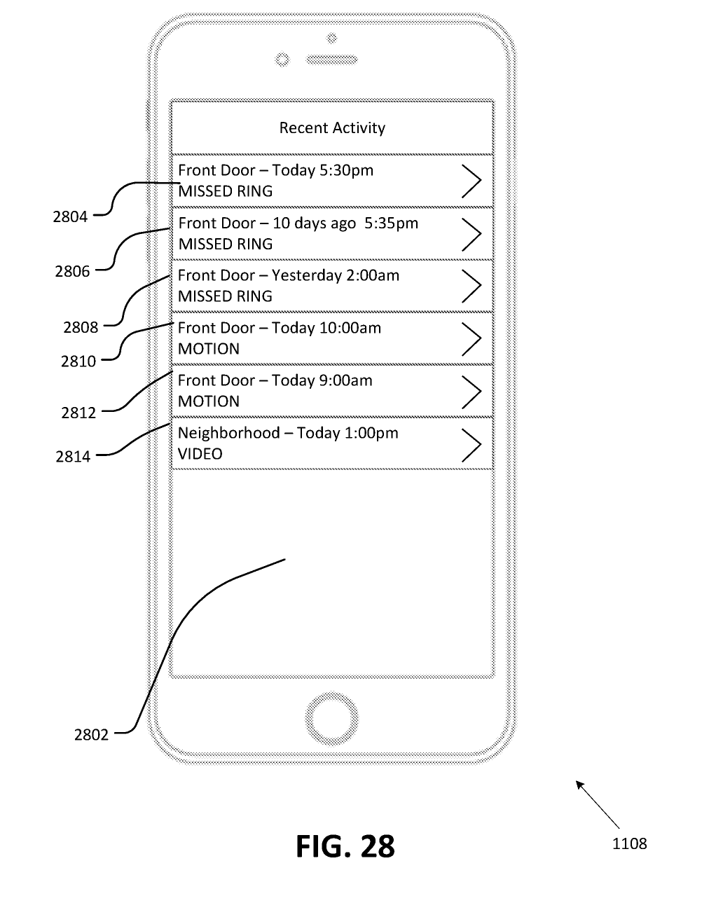

The user's network 1104 may include any or all of the components and/or functionality of the user's network 110 described herein. The system 1100 may also include one or more client devices 1108, 1110, which in various embodiments may be configured to be in network communication and/or associated with the A/V recording and communication device 1102. The client devices 1108, 1110 may comprise, for example, a mobile phone such as a smartphone, or a computing device such as a tablet computer, a laptop computer, a desktop computer, etc. The client devices 1108, 1110 may include any or all of the components and/or functionality of the user's client device 114 (FIG. 1) and/or the client device 2702 (FIG. 27) described herein.

The system 1100 may also include one or more client devices 1109 which in various embodiments may be configured to be in network communication and/or associated with A/V recording and communication devices 1128 that are not located at the same property associated with the user of the client device 1108, 1110 and/or are not associated with the same user account as the user of the client device 1108, 1110 (e.g., the client devices 1109 may be associated with a neighbor who lives within a threshold proximity to the property of the user of the client devices 1008, 1110). The client device(s) 1109 may comprise, for example, a mobile phone such as a smartphone, or a computing device such as a tablet computer, a laptop computer, a desktop computer, etc. The client device(s) 1109 may include any or all of the components and/or functionality of the user's client device 114 (FIG. 1) and/or the client device 2702 (FIG. 27) described herein.

The system 1100 may further include a smart-home hub device 1112 (which may alternatively be referred to herein as the hub device 1112) connected to the user's network 1104. The smart-home hub device 1112 (also known as a home automation hub, gateway device, etc.), may comprise any device that facilitates communication with and control of the sensors 1114, automation devices 1116, and/or the one or more A/V recording and communication devices 1102. For example, the smart-home hub device 1112 may be a component of a home automation system installed at a property. In some embodiments, the A/V recording and communication devices 1102, the sensors 1114, and/or the automation devices 1116 may communicate with the smart-home hub device 1112 directly and/or indirectly via the user's network 1104 and/or the network (Internet/PSTN) 1106. In some of the present embodiments, the A/V recording and communication devices 1102, the sensors 1114, and/or the automation devices 1116 may, in addition to or in lieu of communicating with the smart-home hub device 1112, communicate with the client devices 1108, 1110 and/or one or more of the components of the network of servers/backend devices 1118 directly and/or indirectly via the user's network 1104 and/or the network (Internet/PSTN) 1106.

Home automation, or smart home, is building automation for the home. It involves the control and automation of various devices and/or systems, such as lighting, heating (such as smart thermostats), ventilation, air conditioning (HVAC), blinds/shades, and security, as well as home appliances, such as washers/dryers, ovens, or refrigerators/freezers. Wi-Fi is often used for remote monitoring and control. Smart home devices (e.g., the hub device 1112, the sensors 1114, the automation devices 1116, the A/V recording and communication devices 1102, etc.), when remotely monitored and controlled via the network (Internet/PSTN) 1106, may be considered to be components of the Internet of Things. Smart home systems may include switches and/or sensors (e.g., the sensors 1116) connected to a central hub such as the smart-home hub device 1112, sometimes called a gateway, from which the system may be controlled with a user interface. The user interface may include any or all of a wall-mounted terminal (e.g., a keypad, a touchscreen, etc.), software installed on the client devices 1108, 1110 (e.g., a mobile application), a tablet computer or a web interface, often but not always via Internet cloud services. The home automation system may use one or more communication protocols, including either or both of wired and wireless protocols, including but not limited to Wi-Fi, X10, Ethernet, RS-485, 6LoWPAN, Bluetooth LE (BTLE), ZigBee, and Z-Wave.

The one or more sensors 1114 may include, for example, at least one of a door sensor, a window sensor, a contact sensor, a tilt sensor, a temperature sensor, a carbon monoxide sensor, a smoke detector, a light sensor, a glass break sensor, a motion sensor, and/or other sensors that may provide the user/owner of the security system a notification of a security event at his or her property.

The one or more automation devices 1116 may include, for example, at least one of an outdoor lighting system, an indoor lighting system, and indoor/outdoor lighting system, a temperature control system (e.g., a thermostat), a shade/blind control system, a locking control system (e.g., door lock, window lock, etc.), a home entertainment automation system (e.g., TV control, sound system control, etc.), an irrigation control system, an alarm system, and/or other automation devices.

As described herein, in some of the present embodiments, some or all of the user's network 1104, the client devices 1108, 1110, the A/V recording and communication device 1102, the smart-home hub device 1112, the sensors 1114, and the automation devices 1116 may be referred to as a security system, which may be installed at a property or premises.

With further reference to FIG. 11, the system 1100 may also include various backend devices such as (but not limited to) storage devices 1120, backend servers 1122, and backend APIs 1124 that may be in network communication (e.g., over the user's network 1104 and/or the network (Internet/PSTN) 1106) with the A/V recording and communication devices 1102, the hub device 1112, the client devices 1108, 1110, the sensors 1114, and/or the automation devices 1116. In some embodiments, the storage devices 1120 may be a separate device from the backend servers 1122 (as illustrated) or may be an integral component of the backend servers 1122. The storage devices 1120 may be similar in structure and/or function to the storage device 118 (FIG. 1). In addition, in some embodiments, the backend servers 1122 and backend APIs 1124 may be similar in structure and/or function to the server 120 and the backend API 122 (FIG. 1), respectively.

With further reference to FIG. 11, the system 1100 may also include a security monitoring service 1126. The security monitoring service 1126 may be operated by the same company that manufactures, sells, and/or distributes the A/V recording and communication devices 1102, the hub device 1112, the sensors 1114, and/or the automation devices 1116. In other embodiments, the security monitoring service 1126 may be operated by a third-party company (e.g., a different company than the one that manufactured, sold, and/or distributed the A/V recording and communication devices 1102, the hub device 1112, the sensors 1114, and/or the automation devices 1116). In any of the present embodiments, the security monitoring service 1126 may have control of at least some of the features and components of the security system (e.g., the security monitoring service 1126 may be able to arm and/or disarm the security system, lock and/or unlock doors, activate and/or deactivate one or more of the sensors 1114 and/or the automation devices 1116, etc.). For example, the security monitoring service 1126 may operate and control their own client devices and/or network of servers/backend devices for monitoring and/or controlling security systems. In such an example, the A/V recording and communication devices 1102, the hub device 1112, the sensors 1114, and/or the automation devices 1116 may communicate with the client devices and/or one or more components of the network of servers/backend devices of the security monitoring service 1126 over the network (Internet/PSTN) 1106 (in some embodiments, via one or more of the components of the network of backend servers/backend devices 1118).

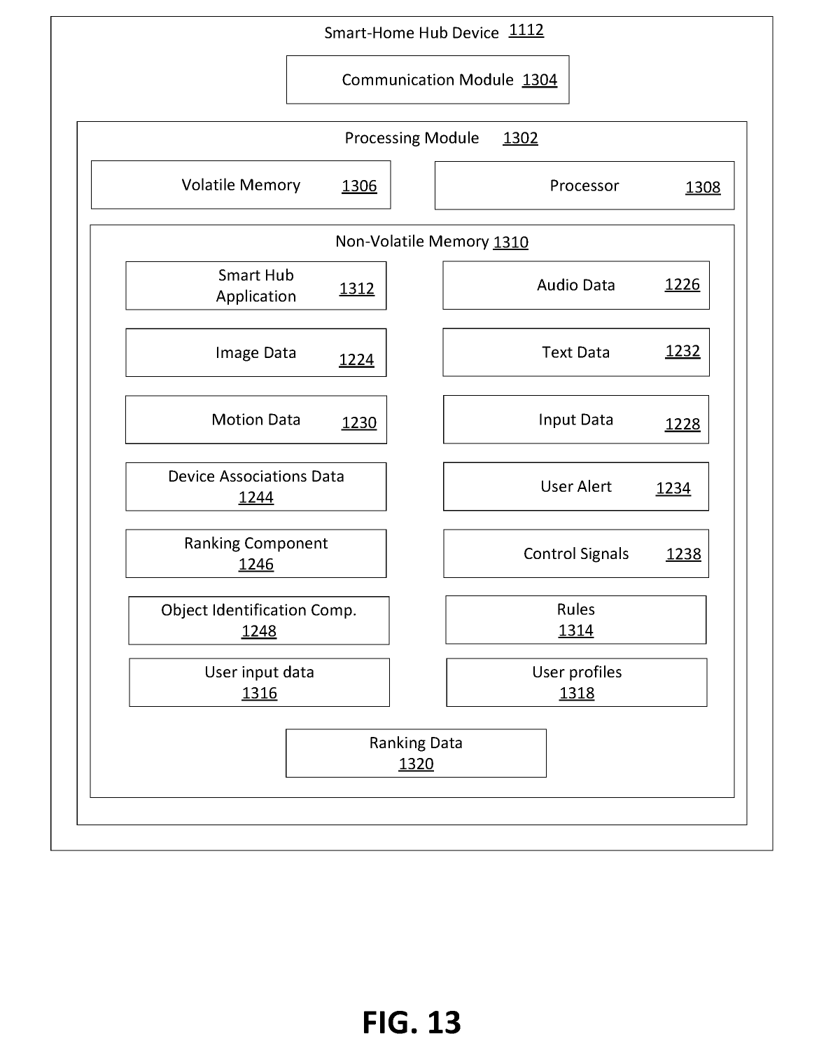

FIG. 12 is a functional block diagram illustrating an embodiment of an A/V recording and communication device 1102 according to various aspects of the present disclosure. In some of the present embodiments, the A/V recording and communication device 1102 may represent, and further include one or more of the components from, the A/V recording and communication doorbell 302, the A/V recording and communication security camera 602, and/or the floodlight controller 802. Additionally, in some embodiments, the A/V recording and communication device 1102 may not include one or more of the components shown in FIG. 12, such as the button 1124 in embodiments where the A/V recording and communication device 1102 is not a doorbell. Furthermore, in some embodiments, the A/V recording and communication devices 1128 may be similar to the A/V recording and communication device 1102.

The A/V recording and communication device 1102 may comprise a processing module 1202 that is operatively connected to a camera 1204, microphone(s) 1206, a motion sensor 1208, speaker(s) 1210, a communication module 1212, and/or a button 1214. The processing module 1202 may comprise a processor 1216, volatile memory 1218, and non-volatile memory 1220, which may include a device application 1222. In various embodiments, the device application 1222 may configure the processor 1216 to capture and/or generate image data 1224 (e.g., videos) using the camera 1204, audio data 1226 using the microphone(s) 1206, input data 1228 using the button 1214, and/or motion data 1230 using the camera 1204 and/or the motion sensor 1208. In some of the present embodiments, the device application 1222 may also configure the processor 1216 to generate text data 1232 describing the image data 1224, the audio data 1226, and/or the input data 1228, such as in the form of metadata, for example.

In addition, the device application 1222 may configure the processor 1216 to transmit the image data 1224, the audio data 1226, the motion data 1230, the input data 1228, the text data 1232, and/or a user alert 1234 to the hub device 1112, the client devices 1108, 1110, and/or the backend server 1122 using the communication module 1212. In various embodiments, the device application 1222 may also configure the processor 1216 to generate and transmit an output signal 1236 that may include the image data 1224, the audio data 1226, the text data 1232, the input data 1228, and/or the motion data 1230. In some of the present embodiments, the output signal 1236 may be transmitted to the backend server(s) 1122 and/or the hub device 1112 using the communication module 1212, and the backend server(s) 1122 and/or the hub device 1112 may transmit (or forward) the output signal 1236 to the client devices 1108, 1110 and/or the backend server(s) 1122 may transmit the output signal 1236 to the hub device 1112. In other embodiments, the output signal 1236 may be transmitted directly to the client devices 1108, 1110 and/or the hub device 1112.

With further reference to FIG. 12, the image data 1224 may comprise image sensor data such as (but not limited to) exposure values and data regarding pixel values for a particular sized grid. The image data 1224 may include still images, live video, and/or pre-recorded images and/or video. The image data 1224 may be recorded and/or generated by the camera 1204 in a field of view of the camera 1204.

In further reference to FIG. 12, the motion data 1230 may comprise motion sensor data generated in response to motion events. For example, the motion data 1230 may include an amount or level of a data type generated by the motion sensor 1208 (e.g., the voltage level output by the motion sensor 1208 when the motion sensor 1208 is a PIR type motion sensor). In some of the present embodiments, such as those where the A/V recording and communication device 1102 does not include the motion sensor 1208, the motion data 1230 may be generated by the camera 1204. In such embodiments, based on a frame by frame comparison of changes in the pixels from the image data 1124, it may be determined that motion is present.

The input data 1228 may include that data generated in response to an input to the button 1214. The button 1214 (which may include similar design and functionality to that of the front button 306 (FIG. 3)) may receive an input (e.g., a press, a touch, a series of touches and/or presses, etc.) and may generate the input data 1228 in response that is indicative of the type of input. In embodiments where the A/V recording and communication device 1102 is not a doorbell, the A/V recording and communication device 1102 may not include the button 1214, and the A/V recording and communication device 1102 may not generate the input data 1228.

With further reference to FIG. 12, a user alert 1234 may be generated by the processor 1216 and transmitted, using the communication module 1212, to the client devices 1108, 1110, the backend server 1122, and/or the hub device 1112. For example, in response to detecting motion using the camera 1204 and/or the motion sensor 1208, the processor 1216 of the A/V recording and communication device 1102 may generate and transmit the user alert 1234. In some of the present embodiments, the user alert 1234 may include at least the image data 1230 and/or the motion data 1224.

With further reference to FIG. 12, the processor 1216 of the A/V recording and communication device 1102 may receive, using the communication module 1212, control signals 1238 from one or more of a client device 1108, 1110, the hub device 112, or the backend server 1122. The control signals 1238 may cause the processor 1216 of the A/V recording and communication device 1102 to activate certain components of the A/V recording and communication device 1102.

In some embodiments, the zone modification component 1240 may be configured to modify one or more motion zones associated with the A/V recording and communication device 1102. For example, the A/V recording and communication device 1102 may be associated with a field of view. The field of view may include one or more zones. A state indicator may be associated with one or more of the zones. The state indicator may provide an indication as to aspects of the state of a particular zone. For example, the state indicator may indicate whether the zone is activated (e.g., “on”) or deactivated (e.g., “off”). Additionally, or alternatively, the state indicator may indicate a motion sensitivity associated with a particular zone.

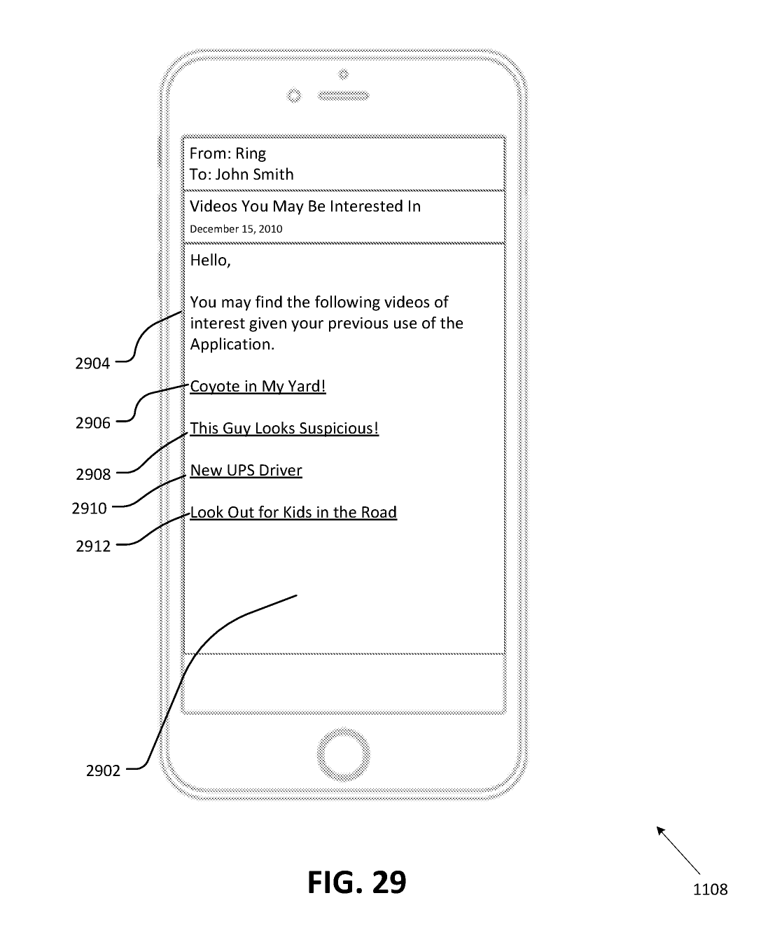

In some embodiments, based on image data 1224 generated by the A/V recording and communication device 1102, a smart-home hub device 1112 and/or a backend server 1122 may identify an object depicted in the image data 1224 and determine that the object is located at a location outside a predefined zone of the field of view of a camera of the A/V recording and communication device 1102. For example, the predefined zone may be a zone including zones 3, 4, and 5. The location of the object may be determined to be in, for example, zone 2. The smart-home device 1112 and/or the backend server 1122 may determine that the object has been prioritized over at least one other object. The prioritization of objects may be performed utilizing the one or more rules described herein, including, without limitation, with respect to FIG. 28. Data representing a request to modify the predefined zone to include the location may be transmitted to the client device 1108, 1110. The request may ask whether the predefined zone should be updated. The request may include, for example, a statement such as “based on your viewing history, we suggest you activate Motion Zone 2,” and a query “would you like to active Motion Zone 2?” A user may select an option to confirm activation of “Motion Zone 2.” Based on the user selection, the zone modification may be performed by the zone modification component 1240.

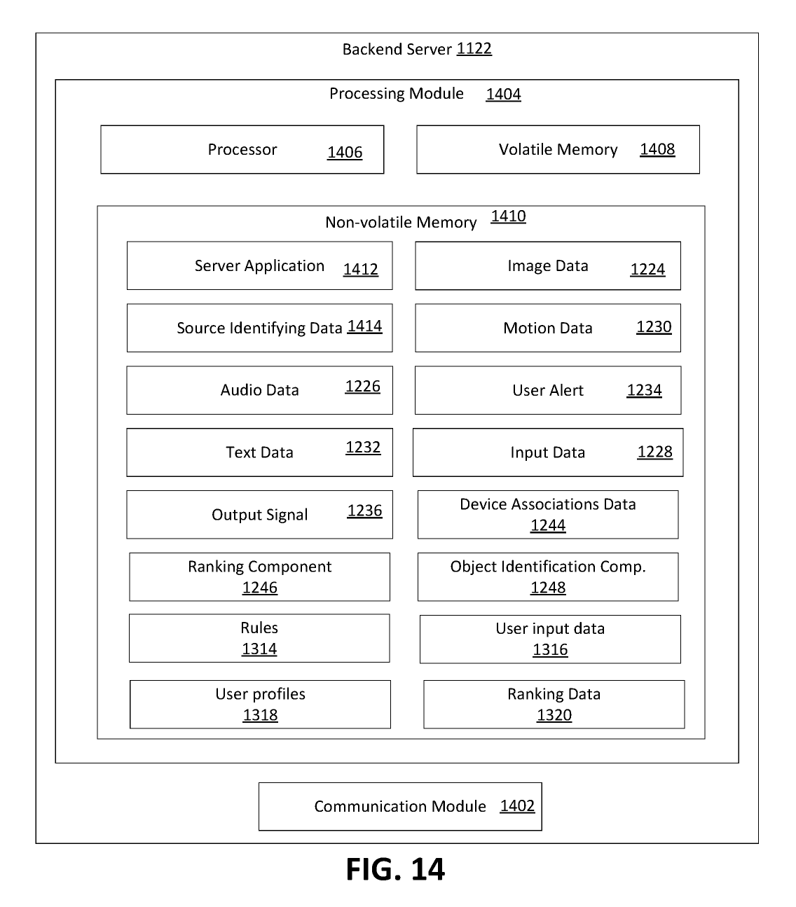

FIG. 13 is a functional block diagram illustrating an example of the smart-home hub device 1112 (alternatively referred to herein as the hub device 1112) according to various aspects of the present disclosure. The hub device 1112 may be, for example, one or more of a Wi-Fi hub, a smart-home hub, a hub of a home security/alarm system, a gateway device, a hub for a legacy security/alarm system (e.g., a hub for connecting a pre-existing security/alarm system to the network (Internet/PSTN) 1106 for enabling remote control of the hub device 1112), and/or another similar device. The hub device 1112 may comprise a processing module 1302 that is operatively connected to a communication module 1304. In some of the present embodiments, the hub device 1112 may comprise one or more of a camera (not shown), a microphone (not shown), and a speaker (not shown). The processing module 1302 may comprise a processor 1306, volatile memory 1308, and non-volatile memory 1310, which may include a smart-home hub application 1312.

In various embodiments, the smart-home hub application 1306 may configure the processor 1308 to receive sensor data from the sensors 1114 and/or the automation devices 1116. For example, the sensor data may include a current state (e.g., opened/closed for door and window sensors, motion detected for motion sensors, living room lights on/off for a lighting automation system, etc.) of each of the sensors 1114 and/or the automation devices 1116. In some of the present embodiments, the sensor data may be received in response to sensor triggers. The sensor triggers may be a door opening/closing, a window opening/closing, lights being turned on/off, blinds being opened/closed, etc. As such, the sensor data may include the current state of the sensors 1114 and/or the automation devices 1116 as well as any updates to the current state based on sensor triggers.

With further reference to FIG. 13, the smart-home hub application 1306 may configure the processor 1312 to receive the audio data 1226, the text data 1232, the image data 1224, the motion data 1230, the input data 1228, and/or the user alert 1234 from the A/V recording and communication device 1102 (in some embodiments, via the backend server 1122) using the communication module 1304. For example, the hub device 1112 may receive and/or retrieve (e.g., after receiving a signal from the A/V recording and communication device 1102 that the device 1102 has been activated) the image data 1224, the input data 1228, the audio data 1126, the text data 1232, and/or the motion data 1230 from the A/V recording and communication device 1102 and/or the backend server 1122 in response to motion being detected by the A/V recording and communication device 1102. In addition, the smart-home hub application 1306 may configure the processor 1312 to receive control signals 1238 from a client device 1108, 1110.

As described herein, at least some of the processes of the A/V recording and communication device 1102, the backend server 1122, and/or the client device 1108, 1110 may be executed by the hub device 1112. For example, the processor 1308 of the hub device 1112 may be configured to receive, via the communication module 1304, the image data 1224 generated by the camera 1204 of a field of view of the camera 1204. The hub device 1112 may be further configured to generate the user alert 1234 based at least in part on the A/V recording and communication device 1102 detecting motion and/or based at least in part on receiving the image data 1224. The user alert 1234 may provide a visual indication, displayable on a client device 1108, 1110 associated with the A/V recording and communication device 1102, that motion has been detected by the A/V recording and communication device 1102.

As another example, the processor 1308 of the hub device 1112 may be configured to receive, using the communication module 1304, input data 1228 from the client device 1108, 1110. In some of the present embodiments, a user interface may be presented on a display 1520 of the client device 1108, 1110 upon, for example, selection of the user alert 1234. The user interface may present a live or near-live (e.g., offset by a short time) video feed of the field of view of the camera 1204 of the A/V recording and communication device 1102.

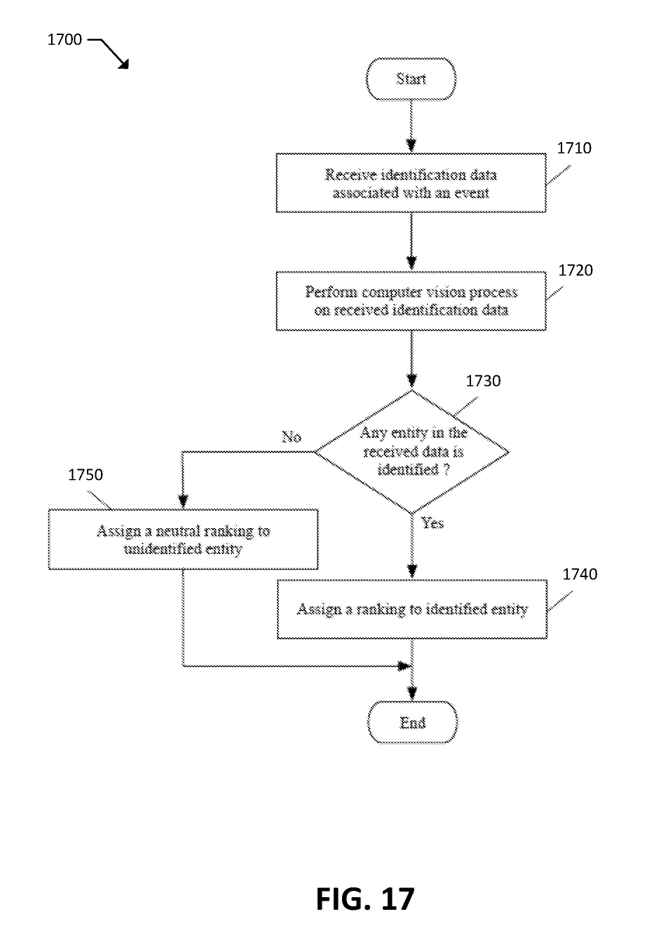

Additionally, or alternatively, the user interface may display one or more indicators of videos and/or image data 1224. The indicators may be displayed in an order based on one or more rules 1314 configured to show a prioritization of the videos and/or image data 1224. The one or more rules 1314 may be identified, determined, and/or generated by, for example, the processor 1308 of the smart-home hub device 1112, the backend server 1122, and/or the client device 1108, 1110, such as via the ranking component 1246. The one or more rules 1314 may be based on, for example, at least one of multiple factors. The factors may include the concepts described herein with respect to FIGS. 16-25, for example. Additionally, or alternatively, the factors may include the following concepts.

The processor 1308 of the hub device 1112 may identify, determine, and/or generate a rule 1314 based on an amount of a video that has been watched by a user associated with the client device 1108, 1110. For example, videos corresponding to image data 1224 captured and/or generated by an A/V recording and communication device 1102 may have various lengths, also described as durations. In some examples, a user may view the entirety of the video. In other examples, the user may view only a portion of the video, such as a percentage of the duration of the video. Videos and/or objects in videos that are viewed in their entirety may be ranked more highly than videos and/or objects in videos that are viewed less than in their entirety. Additionally, videos and/or objects in videos that are viewed a threshold amount may be ranked more highly than videos and/or objects in videos that are viewed less than the threshold amount. The threshold amount may be static or dynamic. For example, the threshold amount may be a certain percentage of the duration of the video and/or a certain amount of time, such as 5 seconds, 10 seconds, 15 seconds, 20 seconds 25 seconds, 30 seconds, or one minute, for example. In other examples, the threshold amount may change depending on the duration of a given video (e.g., may be calculated as a percentage of the video length), and/or the client device 1108, 1110 on which the video is being displayed, and/or the A/V recording and communication device 1102, 1128 from which the video was received, for example.

Additionally, or alternatively, the processor 1308 of the hub device 1112 may identify, determine, and/or generate a rule 1314 base on a number of times a video is displayed by the client device 1108, 1110. For example, the video may be stored on and/or accessible by the client device 1108, 1110. A user may view the video and/or a portion thereof no times, one time, or multiple times. Data indicating the number of times the video has been displayed by the client device 1108, 1110 may be identified, determined, and/or generated and may be utilized to rank the video with respect to other videos. For example, a first video and/or objects in a first video that is viewed more times than a second video and/or objects in a second video may be prioritized over the second video.

Additionally, or alternatively, the processor 1308 of the hub device 1112 may identify, determine, and/or generate a rule 1314 based on a number of times a storage location indicator corresponding to a video is sent from the client device 1108, 1110. For example, a storage location indicator may be a visual indication, such as a link, that corresponds to a video and, when selected, causes the storage location at which the video is stored to be accessed and utilized to display the video. This concept may be described as “sharing” a video. A first video and/or storage location indicator associated with the first video that is shared more frequently than a second video and/or storage location indicator associated with the second video may be prioritized over the second video and/or storage location indicator associated with the second video.

Additionally, or alternatively, the processor 1308 of the hub device 1112 may identify, determine, and/or generate a rule 1314 based on a determination that a video has been downloaded to the client device 1108, 1110 and/or another device associated with the client device 1108, 1110. For example, image data 1224, such as from an A/V recording and communication device 1102 may be stored in a database of the backend server 1122 and/or the smart-home hub device 1112. The client device 1108, 1110 may access the database to view the image data 1224, but the image data 1224 may not be downloaded to memory local to the client device 1108, 1110. However, in embodiments, the user interface may display a selectable option to download a video. Upon selection of the option, the video may be downloaded to memory local to the client device 1108, 1110. Data may be generated indicating that a video has been downloaded. Videos and/or objects in videos that have been downloaded to memory of the client device 1108, 1110 may be prioritized over videos and/or objects in videos that have not been downloaded.

Additionally, or alternatively, the processor 1308 of the hub device 1112 may identify, determine, and/or generate a rule 1314 based on a determination that at least one of a video and a storage location indicator corresponding to the video has been posted to a social network. For example, storage location indicators corresponding to videos may be displayed via the user interface of the client device 1108, 1110. The user interface may also display a selectable option to post the video and/or the storage location indicator to a social network, such as, for example, Facebook®. Videos and/or objects in videos that have been posted to a social network may be prioritized over videos and/or objects in videos that have not been posted to a social network. Additionally, videos and/or objects in videos that have been commented on, liked, or otherwise interacted with on the social network may be prioritized over videos and/or objects in videos that have not been commented on, liked, or otherwise interacted with on the social network.

Additionally, or alternatively, the processor 1308 of the hub device 1112 may identify, determine, and/or generate a rule 1314 based on user input data 1316, which may include data indicating user input that is received by an application that is displaying a video. The additional user input may include, pausing the video, rewinding the video, rating the video, and/or providing user input not related to the video. For example, a user may view the video and then provide additional user input indicating that the user has stayed in the application after viewing the video. Videos and/or objects in videos where additional user input is received after viewing the video may be prioritized over videos and/or objects in videos where no additional user input is received.

Additionally, or alternatively, the processor 1308 of the hub device 1112 may identify, determine, and/or generate a rule 1314 based on a determination that the video is deleted from the client device 1108, 1110. For example, as described above, a video may be downloaded to memory local to the client device 1108, 1110. The user interface may provide a selectable option to delete the video from the memory of the client device 1108, 1110. Upon selection of the option, the video may be deleted from the memory and data indicating that the video has been deleted may be generated and utilized to rank the video and/or objects in the video. For example, videos and/or objects in videos that have not been deleted may be prioritized over videos and/or objects in videos that have been deleted from the memory local to the client device 1108, 1110.

Additionally, or alternatively, the processor 1308 of the hub device 1112 may identify, determine, and/or generate a rule 1314 based on a determination that a video has not been displayed by the client device 1108, 1110. For example, storage location indicators associated with videos may be displayed on the user interface of the client device 1108, 1110. However, the video associated with a particular storage location indicator may not be displayed unless the storage location indicator is selected, such as via a touch input on a portion of a screen of the client device 1108, 1110 that is displaying a rendering of the storage location indicator. Data may be generated (e.g., the user input data 1316) indicating which storage location indicators have been selected and therefore which videos have been displayed, at least in part, on the client device 1108, 1110. Videos and/or objects in videos that have been displayed, at least in part, on the client device 1108, 1110 may be prioritized over videos and/or objects in videos that have not been displayed on the client device 1108, 1110.

Additionally, or alternatively, the processor 1308 of the hub device 1112 may identify, determine, and/or generate a rule 1314 based on a classification of a video and/or an object depicted in a video. The classification may be based on data indicating a location of an object within the video. For example, a field of view may be associated with a camera of the A/V recording and communication device 1102. The camera 1204 may capture images within the field of view and generate corresponding image data 1224. The image data 1224 may be analyzed to determine a location, relative to the camera 1204, of the object. The location may be associated with different portions of an environment depicted in the field of view. The portions of the environment may include, for example, a doorstep, a walkway, a driveway, a lawn, a hillside, a street, a mail-receptacle area, etc. Objects detected in certain portions of an environment may be prioritized over objects in other portions of the environment. For example, videos and/or objects in videos where an object is detected in the mail-receptacle area may be prioritized over videos and/or objects in videos where an object is detected in another portion of the environment, such as a lawn portion. By way of further example, videos and/or objects in videos where an object is detected in the driveway and/or walkway portion of the environment may be prioritized over videos and/or objects in videos where an object is detected in a street portion of the environment.

Additionally, or alternatively, the processor 1308 of the hub device 1112 may identify, determine, and/or generate a rule 1314 based on scheduling data indicating that at least one of the user alerts 1234 was transmitted during a period of time corresponding to an appointment that is located away from location associated with at least one A/V recording and communication device 1102. For example, the scheduling data may be received via a calendar application stored on and/or accessible by the client device 1108, 1110. The scheduling data may indicate a location associated with the appointment, which may be, for example, a place name, an address, or a classification of a place, such as “work.” When the location of the appointment does not correspond to a location of the A/V recording and/or communication device 1102, and the video is generated during a time indicative of the appointment, the video may be prioritized over other videos generated during times when no such appointment is scheduled.

Additionally, or alternatively, the classification of the video and/or the object depicted in the video may be based on data indicating detection of motion in a zone associated with one of one or more A/V recording and communication devices 1102. The field of view of one or more motion sensors of the A/V recording and communication devices 1102 may be classified into zones associated with different portions of the field of view. Certain zones may be prioritized over other zones. As such, videos and/or objects in videos where motion is detected in a prioritized zone may be prioritized over videos and/or objects in videos where motion is detected in a less-prioritized zone.

Additionally, or alternatively, the classification of the video and/or the object depicted in the video may be based on data indicating a time of day at which the video was generated. For example, when image data 1224 is generated, a time stamp or other data indicating the time as which the image data 1224 was generated may be generated and associated with the image data 1224. Videos and/or objects in videos generated during certain times of a day and/or certain days of a week may be prioritized over videos and/or objects in videos generated during other times of a day and/or other days of a week. For example, videos generated during the night may be indicative of an unwanted visitor walking into the field of view of the A/V recording and communication device 1102. By way of continued example, videos generated during a time of day that corresponds to when a resident of a household typically leaves or work and/or returns home from work and where the resident's vehicle and/or person is captured in the video may be deprioritized (e.g., prioritized below evening videos and/or late-night videos).

Additionally, or alternatively, the classification of the video and/or the object depicted in the video may be based on data indicating an amount of time that motion was detected by an A/V recording and communication device 1102. For example, motion may be detected for various amounts of time. Shorter amounts of time may be associated with the quick delivery of a package, a knock on the door from a solicitor, a cat roaming past a doorstep, a car driving by, a person walking by a sideway, etc. Longer amounts of time may be associated with a service technician arriving at a home, a neighbor in need, a nefarious visitor looking to perform illegal activity, etc. Videos and/or objects in videos where the amount of time that motion was detected is greater than other videos and/or objects in the other videos where the amount of time that motion may be prioritized over the other videos and/or objects in the other videos.

Additionally, or alternatively, the classification of the video and/or the object depicted in the video may be based on weather data indicating at least one of a temperature, presence of rain, presence of snow, presence of sun, and presence of clouds at a location associated with at least one A/V recording and communication device 1102. For example, it may be determined that a user interacts with a video more commonly when that video is captured during certain weather conditions. Such videos and/or objects in such videos may be prioritized over other videos and/or objects in other videos.

Additionally, or alternatively, the classification of the video and/or the object depicted in the video may be based on data indicating an event type associated with an event causing the video to be generated and/or displayed. Event types may include, for example, motion-only events, missed-ring events, answered-ring events, neighborhood events, and/or motion-and-ring events. Certain event types may be prioritized over other event types. The prioritization of event types may be predetermined or may be based on historical data indicating which event types are associated with videos that are most commonly viewed on the client device 1108, 1110. Videos and/or objects in videos with prioritized event types may be prioritized over videos and/or objects in videos with less-prioritized event types.

Additionally, or alternatively, the classification of the video and/or the object depicted in the video may be based on data indicating a user profile 1318 associated with the client device 1108, 1110. For example, a client device 1108, 1110 may be associated with multiple user profiles 1318 and/or user accounts (which may also be illustrated by user profiles 1318). For example, the client device 1108, 1110 may be a communal device used by multiple people. Some or all of the people may be associated with their own user profiles 1318 and/or user accounts. Certain user profiles 1318 may be associated with prioritization rules 1314 that differ from other user profiles 1318. Video and/or objects in videos may be prioritized based on the prioritization rules 1314 associated with the user profiles 1318.

The rules 1314 described above may be utilized to display storage location indicators and/or other indicators associated with videos on the client device 1108, 1110. The ranking component 1246 may be configured to apply the one or more rules 1314 described herein to display the storage location indicators and/or other indicators associated with videos on the client device 1108, 1110.

Additionally, the memory 1310 may include device associations data 1244, which may indicate associations between A/V recording and communication devices 1102. For example, the processor 1308 of the hub device 1122 may identify, determine, generate, and/or store device associations data 1244 in the non-volatile memory 1310. The device associations data 1244 may indicate associations between A/V recording and communication devices 1102, client devices 1108, 1110, hub devices 1112, user profiles 1318, and/or user accounts. For example, the A/V recording and communication device 1102 may be associated with a physical address that is the same as a physical address associated with another A/V recording and communication device 1102. Additionally, or alternatively, the A/V recording and communication device 1102 may be associated with a different physical address than the other A/V recording and communication device(s) 1128, but the two physical addresses share common characteristics, such as being located within a predefined proximity, and/or sharing street names, cities, states, and/or zip codes. Additionally, or alternatively, the A/V recording and communication device 1102 may be associated with the same user profile 1318 and/or user account as the other A/V recording and communication devices 1102. Additionally, or alternatively, the A/V recording and communication device 1102 may be associated with a first location and the other A/V recording and communication device(s) 1128 may be associated with a second location. When the first location is within a threshold distance (e.g., a threshold proximity) from the second location, the A/V recording and communication device 1102 may be associated may be associated with the A/V recording and communication device 1102. Additionally, or alternatively, the A/V recording and communication devices 1102, 1128 may be associated with the same neighborhood and/or neighborhood group (e.g., a network of A/V recording and communication devices 1108, 1128 associated based on their locations and/or based on a subscription to the network). Input data 1228 from associated devices, determined based on the device associations data 1244, may be utilized along with the one or more rules 1314 described herein to prioritize image data 1224.

Additionally, the memory 1310 may include an object identification component 1248, which may be configured to identify one or more objects and/or object types depicted in the image data 1224. The object identification component 1248 may detect objects and/or object types based at least in part on the operations described with respect to FIGS. 1, 7, 9, and 17.

Additionally, the memory 1310 may include ranking data 1320, which may include data from one or more A/V recording and communication devices 1102, 1128 and/or one or more client devices 1108, 1110. The ranking data 1320 may indicate how image data 1224 and/or videos and/or storage location indicators corresponding to image data 1224 are to be ranked with respect to each other. The ranking data 1320 may be generated based on applying the one or more rules 1314 described herein utilizing the user input data 1316 to prioritize image data 1224.

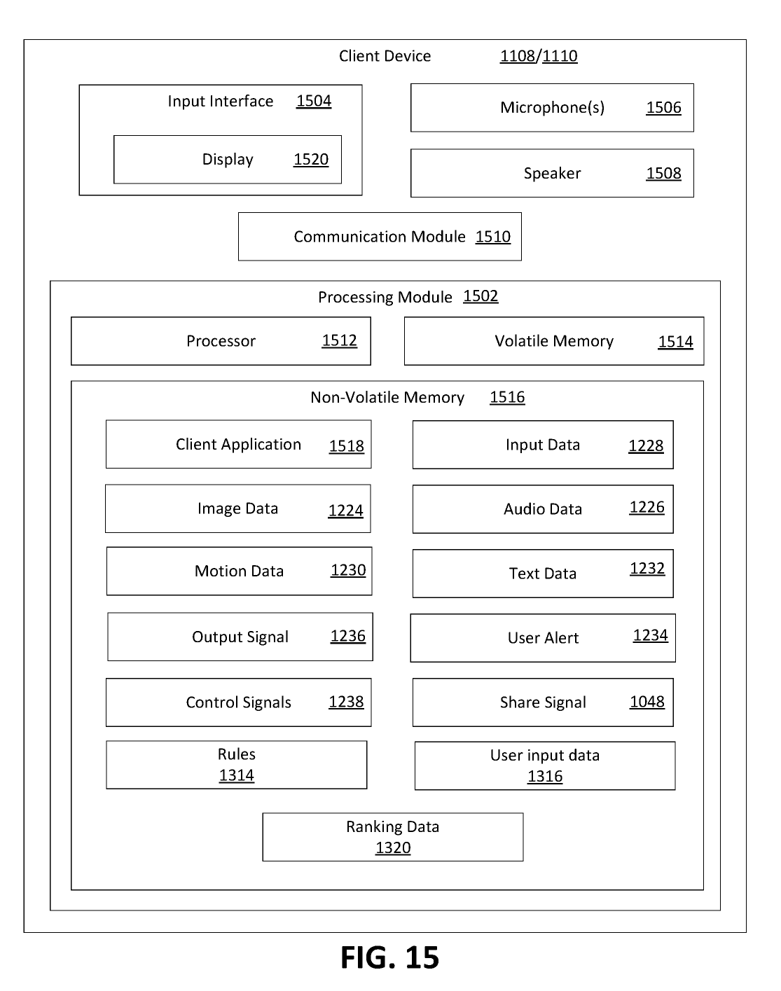

FIG. 14 is a functional block diagram illustrating an example of the backend server(s) 1122 according to various aspects of the present disclosure. The backend server(s) 1122 (and/or other devices from the network of servers/backend devices 1118) may comprise a communication module 1402 and a processing module 1404, which may include a processor 1406, volatile memory 1408, and non-volatile memory 1410. The communication module 1402 may allow the backend server(s) 1122 to access and communicate with devices connected to the network (Internet/PSTN) 1106 (e.g., the A/V recording and communication device 1102, the hub device 1112, the client devices 1108, 1110, and/or a device controlled by the security monitoring service 1126). The non-volatile memory 1410 may include a server application 1412 that configures the processor 1406 to receive and/or retrieve the audio data 1226, the text data 1232, the input data 1228, the user alerts 1234, the image data 1224, and/or the motion data 1230 from the A/V recording and communication device 1102 (e.g., in the output signal 1236) and/or the hub device 1112. The server application 1412 may also configure the processor 1406 to transmit (and/or forward) the audio data 1226, the text data 1232, the input data 1228, the user alerts 1234, the image data 1224, the motion data 1230, and/or the device associations data 1244 to the client devices 1108, 1110, the A/V recording and communication devices 1102, and/or the hub device 1112 using the communication module 1402.

In further reference to FIG. 14, the non-volatile memory 506 may also include source identifying data 1414 that may be used to identify the A/V recording and communication device 1102, the hub device 1112, and/or the client devices 1108, 1110. In addition, the source identifying data 1414 may be used by the processor 1406 of the backend server 1122 to determine the client devices 1108, 1110 associated with the A/V recording and communication device 1102 and/or the hub device 1112.

In some of the present embodiments, the server application 1412 may further configure the processor 1406 to generate and transmit a report signal (not shown) to a third-party client device (not shown), which may be associated with a law enforcement agency or the security monitoring service, for example. The report signal, which may be the user alert 1234, in some examples, may include the image data 1224, the audio data 1226, and/or the text data 1232. In these examples, an operator of the third-party client device may be able to view the image data 1224, and/or the text data 1232 to help in making a determination of whether a person in the field of view of the A/V recording and communication device 1102 is suspicious and/or performing suspicious activities.

As described herein, at least some of the processes of the A/V recording and communication device 1102, the hub device 1112, and/or the client device 1108, 1110 may be executed by the backend server 1122. For example, similar to the functions and processes described above with respect to the hub device 1112, the processor 1406 of the backend server 1122 may be configured to receive, via the communication module 1402, the image data 1224 generated by the camera 1204 of a field of view of the camera 1204. The processor 1406 of the backend server 1122 may be further configured to generate the user alert 1234 based at least in part on the A/V recording and communication device 1102 detecting motion and/or based at least in part on receiving the image data 1224. The user alert 1234 may provide a visual indication, displayable on a client device 1108, 1110 associated with the A/V recording and communication device 1102, that motion has been detected by the A/V recording and communication device 1102. Additionally, similar to the functions and processes described above with respect to the hub device 1112, the processor 1406 of the backend server 1122 may be configured to identify, determine, and/or generate rules 1314.

The hub device 1112 and/or the backend server 1122 (and/or one or more other devices from the network(s) of servers/backend devices 1118) may alternatively be referred to as network devices.

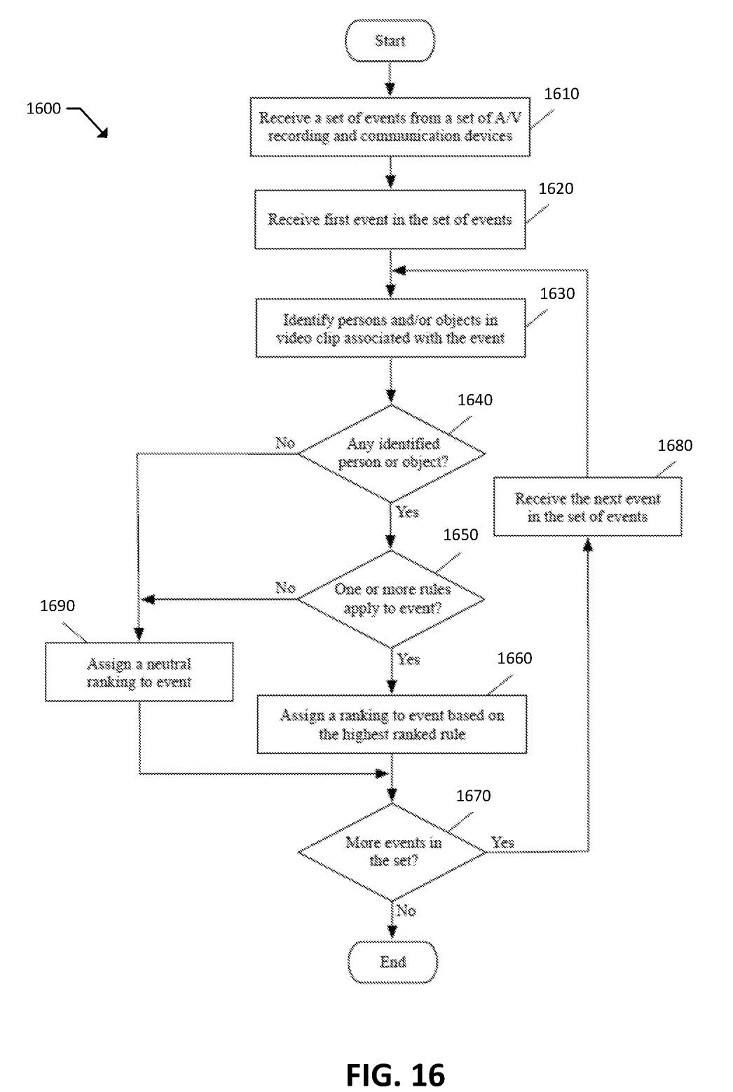

FIG. 15 is a functional block diagram illustrating one embodiment of a client device 1108, 1110 according to various aspects of the present disclosure. The client device 1108, 1110 may comprise a processing module 1502 that is operatively connected to an input interface 1504, microphone(s) 1506, a speaker(s) 1508, and/or a communication module 1510. The client device 1108, 1110 may further comprise a camera (not shown) operatively connected to the processing module 1502. The processing module 1502 may comprise a processor 1512, volatile memory 1514, and non-volatile memory 1516, which may include a client application 1518. In various embodiments, the client application 1518 may configure the processor 1512 to receive input(s) to the input interface 1504 (e.g., requests for access to the A/V recording and communication device 1102) and/or to capture the audio using the microphone(s) 1506, for example. In addition, the client application 1518 may configure the processor 1512 to receive input data 1228, image data 1224, audio data 1226, the output signal 1236, and/or the user alert 1234 from one or more of the A/V recording and communication devices 1102, the hub device 1112, and the backend server 1122. Furthermore, the client application 1518 may configure the processor 1512 to transmit the audio data and the control signals 1238 to one or more of the A/V recording and communication devices 1102, the hub device 1112, and the network device 1122. In some embodiments, the client device 1108, 1110 may generate and transmit a share signal 1048 using the image data 1224, the audio data 1226, and/or the text data 1232 to the backend server 1122, as described above. As further described below, the share signal 1048 may be received by the backend server 1122, where it may be transmitted (forwarded) to client devices 1109 associated with one or more A/V recording and communication devices 1102 that are not associated with the client device 1108, 1110 (e.g., client devices 1109 associated with other A/V recording and communication devices 1102 located at other locations than the A/V recording and communication device 1102 associated with the client device 1108, 1110, such as at a neighbor's property).

With further reference to FIG. 15, the input interface 1504 may include a display 1520. The display 1520 may include a touchscreen, such that the user of the client device 1108, 1110 may provide inputs directly to the display 1520 (e.g., interactions with the image data 1224). In some embodiments, the client device 1108, 1110 may not include a touchscreen. In such embodiments, the user may provide an input using any input device, such as, without limitation, a mouse, a trackball, a touchpad, a joystick, a pointing stick, a stylus, etc.

In some of the present embodiments, based at least in part on receiving a user alert 1234, the client application 1518 may configure the processor 1512 to cause the display 1520 to display the user alert 1234. While displaying the user alert 1234, the user interface 1504 may receive input from the user to answer the user alert 1234. In response, the client application 1518 may configure the processor 1512 to display the received image data 1224 using the display 1520. Additionally, the client application 1518 may configure the processor 1512 to output audio represented by the audio data 1226 using the speaker 1508. Furthermore, a two-way audio communication may occur between the user of the client device 1108, 1110 and a visitor using the client device 1108, 1110 and the A/V recording and communication device 1102.

Additionally, or alternatively, the processor 1512 of the client device 1108, 1110 may be configured to perform one or more operations via the client application 1518. The operations may include, for example, receiving (in some embodiments, via the hub device 1112 and/or the backend server 1122) the image data 1224 generated by the camera 1204 of a first A/V recording and communication device 1102 (e.g., the A/V recording and communication doorbell 302). The image data 1224 may be received based at least in part on, and/or in response to, the first A/V recording and communication device 1102 detecting motion. The operations may further include causing the image data 1224 to be displayed on the display 1520 of the client device 1108, 1110. Causing the image data 1224 to be displayed may be based at least in part on a user input representing a selection of a user alert 1234 sent to the client device 1108, 1110 via one or more of the first A/V recording and communication device 1102, a smart-home hub device 1112, and/or a backend server 1122. The operations may further include generating the user input data 1316 indicating how the user interacts with the image data 1224 (e.g., videos). The processor 1512 of the client device 1108, 1110 may then transmit, using the communication module 1510, the user input data 1316 to the hub device 1112 and/or the backend server 1122.

In the illustrated embodiment of FIGS. 12-15, the various components including (but not limited to) the processing modules 1202, 1302, 1410, 1502 and the communication modules 1212, 1304, 1402, 1510 are represented by separate boxes. The graphical representations depicted in each of FIGS. 12-15 are, however, merely examples, and are not intended to indicate that any of the various components of the A/V recording and communication device 1102, the hub device 1112, the backend server(s) 1122, and/or the client device 1108, 1110 are necessarily physically separate from one another, although in some embodiments they might be. In other embodiments, however, the structure and/or functionality of any or all of the components of each of the A/V recording and communication device 1102, the hub device 1112, the backend server 1122, and/or the client device 1108, 1110 may be combined. As an example, the structure and/or functionality of any or all of the components of the A/V recording and communication device 1102 may be combined. In addition, in some embodiments the communication module 1212 may include its own processor, volatile memory, and/or non-volatile memory. As a second example, the structure and/or functionality of any or all of the components of the hub device 1112 may be combined. In addition, in some embodiments the communication module 1302 may include its own processor, volatile memory, and/or non-volatile memory. As a third example, the structure and/or functionality of any or all of the components of the backend server 1122 may be combined. In addition, in some embodiments the communication module 1410 may include its own processor, volatile memory, and/or non-volatile memory. Finally, as a fourth example, the structure and/or functionality of any or all of the components of the client device 1108, 1110 may be combined. In addition, in some embodiments the communication module 1502 may include its own processor, volatile memory, and/or non-volatile memory.

Each of the processes described herein, including the processes 1600, 1700, 1900, 2200, 2400, are illustrated as a collection of blocks in a logical flow graph, which represent a sequence of operations that may be implemented in hardware, software, or a combination thereof. In the context of software, the blocks represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks may be combined in any order and/or in parallel to implement the processes. Additionally, any number of the described blocks may be optional and eliminated to implement the processes.

FIG. 16 is a flowchart illustrating a process 1600 for prioritizing (or ranking) the events generated by one or more A/V recording and communication devices, according to some aspects of the present embodiments. In some of the present embodiments, the process of ranking the events may be performed by one or more backend devices such as the backend server 118 and/or the backend API 122 (FIG. 1). In some other embodiments, the process may be performed by A/V recording and communication devices, such as the A/V recording and communication device 102 (FIG. 1). In yet other embodiments, some parts of the process of ranking/prioritizing events may be performed by one or more backend servers, while some other parts of the process may be performed by the A/V recording and communication devices.

The process 1600 initiates at block 1610 by receiving a set of events from a set of A/V recording and communication devices. The set of A/V recording and communication devices may be installed at a same property (e.g., inside and/or outside a house), or they might be installed at several different properties (e.g., a first subset of the A/V recording and communication devices installed at a first property, a second subset of the A/V recording and communication devices installed at a second property, etc.). In some of the present embodiments, each time an A/V recording and communication device detects a presence of a person or an object (e.g., through one or more motion detectors of the device, when a doorbell button of the device is pressed, etc.), the A/V recording and communication device generates an event for the detected presence. As described above, the A/V recording and communication device may also associate video footage (e.g., A/V data recoded by a video camera and a microphone of the A/V recording and communication device) to the generated event. In some of the present embodiments, the associated video footage may start from the time movement is detected and may last for a specific period of time (e.g., 30 seconds, 45 seconds, etc.), or it may last until movement is no longer detected, or it may last until an established communication session (e.g., between a visitor and a user) is terminated. In one aspect of the present embodiments the video footage may start with a very short delay and a little after the presence of a person or object is detected (e.g., by a motion sensor of the device).

After receiving the set of events, at block 1620, the process 1600 selects the first event in the set of received events. At block 1630, the process 1600 may analyze the selected event to identify one or more persons and/or objects that appear in video footage associated with the selected event. In some of the present embodiments, the process may identify a class that includes the person and/or object appearing in the video footage. For example, a class detection process may comprise identifying a class of an object in the video footage. Example object classes include, without limitation, persons, parcels, animals, and vehicles. If the class detection process successfully identifies the class of the object in the video footage, a further process may comprise class recognition, where class recognition comprises identifying a particular member of the identified class. For example, if the identified class is a person, class recognition may comprise identifying a particular person (e.g., John Smith). In some embodiments, identifying the particular member of the identified class may comprise using biometric data, such as facial recognition data. In other embodiments, identifying the particular member of the identified class may comprise using computer vision.

To identify a person or an object, the A/V recording and communication device of some of the present embodiments may send (e.g., through wired and/or wireless networks) the person's/object's identification data (e.g., a set of video images of the person/object) to one or more backend devices and/or services (e.g., backend servers). The servers, in turn, may identify the person or object, e.g., using one of the above-described AIDC or computer vision methods and one or more databases, such as databases of authorized visitors, criminals, suspicious persons, etc. For example, with reference to FIGS. 7 and 16, information received by the computer vision module 744 of the A/V recording and communication device 102 may be sent to one or more network devices, such as the server 120 and/or the backend API 122 (e.g., in a computer vision query signal) to query about the identification of the person or object. In some aspects of the present embodiments, however, the A/V recording and communication device 102 may identify the person or object without exchanging identification data with backend devices (e.g., by performing identification processes locally using data stored at the A/V recording and communication device). In yet other aspects of the present embodiments, the identification of the person or object may be determined by a combination of the A/V recording and communication device 102 and one or more backend devices.

In some aspects of the present embodiments, the information sent to the backend devices and/or services may be compared with other information stored at one or more backend devices and/or services (e.g., databases) to determine whether there is a match and/or whether one or more rules 1314 in a set of rules 1314 apply to the identified person or object. For instance, one or more images (and/or other biometric data) of a person appearing in the video footage may be compared with photos and/or images (and/or other biometric data) of authorized visitors, known suspicious persons, criminals, etc., to identify the person. If a match is found during the process, some embodiments may assign a ranking (e.g., by the backend servers or by the A/V recording and communication device) based on the database against which a match for the person or object is found. For example, if the visitor is matched against a criminal database's records, and there is a rule 1314 to assign a higher priority to criminals, some of the present embodiments may assign a higher priority to the event and video footage that contain the identified visitor. Conversely, when the visitor is matched against a known and authorized persons' database and a rule 1314 is defined to assign a lower priority to known and/or authorized persons, some embodiments may assign a lower ranking to the event and video footage that contain the visitor. The databases described above, and elsewhere herein, are merely examples, and should not be construed as limiting. In some embodiments, information about visitors may be retrieved from a single database, or from a plurality of databases other than those described herein.

The databases may contain as much information as possible about each known suspicious person, criminal, authorized person, etc., such as their facial features or characteristics, name, aliases, and/or criminal history. However, the databases may also contain as little information as an image of the face of a known suspicious person, criminal, etc., even if that person is otherwise unidentified by name or other typical identifying information. In some embodiments, the database(s) of known suspicious persons, criminal, etc. maybe one or more databases of wanted criminals (e.g., from a “most wanted” list), convicted felons, and/or registered sex offenders. In other embodiments, the database of known suspicious persons may be modified by the user, such as through the client device. Specifically, the user may, upon review of stored images of visitors, flag a particular stored image of a visitor as suspicious or threatening. This image may then be uploaded into the database. This flagging function can further be notated by the user as a “public” suspicious or threatening person, who might be exhibiting suspicious or threatening behavior as to an entire neighborhood, such as, for example, a suspicious or threatening person that the user saw breaking a neighbor's windows, or it can be notated by the user as a “private” suspicious or threatening person, such as, for example a hostile co-worker whose presence may be suspicious or threatening with respect to the user's home, but not to the public at large.

Additionally, a user may upload one or more images of persons that the user considers suspicious, threatening, authorized users, family members, etc., into the databases, from sources other than those captured by an A/V recording and communication device (e.g., from the user's smartphone camera). This example embodiment allows for the user to assign a ranking to persons that have different values to the user, for example, an ex-spouse, a hostile co-worker, a hostile neighbor, a friend, a mail carrier, etc., but who may not be identifiable through public databases.

Furthermore, in some embodiments, a crime(s) and/or suspicious event(s) may have been recorded by an A/V recording and communication device other than the ones associated with the owner/occupant of the property. For example, another user of an A/V recording and communication device may view video footage that was recorded by his or her device and determine that the person or persons in the video footage are, or may be, engaged in suspicious or threatening activity and/or criminal activity. The other user may then share that video footage with one or more other people, such as other users of A/V recording and communication devices, and/or one or more organizations, including one or more law enforcement agencies. The present embodiments may leverage this shared video footage for use in comparing with the information in the computer vision query to determine whether a person detected in the area about the A/V recording and communication device is the same person that was the subject of (and/or depicted in) the shared video footage.

With further reference to FIG. 16, at block 1640 the process 1600 determines whether the person or object could be identified. If the process determines that the person or object was not identifiable, the process 1600 may assign (at block 1690) a neutral ranking to the event associated with the person or object (e.g., the process may assign a particular value, such as a zero, to the event). The process 1600 then proceeds to block 1670, which is described below. If, however, the process 1600 identifies the person or object at block 1640, then at block 1650 the process 1600 determines whether one or more rules 1314 in a set of rules 1314 apply to the identified person or object.

In some of the present embodiments, the set of rules 1314 may be defined by a user and/or by the system (e.g., a rule 1314 to learn that a person or object may have a higher value to a user based on a set of criteria). A user may explicitly define one or more rules 1314 for different persons or objects. For example, the user may tag a person that has appeared in a video as a person of interest. In some embodiments, the user may even specify the level of interest in the person (e.g., low importance, highly interested, etc.). In other examples, rules 1314 according to the present embodiments, the system may assign a level of importance to an event and/or a person automatically and based on a set of criteria.

The set of criteria may include predefined criteria and/or user-defined criteria. For instance, a criterion in the set of criteria may be the number of appearances of a person in different video footage associated with different events. For example, a system-defined rule 1314 may specify that if the same person appears in more than a threshold number of videos (e.g., more than 1 video, or more than 2 videos, or more than 3 videos, etc.) that are recorded within a specified time period, then that person is very important. As an example, when a person lingers or loiters around a property, he or she may be detected, and recorded, by the A/V recording and communication device several times. A lingering or loitering stranger may pose a threat to persons and/or property, and is therefore of great interest to the user of the A/V recording and communication device. Conversely, a rule 1314 in the set of rules 1314 may specify that if a person appears in more than a threshold number of videos (e.g., within a specific period of time), the event associated with that person is not important. As an example, when a family member enters and leaves a house several times a day, he or she may be detected, and recorded, by the A/V recording and communication device each time, but a family member is typically not a threat to persons and/or property, and therefore may not be of great interest to the user of the A/V recording and communication device. Some aspects of the present embodiments may assign a higher priority to events that include a person with multiple appearances in video footage, only if that person has not been tagged (e.g., as a family member, or a friend, or any other authorized person) by the user before.

Another criterion in the set of criteria may be the number of times a user has viewed specific video footage. For example, a rule 1314 may specify that if a person appears in video footage that is watched by the user for more than a threshold number of times (e.g., more than 1 time, more than 2 times, etc.), a higher priority should be assigned to the video footage (and their corresponding events) that include that same person. Another criterion in the set of criteria may be the action that the user performs while viewing an event (e.g., pushing a talk button on the client device to talk to the visitor during a communication session, pushing a speaker button to hear the audio received by a microphone of the A/V recording and communication device, activating a siren or other component of the A/V recording and communication device (e.g., during a communication session) to scare away the visitor, etc.).

As discussed above, a rule 1314 in the set of rules 1314 may assign a highest ranking to an event in which one or more persons appear to be engaged in suspicious activity (e.g., carrying a weapon, such as a gun, or another suspicious object, such as a burglary tool). In some of the present embodiments, a user may override a predefined rule 1314 and/or criterion. For example, the user may change a rule 1314 that specifies a particular person/object as “highly important” to “not important.” Similarly, the user may change a rule 1314 that assigns a neutral ranking to unknown visitors to instead rank the unknown visitors as highly important.

Some of the present embodiments may rank an event that is generated by an A/V recording and communication device based on a combination of two or more criteria. For example, some aspects of the present embodiments may rank an event based on both the content of the event and the time of generation of the event. That is, even though a first event, based on the content of the event, could be assigned a higher ranking compared to a second event, some aspects of the present embodiments may rank the first event lower than the second event based on the time at which the first and second events are generated (e.g., when the first event is generated substantially prior to the second event).

With further reference to FIG. 16, when the process 1600 determines (at block 1650) that no rule 1314 in the set of rules 1314 applies to the event that is associated with the identified person or object, the process 1600 may assign (at block 1690) a neutral ranking to the event. The process 1600 then proceeds to block 1670, which is described below. If, however, the process 1600 determines at block 1650 that at least one rule 1314 in the set of rules 1314 applies to the event associated with the person or object, the process 1600 then ranks (at block 1660) the event based on the highest ranked rule. That is, when for an identified person or object, the set of rules 1314 includes more than one rule 1314 that applies to the person or object, the rule 1314 that has a higher ranking among the applicable rules 1314 may be applied to the person or object, in some embodiments.

In some of the present embodiments, the rankings of the rules 1314 may be defined by the user, by the system, or by a combination of both. For example, there may be a first rule 1314 that assigns a higher ranking to a person (e.g., because the user has tagged the person as a person of interest), while a second rule 1314 in the set of rules 1314 assigns a lower ranking to the same person (e.g., because the user is included in a database that contains authorized users). Some of the present embodiments may assign a higher ranking to the event associated with the person based on the first rule, because the first rule 1314 has a higher ranking than the second rule 1314 (e.g., because a system-defined rule 1314 specifies that rules 1314 that are defined by the user have higher priority than the rules 1314 that are defined by the system).

At block 1670, the process 1600 determines whether more events exist in the set of received events. If the process determines that no more events are left, then the process ends. When, however, the process determines that there are more events in the set of received events, then the process 1600 selects (at block 1680) the next event in the set of events and returns to block 1630 to determine the identity of the person(s) or object(s) associated with the selected event, and to assign a ranking to the event (e.g., based on such a determination and based on a set of rules 1314, as described above).

In some of the present embodiments, the set of events received by the above-described process may include only one event. That is, some aspects of the present embodiments may rank an event based on a set of rules 1314 as soon as the event is generated. Therefore, each time an event is generated, the above-described process may receive a set of only one (generated) event and may perform all of the above-described operations with reference to blocks 1620-1690 on the received event.

The specific operations of the above-described process may not be performed in the exact order shown and described. For example, when the process does not identify a person or object, the process may store the unidentified person or object in a database, which can then be used for future identifications. As an example, in some of the present embodiments the process may associate a counter to the unidentified person or object, and the counter may increase each time the person or object appears in other video footage. Such a counter can be used by, e.g., rules 1314 that learn about persons or objects over time. For example, the higher value the counter has, the higher ranking the person or object may have, in some embodiments.

Furthermore, the specific operations may not be performed in one continuous series of operations, and different specific operations may be performed in different embodiments. For example, when no rule 1314 in the set of rules 1314 is determined to be applicable to an event (at block 1650), some embodiments may assign a different ranking than the neutral ranking (that is described above at block 1690). For example, some embodiments may rank an event associated with an identified person or object to which no rule 1314 is applied higher than an event associated with a person or object that is not identifiable at all. Additionally, the above-described process could be implemented using several sub-processes, or as part of a larger process.

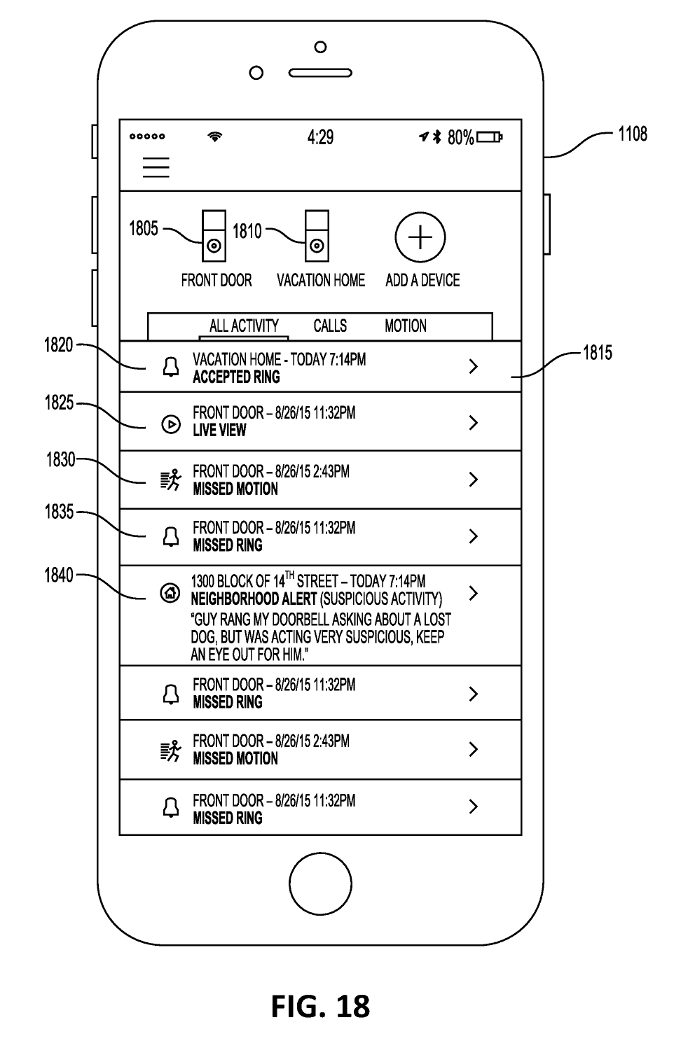

FIG. 17 is a flowchart illustrating a process 1700 for receiving identification data for an event and determining a ranking that should be assigned to the event, according to the present embodiments. In some of the present embodiments, the process described with reference to FIG. 6 may be performed by one or more backend devices (e.g., backend APIs and/or servers). In some other embodiments, the process may be performed by an A/V recording and communication device. In some of the present embodiments, some of the operations described above with reference to FIG. 16, such as the operations described with reference to blocks 1630-1660, may be performed according to the process described with reference to FIG. 17. With reference to FIG. 17, the process 1700 initiates by receiving (at block 1710) identification data associated with an event. As described above, the identification data may be related to a person at, or near, a property. The process may receive the identification data for the person from an A/V recording and communication device, such as a video doorbell or a security camera. That is, the process may receive one or more video images of the person from an A/V recording and communication device after the A/V recording and communication device detects the person and generates an event that contains video images of the detected person.

After receiving the identification data, at block 1720 the process 1700 performs a computer vision process on the received identification data to identify the person or object. As described above, the computer vision process may include face and/or object recognition, and/or any other biometrics recognition process to identify the person. For example, in a face recognition process, the face of the person may be compared with different databases of known persons, authorized persons, criminals, etc., as described above. At block 1730, the process 1700 determines whether the person or object was identified through the computer vision process (e.g., whether a match for the received identification data was found in any of the databases). When the process determines that no match was found, then the process 1700 of some embodiments assigns (at block 1750) a neutral ranking to the person, e.g., in the same manner described above for block 1690 of FIG. 16.

However, when the process matches the person or object against one or more of the databases, then the process 1700 of some embodiments assigns (at block 1740) a ranking to the identified person or object that may correspond to the database in which the person is found. For example, if the person is found in a database of convicted felons, and a rule 1314 specifies to assign a higher priority to felons, a high-level ranking may be assigned to the video footage and event that contain the identified person.

Although many of the present embodiments have been described with reference to persons detected by, or present in the area about, the A/V recording and communication device, the present embodiments are not limited, however, to scenarios involving humans. For example, the present embodiments may rank an event associated with an object (e.g., a bot, a drone, etc.) as a high ranked event when these embodiments contemplate that suspicious behavior may be committed by the object. For example, in some instances, the mere presence of a bot or drone in an event generated by an A/V recording and communication device may cause the event to be ranked as an important event, while in other instances, loitering by a drone will cause the event to be identified as important.

The above description discusses the general concepts and implementation of assigning different rankings/priorities to different events based on a set of different rules 1314 and/or criteria. In the following discussion, Section I describes intelligent presentation of a summary of events based on such rankings, according to some of the present embodiments. Section II describes providing different types of notifications when different events are generated based on the rankings associated with the events, according to some of the present embodiments. Section III describes presenting video streams from multiple cameras belonging to different A/V recording and communication devices, according to some of the present embodiments. Section IV describes artificial intelligence and machine learning concepts that may be employed in any of the present embodiments. Section V describes the electronic systems (e.g., a client device, an A/V recording and communication device, a general-purpose computing system, etc.) on which some of the present embodiments may be implemented.

As described above, conventional methods of presenting events generated by one or more A/V recording and communication devices (e.g., to a user) do not analyze the content of the events, and do not attempt to determine, based on the content analysis, whether any of the events are more important (or less important) to the user. Consequently, events that are more important to the user may be overlooked due to their inclusion among events that are less important to the user, which less important events may vastly outnumber the more important events. Some of the present embodiments solve this problem by analyzing the content of the video footage associated with each event, and then applying a set of rules 1314 to rank the events relative to one another. The ranked events are then presented to the user as an ordered list in decreasing order of interest or importance to the user (e.g., with the most interesting/important event at the top of the list). The user is thus more likely to notice important events, because they are presented more prominently in the ordered list. The set of rules 1314 may be defined by the user and/or by the system. Certain of the present embodiments may learn dynamically which events, such as which types or classes of events, are typically of greatest interest or importance to the user, and adjust the rankings process based on such a learning process.

In some of the present embodiments one or more applications that execute on a client device, such as the client device 1108/1110 shown in FIG. 15, may allow a user to interact with one or more events generated by a set of associated A/V recording and communication devices. Interacting with events, in some of the present embodiments, may include receiving notifications about new events, viewing a summary of the past events, communicating with a visitor associated with a live view event, viewing other events generated by other A/V recording and communication devices (e.g., belonging to other users in the same neighborhood), rating the events, etc. As described above, in some of the present embodiments a user may request to view a summary of the past events (e.g., video footage of the events that have already occurred at the time of the request). When no rule 1314 is defined to apply to the events, then upon receiving such a request, some embodiments may present (e.g., on a display of a client device) a list of past events that is ordered chronologically (e.g., with the most recent event appearing at the top of the list).

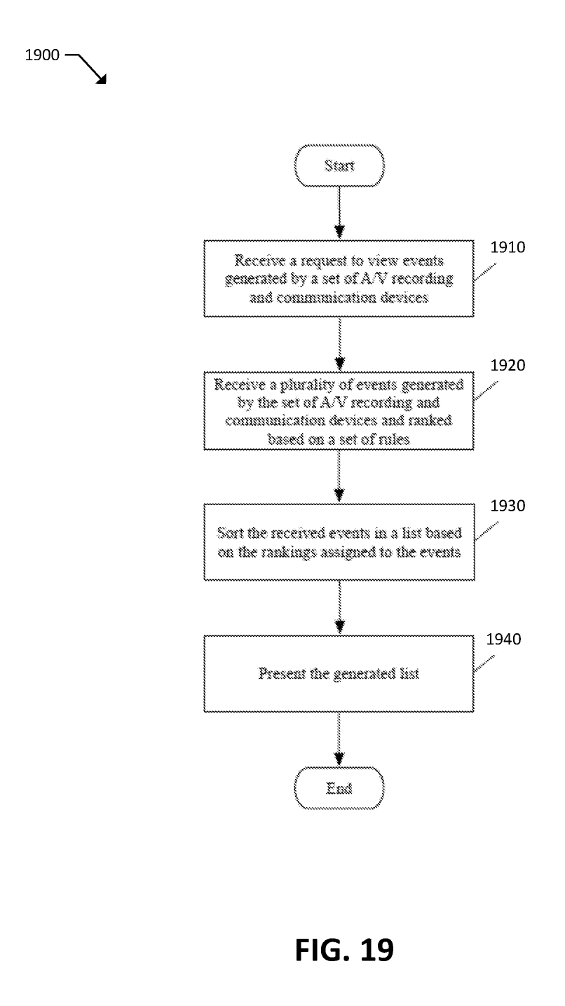

FIG. 18 illustrates an example of a summary of recent events displayed on a display of a client device by an application associated with one or more A/V recording and communication devices, according to various aspects of the present disclosure. With reference to

FIG. 18, the client device 1108/1110 (e.g., a smartphone) includes a display 1802 on which a graphical user interface (GUI) 1815 of an application is displayed. The application is associated with at least two A/V recording and communication devices 1805 (named as “Front Door”) and 1810 (named as “Vacation Home”). In some embodiments, when a user opens the application (e.g., by tapping an icon of the application displayed on the display 1802 of the client device 1108/1110, or by selecting the application using any other means), the GUI 1815 including the past events (e.g., events 1820-1840) may be presented to the user.

In the example illustrated in FIG. 18, no specific rule 1314 is defined for the events and, therefore, a default rule 1314 that arranges the events chronologically based on the time each event occurred has been applied to the events. Consequently, a list of past events that are sorted according to their time of occurrences is displayed to the user. As shown, the list includes an accepted ring event 1820, a live view event 1825, a missed motion event 1830, a missed ring event 1835, a neighborhood alert event 1840, etc. In some of the present embodiments the user can scroll down through the list to view older events (if more events are available).

As shown in FIG. 18, each event also includes the name of the A/V recording and communication device that generated the event, and the date and time of the event (e.g., the date and time at which the event is generated by the associated A/V recording and communication device). As shown, the presented list in the GUI 715 includes a combination of events generated by different A/V recording and communication devices. However, in some of the present embodiments the user may select one of the devices (e.g., one of the devices 1805 and 1810) to view only the events that are generated by the selected A/V recording and communication device. In some of the present embodiments, once a user selects any of the events presented in the GUI 1815 (e.g., by tapping on the event), video footage associated with the selected event may be presented to the user.

The accepted ring event 1820 shows to the user that the Vacation Home device 1810 (e.g., a video doorbell) has been activated and a doorbell ring was accepted (e.g., today at 7:14 PM as shown in the first line of the event's description). As described above, if the user selects this event, video footage associated with the event will be presented to the user to view the visitor, e.g., who has activated the Vacation Home device 1810, and possibly to listen to a conversation between the visitor and the user. The live view event 1825 indicates that the user has activated a live view option at some time in the past (e.g., at 11:32 PM, as shown above the event 725) for the Front Door device 1805 to see video footage being captured by a video camera of the Front Door device 1805 at that time.

The missed motion event 1830 and the missed ring event 1835 indicate that at some previous time (e.g., at 2:43 PM and 11:32 PM, respectively,) motion was detected by the Front Door device 1805 and a doorbell button of the Front Door device 1805 was pushed. The neighborhood alert event 1840 shows a concerned neighbor's message about a person ringing his/her doorbell, acting suspiciously, and asking for his lost dog. The neighbor's address, as well as the time and date of the message are shown above the alert message.

As described above, the illustrated list of events shown in FIG. 18 does not consider which event(s) may be of greater interest to the user, or which event(s) may be of less interest to the user. The only factor that separates the events from each other is their generation time, and the events are displayed chronologically with more recent events at the top of the list. Some of the present embodiments, by contrast, may identify one or more persons (and/or other objects) that appear in a video associated with each event and, based on such an identification, prioritize the events (e.g., based on a set of rules 1314) in an ordered summary list. Some of the present embodiments may present a subset of prioritized events that have occurred more recently. Some other embodiments may present a list that is sorted based on a combination of the time each event has occurred and the content of the event. That is, some of the present embodiments may rank each event that is generated by an A/V recording and communication device based on both the content of the event and the time the event is generated.

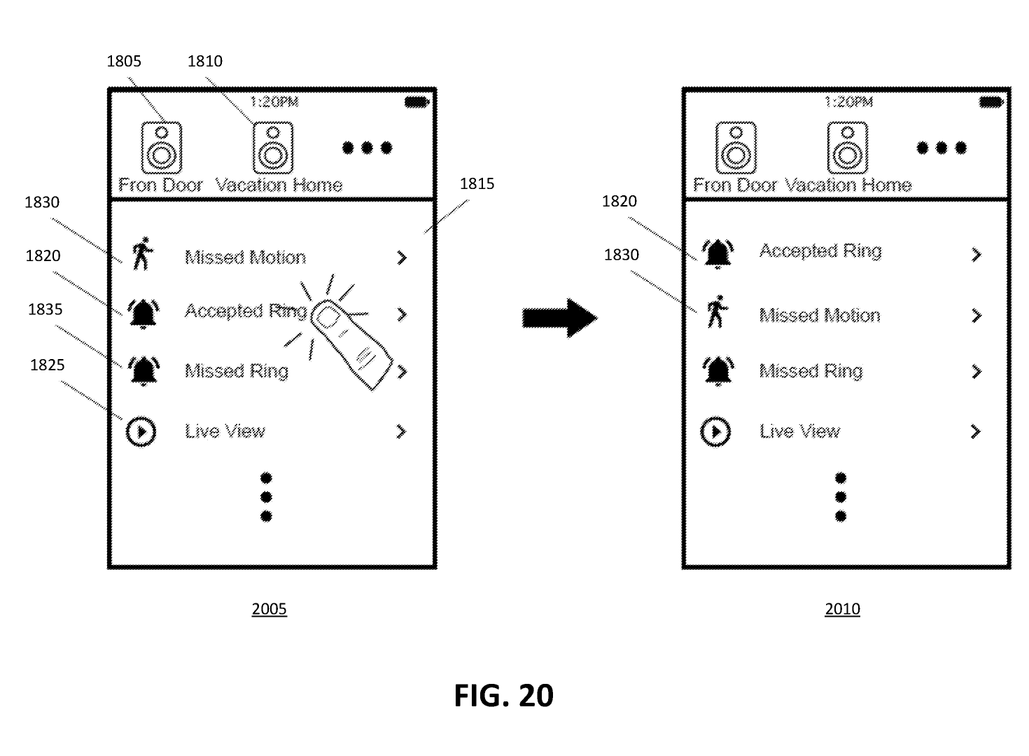

FIG. 19 is a flowchart illustrating a process 1900 for presenting a summary of recent events generated by one or more A/V recording and communication devices, according to some aspects of the present embodiments. This process may be performed by an application executing on a client device, in some embodiments. In some other embodiments, part of the process may be performed by an application running on the client device, and another part of the process may be performed by one or more backend devices. For example, in some aspects of the present embodiments, the operations 1910 and 1940 may be performed on a client device, while the operations 1920 and 1930 may be performed at a backend server.

With reference to FIG. 19, the process 1900 starts by receiving, at block 1910, a request to view the events generated by one or more A/V recording and communication devices. After receiving the request, at block 1920, the process 1900 gathers a plurality of events that are generated by the requested set of A/V recording and communication devices, where each event is ranked based on a set of defined rules 1314. After the ranked events are received, at block 1930, the process 1900 arranges the received events in a list based on the rankings that are assigned to the events. For example, the generated list may include the highest ranked event as its first item and the lowest ranked event as its last item. When two different events are ranked the same, some aspects of the present embodiments may position the more recent event higher on the list than the older event. Next, at block 1940, the process 1900 presents the generated list to the user (e.g., to the person who sent the request to view the list at block 1910). The process 1900 then ends. In some of the present embodiments, the list may be displayed on a display screen of a client device of the user (e.g., on a display of a mobile phone, on a monitor of desktop computer, etc.).

As described above, a user may explicitly define one or more rules 1314 for the events. For example, the user may tag a person that has appeared in a video as a person of interest. In some embodiments, the user may even specify the level of interest in the person (e.g., low importance, highly interested, etc.). Some other rules 1314 may assign a level of importance to an event dynamically and without any input from the user. For example, a rule 1314 may specify that if a person appears in more than a threshold number of videos (e.g., more than two videos, more than three videos, etc.) within a specific period of time, the person may be ranked higher (e.g., because the person could be a burglar who is loitering around the house), or, conversely, the user may have no interest in the person (e.g., because the person is a family member who enters and exits the house several times a day).

In general, the set of rules 1314 may include a rule 1314 that relates to the content of video footage, a rule 1314 that relates to the characteristic of video footage, a rule 1314 that relates to the A/V recording and communication device (e.g., a location of the device), a rule 1314 that relates to a user (e.g., a location of the user) associated with the A/V recording and communication device, etc. An example of a rule 1314 that relates to the content of a video, as discussed above, could be a rule 1314 that is triggered when the video footage shows a person/object, or a specific person/or object. Examples of the characteristic of a video may include the time at which the video footage is recorded (e.g., the time that the event associated with the video footage is triggered), a measured distance between the A/V recording and communication device and the person/object shown in the video footage, whether or not the event captured in the video footage is atypical, etc. An event captured in video footage may be atypical if the event does not conform to routine behavior observed by the camera that captured the video footage. For example, if the occupant of the house associated with the camera routinely arrives home between 6:30 PM and 7:30 PM on Tuesdays, then an arrival time of 10:00 PM on a Tuesday for the occupant could be considered to be atypical, and video footage of the atypical arrival event may therefore be processed according to the rule 1314 that relates to atypical events.

In some of the present embodiments, some rules 1314 may include a combination of criteria to limit the number of events in the list of events presented to a user to events that might be of greater interest to the user, and/or events that provide more helpful information to the user. For example, a rule 1314 of some embodiments may take into account a combination of the user's distance from home and the period of time that the user has been away from home. In particular, such a rule 1314 may first consider the location of the user and, if the user is determined to be away from home, the time at which the user left home. Based on these criteria, the rule 1314 may specify that only events that have occurred after the user left the house should be included in a summary list of events presented to the user (e.g., when the user opens an application associated with the A/V recording and communication device(s), when the user sends a request, etc.).

In some of the present embodiments, events that are included in an ordered list are not limited to the events that are generated by one or more A/V recording and communication devices of the user. That is, in some embodiments, a rule 1314 may assign a higher priority to events that are associated with other A/V recording and communication devices (e.g., an event that is recorded by an A/V recording and communication device of a neighbor and reported by the neighbor as a suspicious event, an event that is reported by a public agency, such as a law enforcement agency as an important event, etc.). As such, some of the present embodiments may present an ordered list of events to a user that includes (i) one or more high priority events generated by the A/V recording and communication devices associated with the user, (ii) one or more high priority events generated by other A/V recording and communication devices associated with other users, and (iii) one or more high priority events generated and/or reported by other entities with which the client device communicates.

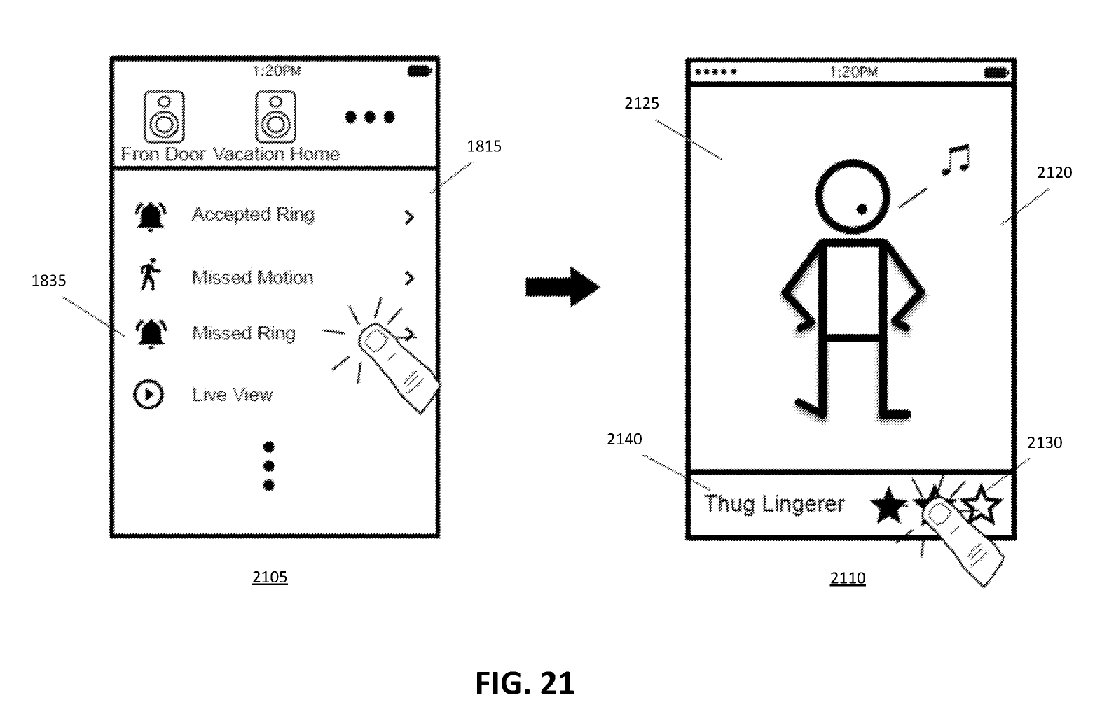

FIG. 20 illustrates an example of a dynamic rule 1314 for learning, over time, which events generated by one or more A/V recording and communication devices may have more value to a user, according to various aspects of the present embodiments. As discussed above, some rules 1314 may assign a level of importance to a person or object dynamically and based on a set of criteria. The set of criteria may contain predefined criteria and/or user-defined criteria. For instance, a criterion in the set of criteria may be the number of appearances of a person in different video footage associated with different events (e.g., within a specified period of time). Another criterion in the set of criteria may be the number of times a user views a video of an event that contains a particular person or object. Another criterion in the set of criteria may be the action that the user performs while viewing an event (e.g., pushing a talk button on the client device to talk to the visitor during a communication session, pushing a speaker button to hear the audio received by a microphone of the A/V recording and communication device, etc.).

With reference to FIG. 20, the two different stages 2005 and 2010 illustrate an example of how the priority of a set of events may be dynamically modified based on a user's behavior. FIG. 20 illustrates a GUI 1815 of an application executing on a client device. The GUI 1815 includes two A/V recording and communication devices 2005 and 2010 and a set of events 1820-1835 that are generated by these two devices 2005 and 2010. However, unlike the GUI 1815 of FIG. 18, the events 1820-1835 in the GUI 1815 of FIG. 20 are sorted based on a set of user-defined and/or system-defined rules 1314, and not just based on the time each event occurred. Therefore, as shown in the first stage 2005, the missed motion event 1830 appears before the accepted ring event 1820 in the list. This order of events may result because the person identified in video footage associated with the missed motion event 1830 may have a higher value (e.g., to the user) compared to a person identified in video footage associated with the accepted ring event 1820. Similarly, the missed ring event 1835 appears before the live view event 1825 in the list, because the person identified in video footage associated with the missed ring event 1835 may have a higher value than a person identified in video footage associated with the live view event 1825.

The first stage 2005 also shows the user (using his or her finger) selecting the accepted ring event 1820, e.g., to watch the video footage associated with this event. As described above, in some of the present embodiments a criterion may be the number of times a user watches a video associated with an event. In the illustrated example, since the user has watched the accepted ring event 1820 once before (e.g., “accepted ring” indicates that the video footage has been viewed at least once in the past), a second view of the video footage may trigger the rule 1314 to assign a higher ranking to the person associated with this event (e.g., since the user wants to watch the person appearing in the video footage associated with the event multiple times).

After the user has viewed the event for a second time, the second stage 2010 shows that the positions of the accepted ring event 1820 and the missing motion event 1830 are changed in the list (e.g., the two events have swapped their places in the list). In the illustrated embodiment, the threshold for number of views (e.g., for assigning a higher ranking to an event) is two. Therefore, as shown in stage 2010, and as a result of the second viewing of the event by the user, the accepted ring event 1820 is now at the top of the list of events, while the missing motion event 1830 is positioned in the second place and after the accepted ring event 1820. By contrast, if the threshold for the criterion was defined to be viewing more than two times, the places of the events 1820 and 1830 would have not have been swapped after the second selection of the event 1820.

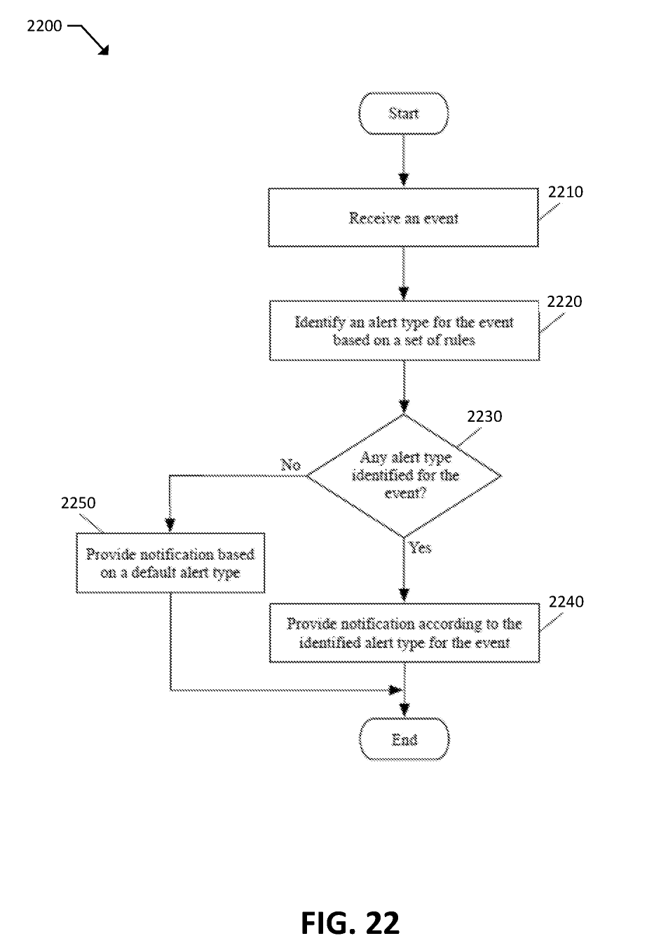

FIG. 21 illustrates an example of a user-defined rule 1314 (e.g., an explicit rule) for ranking an event generated by an A/V recording and communication device, according to various aspects of the present embodiments. The figure shows, in two different stages 2105 and 2110, a user ranking an event based on a person appearing in video footage associated with the event. Although in the illustrated example the user selects the event first (using his or her finger), as shown in the first stage 2105, and then an image 2120 of the person is shown to the user to rank, as shown in the second stage 2110, in some aspects of the present embodiments, after a person (or object) appearing in a video triggers a rule 1314 (e.g., the person acts suspiciously, the person appears in multiple video clips, the user watches video footage in which the person appears multiple times, etc.), an image of the person (or object) is automatically shown to the user to tag the person (or object) to be associated with a higher (or lower) ranking.

The first stage 2105 of FIG. 21 illustrates the same GUI 1815 shown in the second stage 2110 described above with reference to FIG. 20. However, in this stage 2105 the user selects (using his or her finger) the missed ring event 1835 to view the content associated with this event 1835 and to rank the event 1835 based on its content. As shown in the second stage 2110, an image 2120 of a person that one of the A/V recording and communication devices 1805, 1810 has detected is displayed on a display screen 2125 of the client device 1108/1110. At the bottom of the image 2120, in the area 2140, an identified name of the person may be displayed. Additionally, the GUI 1815 may include a rating area 2130 in which the user can specify the level of importance of the object appearing in the image 2120, e.g., by selecting and unselecting each of the three stars provided to the user in the rating area 2130.

While selection of an event and ranking the event based on its content is shown in two different stages in the above example embodiments, in some other embodiments the process may include more than two stages for ranking an event. For example, after selecting the event at stage 2105, another option may be provided to the user for ranking the event based on the person(s) and or object(s) that appear in the video footage associated with the event. After selection of such an option, a set of images of the persons or objects (e.g., identified through face recognition or other computer vision processes as described above) appearing in the video footage may be displayed to the user for selection. Upon selection of any of the displayed persons or objects by the user, some of the present embodiments may provide the selected image to the user for ranking the event that is associated with the image (e.g., as shown in the second stage 2110 of the FIG. 21). Some other embodiments may dynamically show a person or object to the user to tag based on one or more criteria as described above. For instance, when a person appears to be suspicious (e.g., when the person approaches a property in a video of an event that is triggered in the middle of the night), some embodiments automatically present the suspicious person to the user to tag.

While in the above-described embodiments the ranked events are presented to a user as a summary list of events, some other embodiments may present the ranked/prioritized events (e.g., to user) in another format. For example, some aspects of the present embodiments may generate a list of recent ranked events and may email the generated list to the user (e.g., a client device of the user) upon the user's request. Some other embodiments may generate and email such a list to the user based on the occurrence of a certain event (e.g., periodically, after a specific number of events occur, etc.) and without receiving any request from the user. In yet some other embodiments, the ranked events may be emailed to a user both upon receiving the user's request and upon the occurrence of a specific event.

As described above, conventional methods of providing event notifications (e.g., alerts sent to a client device of a user) provide the same type of notification every time a triggering event occurs (e.g., when an event is captured by an A/V recording and communication device). That is, conventional methods do not consider that some events may be more urgent, and/or may be of greater interest to the user, than others. Consequently, notifications for events that are urgent or that may be of great interest to the user may be overlooked by the user, because he or she does not appreciate that the event that triggered the notification is anything other than a routine event. Some of the present embodiments solve this problem by generating an alert type for each event based on a set of rules 1314, where events that are more urgent and/or more likely to be of interest or to be considered important by the user are assigned an alert type that is designed to be more likely to be noticed by the user. The user is thus more likely to receive urgent or important notifications in a timely manner. The set of rules 1314 may be defined by the user and/or by the system. Certain of the present embodiments may learn dynamically which events, such as which types or classes of events, are typically of greatest interest or importance to the user, and adjust the assignment of an alert type to each event based on such a learning process.

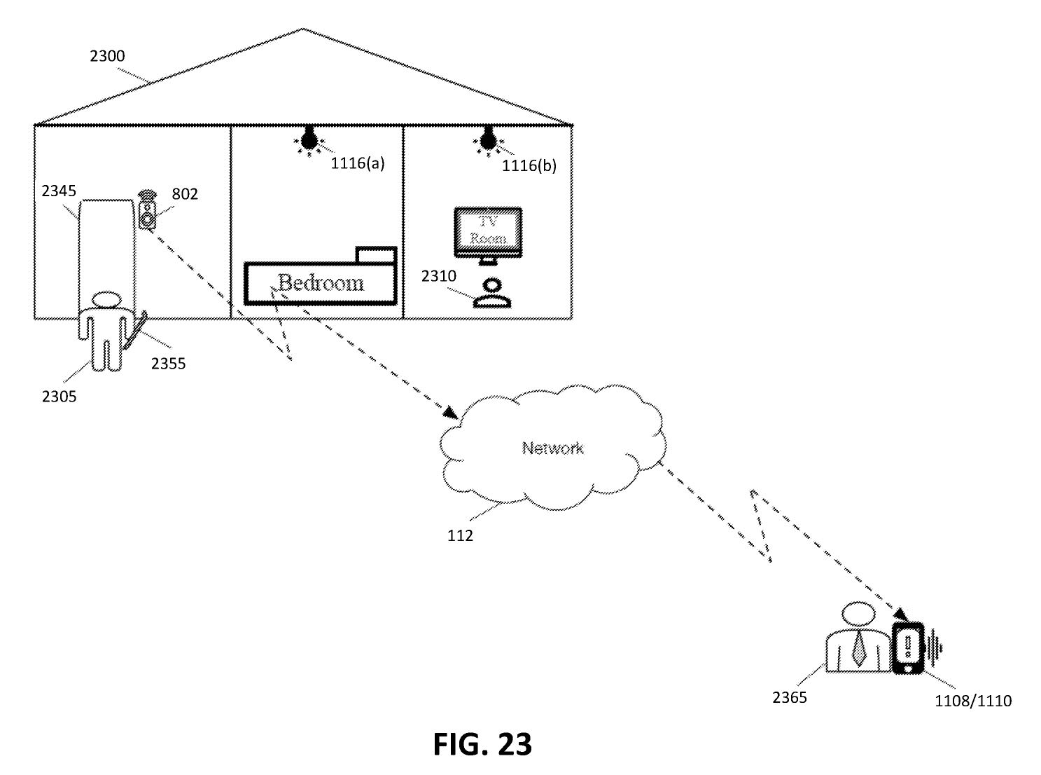

FIG. 22 is a flowchart illustrating a process 2200 for providing notifications to a user for the events generated by one or more A/V recording and communication devices, according to various aspects of the present embodiments. The process of FIG. 22 may be performed by an A/V recording and communication device in some embodiments, or in some other embodiments this process may be performed by one or more backend devices (e.g., backend APIs, backend servers, etc.). In yet some other embodiments, the process may be performed by a combination of an A/V recording and communication device and one or more backend device(s).

The process 2200 initiates by receiving, at block 2210, an event. The process 2200 may receive the event from an A/V recording and communication device that generated the event. Next, at block 2220, the process 2200 identifies an alert type, from among a plurality of alert types, to assign to the received event. For instance, each time an event is generated, the process of FIG. 22 may identify the person(s) or object(s) appearing in video footage associated with the event, and may determine an alert type for the event based on a set of rules 1314.

At block 2230, the process 2200 identifies an alert type from a plurality of alert types to assign to the received event based on a set of rules 1314. The set of rules 1314 may include any of the rules 1314 and/or criteria that are described above, or that are described elsewhere herein. For example, the set of rules 1314 may include a rule 1314 that relates to the content of the video footage (e.g., a specific person in the video, etc.), a rule 1314 that relates to a characteristic of the video footage (e.g., the time at which the video is captured, etc.), a rule 1314 that relates to the A/V recording and communication device that recorded the video footage (e.g., location of the device, etc.), a rule 1314 that relates to a user associated with the A/V recording and communication device (e.g., a location of the user), etc.

Some examples of notification/alert types assigned to different events and delivered by the process, in some of the present embodiments, may include, but are not limited to, a push notification delivered to a client device with a custom urgent delivery alert sound, a push notification delivered to a client device repeatedly until acknowledged by the user, directly opening a live video feed associated with the event on a client device without receiving an input from the user to open the notification for the event, flashing a light on a client device of the user (e.g., if the client device is in a low ambient light environment), flashing a display screen of a client device of the user, etc.

If the process determines that no particular ranking type can be assigned to the event, the process 2200 provides, at block 2250, a notification to a user (e.g., to a client device of the user) that is associated with a default alert type defined for the system. For example, a default alert type could be a first type of push notification to the client device when the A/V recording and communication device detects motion, and a second, different type of push notification when a doorbell button of the A/V recording and communication device is pressed. As such, the notifications sent based on a default alert type are different based on how the events are generated and not based on the content of the events, the location of the user, etc. After providing a notification associated with the default notification type, the process ends.

When the process 2200 determines, at block 2230, that an alert type is assigned to the received event, the process 2200 provides, at block 2240, a particular type of notification (e.g., to a client device, to a residence, etc.) that corresponds to the assigned alert type, and then ends. That is, the process may deliver one or more customizable notification types based on the ranking (e.g., based on the urgency or importance) of the event that has triggered the notification. Based on the perceived urgency or priority of the event, the system may select a method of notification delivery that increases the likelihood of the user seeing and responding to the notification. For example, when an event is assigned a high level of urgency (e.g., the event is ranked very high), the process may send a notification to the client device that may cause the client device to generate a visual and audible alarm.

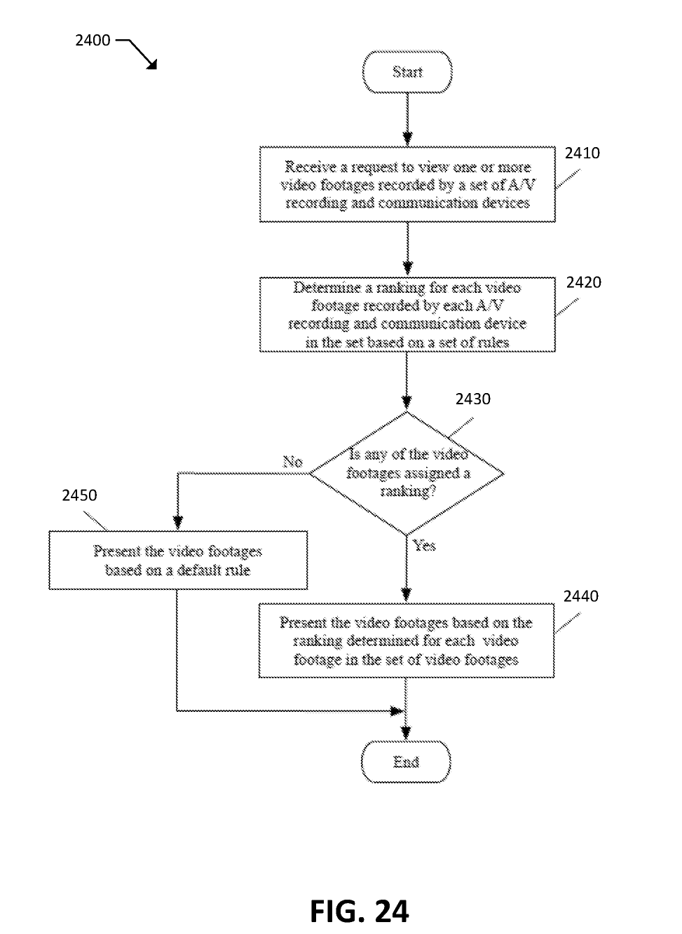

In some of the present embodiments, the process may also evaluate different circumstances on the side of the user to determine the most effective way to deliver the notification(s). For example, when an event is ranked as highly important, in addition to the above described notifications, the process of some of the present embodiments may identify the whereabouts of the user and may send visual and audible notifications to a property at which the user is located. For example, and as described below with reference to FIG. 23, the process may turn on a set of lights installed at the property at which the user is located, and/or provide audible notifications using one or more speakers installed at the property. Some aspects of the present embodiments may send audible and visual notifications to one or more properties that are associated with the user irrespective of the location of the user (e.g., to a property at which the A/V recording and communication device is installed, to every property that the user owns, etc.).

Other examples of notifying a user based on the location of the user may include ringing a wired or mobile phone inside a property at which the user is located (e.g., with a pre-recorded message), or notifying the user through other means within the property, such as a smart TV, a desktop computer, etc. Some of the present embodiments may use the aforementioned location-based notification only if the user does not respond to the original notification sent to a client device of the user. One aspect of the present embodiments may use the client device (e.g., a smartphone's hardware) to detect whether the user has seen a notification initially sent to the user and to escalate the delivery method if the user has not seen the notification. Some aspects of the present embodiments may provide a notification to the user while the user is driving, e.g., using a vehicle's interactive communication system.

FIG. 23 is a schematic diagram of a structure, illustrating an example of notifying persons present at a property, as well as an authorized person associated with the property, about a high ranked event, such as suspicious activity at, or near, the property, according to some aspects of the present embodiments. With reference to FIG. 23, the present embodiments comprise an A/V recording and communication device 802 (e.g., a video doorbell, a security camera, etc.) detecting a person 2305 (may also be referred to as “visitor”) standing near an outside door 2345 of a structure, such as a house 2300 with a crowbar 2355 in his hand, and providing an alert to a person 2310 (may also be referred to as “resident”) watching TV inside the house 2300, wherein the alert also provides the person 2310 with information about the severity of a threat the visitor 2305 might pose to the person 2310. The A/V recording and communication device 802 may also provide an alert to an authorized user 2365, holding a client device 1108/1110, through the network 112 as described below.

As shown, the house 2300 is equipped with a set of smart LED light bulbs 1116(a) and 1116(b) (e.g., one light bulb in each room) that are capable of emitting light in different colors. While FIG. 23 shows a house 2300, the present embodiments are not limited to houses. Rather, the present embodiments are applicable to any type of property and/or structure, including without limitation houses, apartments, offices, businesses, storage facilities, etc.

With reference to FIG. 23, when the A/V recording and communication device 802 detects the visitor 2305's presence, the device 802 captures video images of persons and/or objects that are within a field of view of a camera of the A/V recording and communication device 802. The A/V recording and communication device 802 may also capture audio through the device's microphone. As described above, the A/V recording and communication device 802 may detect the visitor 2305's presence by detecting motion using its camera and/or one or more motion sensors. The A/V recording and communication device 802 may also detect the visitor 2305's presence when the visitor 2305 presses a front button of the A/V recording and communication device 802 (e.g., when the A/V recording and communication device 802 is a video doorbell).

As soon as the visitor's presence is detected (through any of the above-mentioned methods), the A/V recording and communication device 802 may send a notification (along with streaming video and, in some embodiments, audio) to a client device as described below. Various aspects of the present embodiments may also notify any persons inside the property of a threat level associated with the detected visitor 2305. For example, some aspects of the present embodiments instead of, or in conjunction with, a notification sent to one or more client devices, may provide a different type of alert that is indicative of a highly important event associated with the visitor.

For instance, when the visitor is determined to be a criminal, instead of, or in conjunction with, a regular notification (e.g., a message along with streaming A/V sent to the client device), a second, different type of alert (e.g., a loud noise, display screen flashing, or any other type of warning notification), as described below, may be sent to the client device in some of the present embodiments. Additionally, in some of the present embodiments a visual and/or audible notification about the level of the importance associated with the event may be sent to any persons present at the property (e.g., by activating one or more smart LED lights such as the LED lights 1116(a ) and 1116(b), by verbally warning the residents using one or more speakers installed inside the property, etc.). When the event is assigned a neutral ranking (e.g., the identified person associated with the event is a family member), some of the present embodiments may provide a notification that corresponds to such a ranking (e.g., the LED lights 1116(a), 1116(b) turn green). When the visitor cannot be identified, some aspects of the present embodiments do not assign a ranking to the event associated with the unidentified person and provide a corresponding notification (e.g., the LED lights 1116(a), 1116(b) turn yellow).

The smart LED lights 1116(a), 1116(b) are merely one example of a notification device (e.g., the in-home alert device 143 shown in FIG. 1) that can be used in connection with the present embodiments to provide a notification or warning to any persons inside the structure 2300. Other examples of the in-home alert device 143 include discrete devices that may be located anywhere throughout the structure 2300, such as devices that may be placed on tabletops or shelves, and which may include different modes of providing notifications, such as display screens, multi-colored lights, speakers for audio notifications, etc. Any of these notification devices, including the smart LED lights 1116(a), 1116(b), may be configured to communicate with other devices through wired and/or wireless connections through the user's network 110 (FIG. 1) and/or the network 112, and/or through direct communication with other devices using one or more short-range communication protocols, such as Bluetooth or Bluetooth low energy (LE).

Although in the illustrated example both of the LED lights 1116(a) and 1116(b) are activated, in some aspects of the present embodiments not every LED light inside the house may be activated when a notification of threat level is provided to the persons inside the structure 2300. For example, in some embodiments, only the light(s) of the room (or rooms) that is/are occupied may be activated. Some of the present embodiments may determine which rooms are occupied by employing a set of motion sensors installed in the house, through detection of the client devices carried by the occupants, through other A/V recording and communication devices installed inside the house 2300, etc. In the illustrated example, the LED light 1116(b) in the TV room is activated because a person 2310 is present there, while the LED light 1116(a) in the bedroom remains inactive because no person is present there.

The A/V recording and communication device 802 of some of the present embodiments may recognize suspicious activity engaged in by a visitor and notify the owners and/or occupants of the property of a high ranked event associated with the visitor, even in cases where the visitor cannot be identified (e.g., using face recognition processes). That is, in some aspects of the present embodiments when a person at, or near, a property engages in suspicious activity, the A/V recording and communication device may generate an event and assign a high ranking to the event and send a signal to the in-home alert devices (and/or to other client devices) even if the visitor was not recognizable (e.g., the visitor's identity could not be matched against any of the databases), or even when the event could have been ranked low because the visitor associated with the event is found in one of the lower ranked databases (e.g., visitor is known by the owner of the property).

One example of suspicious activity that could cause the A/V recording and communication device to rank the associated event as highly important is loitering. Loitering is often a prelude to a number of property and personal crimes, such as burglary, vandalism, breaking-and-entering, home invasion robbery, etc. Loitering may be identified using the several of the present embodiments in a variety of ways. For example, in some embodiments, the A/V recording and communication device 802 is configured to record and save image data of all persons who enter the field of view of the camera 104 to create saved visitor images. These saved visitor images may then be automatically compared to the images of subsequent visitors within a certain period of time. Then, using the saved visitor images and the image data from a new visitor, if it is determined that the visitor has entered the field of view of the camera more than once within a predetermined period of time (may be referred to as a “suspicious loitering time warning value”), the process may set a suspicious person warning flag and/or generate and send alerts through the in-home alert devices and/or other client devices.

Some embodiments may identify loitering as a result of a prolonged presence of the same person in the field of view of the camera 104 of the A/V recording and communication device 802. In other embodiments, the process may include determining whether the doorbell of the A/V recording and communication device 802 has been activated. Then, if the doorbell has not been activated, and the suspicious loitering time warning value has been exceeded, the process may set a warning flag. In another embodiment for identifying suspicious behavior, including loitering, the process may employ two distinct A/V recording and communication devices. This method can advantageously identify suspicious behavior, for example, in the form of a person first approaching the front door of a property and then the back door of the same property.

Another form of suspicious behavior that can be identified by some of the present embodiments is carrying a suspicious object, such as a weapon or a burglary tool (e.g., a crowbar). The present embodiments also contemplate numerous methodologies for determining whether an object carried by a person who is present within the camera's field of view is a suspicious item, such as a weapon or burglary tool 2355 (shown in FIG. 23). Any or all of these methodologies may include one or more aspects of computer vision. For example, in some embodiments, received image data of an object carried by a person within the camera's field of view may be determined to be a suspicious item by using object recognition software to compare images received from the A/V recording and communication device 802 to a database of images of weapons and/or burglary tools and/or other types of suspicious objects. Upon determining that a person is carrying a suspicious object or a weapon, a suspicious person warning flag may be set by some of the present embodiments.

Another form of suspicious behavior is intentionally obscuring, or partially obscuring, a visitor's face, so that it cannot be seen or recognized by the A/V recording and communication device 802. In embodiments of the present methods, the facial recognition software and the object recognition software can be used to interact with one another, or to act alone, in order to determine, based on received image data of a person within the field of view of a camera of the A/V recording and communication device 802, that the person has used an object to obscure or partially obscure his or her face. When the process determines that a person is in the field of view of the camera, but that the person's face is obscured, or is obscured for some predetermined period of time, or that the person's face is obscured at the time that the person activates the doorbell, a suspicious person warning flag may be set by some embodiments.

Many more examples of suspicious activities, as well as methods of dynamic recognition of suspicious persons and/or activities by an A/V recording and communication device, are provided in U.S. Provisional Patent Application Ser. No. 62/464,342, filed on Feb. 27, 2017, entitled “IDENTIFICATION OF SUSPICIOUS PERSONS USING AUDIO/VIDEO RECORDING AND COMMUNICATION DEVICES,” which is incorporated herein by reference in its entirety as if fully set forth.

As shown in FIG. 23, the person 2305 is holding a crowbar 2355. As described above, since a crowbar 2355 can be determined to be a suspicious object, some of the present embodiments may send a high level alert to both the in-home alert devices 1116(a), 1116(b) (to notify persons inside the house) and/or to any client device(s) associated with the A/V recording and communication device 802 (whether inside the property or away from the property).

As described above, a received image of an object carried by a person within the camera's field of view may be determined to be a suspicious item by using object recognition software to compare the received image from the A/V recording and communication device 802 to one or more database(s) of images of weapons and/or other types of suspicious objects, such as burglary tools. Upon determining that the person 2305 is carrying a suspicious object (such as the depicted crowbar 2355) some of the present embodiments may rank the associated event as highly important and send an alert without attempting to determine (e.g., using other remote servers and/or databases) the identity of the person 2305 who is carrying the suspicious object. In yet other aspects of the present embodiments the A/V recording and communication device 802 may send a query signal to one or more backend devices to attempt to identify the person and the threat level associated with the person carrying the suspicious object, irrespective of recognition of the suspicious object carried by the person.

As shown in FIG. 23, a serious threat level notification may be sent to both of the persons within the structure through the LED lights 1116(a) and 1116(b) inside the property by emitting a red light (or another color associated with danger) and the client device 1108/1110, while the user 2365 is away from the house 2300 (e.g., at work). The threat level notification may be sent to the client device 1108/1110 through the network 112 (e.g., a combination of the user network 110 and the network 112 described above with reference to FIG. 1). When the client device 1108/1110 receives a severe threat alert, depending on the configuration of the device 1108/1110, the device 1108/1110 may provide one or more audible and/or visual notifications to the user 2365. For example, a loud noise and/or a warning statement might be broadcast from the speaker(s) of the device 1108/1110 in some embodiments. In some other embodiments, a display screen of the device 1108/1110 may flash and/or one or more warning messages or popups may appear (e.g., in red or other colors) on the display screen of the device 1108/1110. In yet other embodiments, a combination of verbal and visual notifications may be provided to the user 2365.

The present embodiments are not limited to notifying any particular person or class of persons. The person notified about the visitor may be, for example, the owner of the property, a resident of the property, an occupant of the property, any person present at the property when the visitor is also present, any authorized user of the A/V recording and communication device (even if the authorized user is not present at the property when the visitor is also present), or any other person. Examples of the present embodiments may be described herein with respect to a particular person or class of persons, but any such examples should not be construed as limiting the present embodiments to notifying any particular person(s) or class of persons to the exclusion of notifying any other person(s) or class of persons.

As described above, conventional methods of presenting video streams from multiple cameras (e.g., cameras of different A/V recording and communication devices) do not consider that some video streams may be more urgent, and/or may be of greater interest to the user, than others. Furthermore, when multiple video streams are transmitted and/or presented simultaneously, bandwidth limitations may degrade the quality of one or more of the video streams, or may prevent any of the streams from being presented at all. The present embodiments solve these problems by prioritizing the video streams based on a set of rules 1314, and then transmitting and/or presenting the video streams according to their relative priorities. The set of rules 1314 may assign higher priority to video streams that are more urgent and/or more likely to be of interest or to be considered important by the user, and assign lower priority to video streams that are less urgent and/or less likely to be of interest or to be considered important by the user. The set of rules 1314 may be defined by the user and/or by the system. Certain of the present embodiments may learn dynamically which video streams, such as video streams containing certain types or classes of events or people, are typically of greatest interest or importance to the user, and prioritize the video streams based on such a learning process.

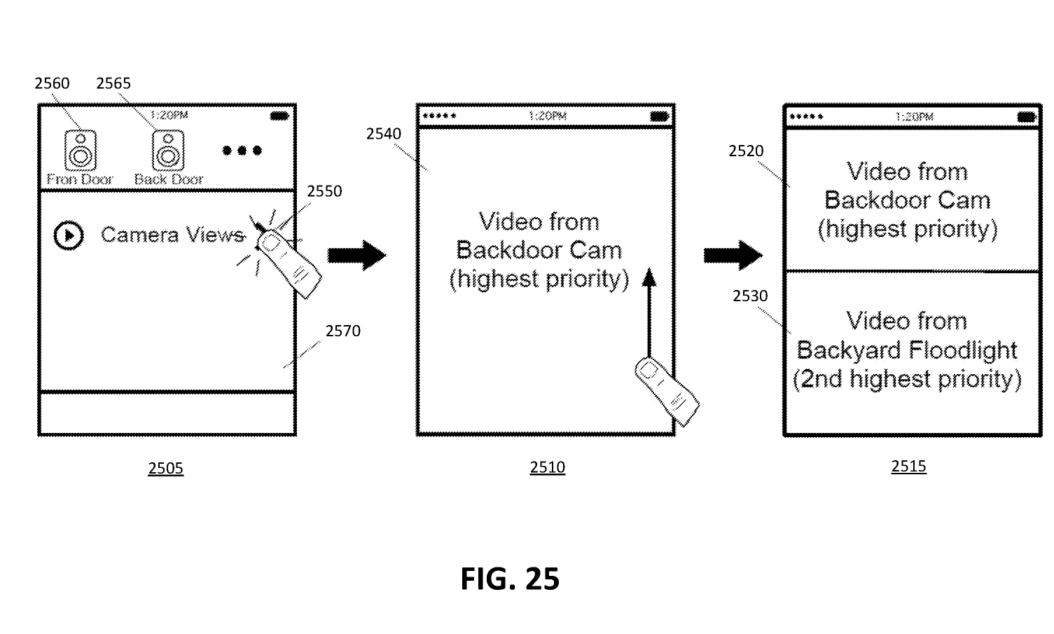

FIG. 24 is a flowchart illustrating a process 2400 for transmitting to a client device one or more video streams from among a plurality of video streams from one or more A/V recording and communication devices, based on a ranking assigned to each video stream, according to various aspect of the present embodiments. The process 2400 of FIG. 24 may be performed by one or more backend servers in some of the present embodiments, while in other embodiments this process may be performed by one or more A/V recording and communication devices. In yet some other embodiments, some parts of the process may be performed by one or more backend servers, while other parts of the process are performed by the A/V recording and communication devices.

The process 2400 initiates, at block 2410, by receiving a request from a user to view to view one or more video streams recorded by a set of A/V recording and communication devices. That is, the user may send a request (e.g., through a client device of the user) to view the video footage captured by a set of A/V recording and communication devices of the user (e.g., a set of video doorbells and/or security cameras that are installed at one or more properties associated with the user). The one or more videos that are requested to be transmitted to the client device of the user may comprise, in some of the present embodiments, live video streams (e.g., videos that are currently being recorded by the A/V recording and communication devices), or prerecorded video footage (e.g., videos that were previously recorded by the A/V recording and communication devices). For example, the user may have several different video doorbells, security cameras, floodlight cameras, etc., installed at one or more properties of the user. Some of the present embodiments may provide the user with an option (e.g., in an application that executes on a client device of the user and that is associated with the A/V recording and communication devices) to have a live view from a field of view of the video cameras of the A/V recording and communication devices.

Instead of selecting each of the A/V recording and communication devices to view its corresponding video, the user might want to have a live view of one or more A/V recording and communication devices that are recording videos in which the user might have a greater interest. As such, some of the present embodiments may provide an option for viewing the higher ranked videos from among a plurality of videos before viewing the lower ranked videos. As described above, the plurality of videos may include video streams that are currently being recorded by the A/V recording and communication devices, as well as the video footage that was previously recorded by the A/V recording and communication devices.

At block 2420, the process 2400 determines a ranking (or priority) for each one of the videos based on a set of rules 1314. For instance, the process may identify the persons and/or objects in the videos and rank the videos based on the identified persons and/or objects based on the set of rules 1314. As described above, the set of rules 1314 may include rules 1314 that are explicitly defined by the user and/or rules 1314 that dynamically learn, over time, how to rank the different videos. One example of the rules 1314 may include assigning a priority/ranking (e.g., high, medium, low, neutral, etc.) to some or all of the A/V recording and communication devices that are installed at one or more properties associated with a user. This way, when the user requests to view a prioritized feed (video), some of the present embodiments may transmit a video stream (e.g., to a client device) that is being recorded by an A/V recording and communication device that is assigned the highest priority/ranking.

As discussed above, some of the present embodiments may evaluate the ranking of a video using a combination of rules 1314. For example, if a rule 1314 in the set of rules 1314 has previously assigned a very high ranking to a previously recorded video (e.g., because of a suspicious activity identified in the video), even though the previously recorded video was recorded by a low ranked A/V recording and communication device, some of the present embodiments may present that video to the user (e.g., upon the user's request) instead of sending a video stream that is currently being recorded by a higher ranked A/V recording and communication device.

Some example rules 1314 that relate to the content of video footage may include rules 1314 that assign higher rankings to videos that contain motion, persons, and/or objects, specific persons and/or objects, etc. Conversely, some embodiments may assign a higher ranking to videos that exclude specific person(s) and/or objects, or may assign a lower ranking to such videos. An example rule 1314 that relates to the characteristic of video footage may include a rule 1314 that considers the bandwidth usage for transmission of the recorded and/or streaming videos to rank the videos. As an example, some of the present embodiments may assign a higher ranking to videos that require less transmitting bandwidth compared to the other videos. Some aspects of the present embodiments may assign a very low ranking to videos for which the transmitting rate exceeds a threshold limit. One aspect of the present embodiments may assign a higher ranking to a video when the bandwidth usage for transmitting the video does not exceed the capacity of the user's network and/or other networks. Some of the present embodiments may measure the bandwidth of the networks (e.g., the user's network, a public network, etc.) by performing a network speed test on the different A/V recording and communication devices.

Some other rules 1314, in some of the present embodiments, may include, but are not limited to, assigning priority to videos based on the time of day, a user's location, a state of the system (e.g., A/V recording and communication devices being armed/disarmed), etc. As an example, when a first set of A/V recording and communication devices that are installed outside a house are set to be armed while a second set of A/V recording and communication devices installed inside the house are set to be disarmed, and a rule 1314 assigns a higher ranking to armed A/V recording and communication devices, some of the present embodiments may show to a user (e.g., upon the user's request) video footage that is recorded by the outside A/V recording and communication devices before the video footage recorded by the inside devices. Some such embodiments may first show the highest ranked video stream that is captured by an A/V recording and communication device installed at the outside door of the house (e.g., when another rule 1314 is defined to assign a higher ranking based on the location of the A/V recording and communication devices).

In some of the present embodiments, even more complicated rules 1314 may be defined for prioritizing the videos that are being recorded or have been recorded by the A/V recording and communication devices. As an example, a rule 1314 may specify to prioritize an order of videos based on the direction of recent motions detected by neighboring A/V recording and communication devices. For example, if the direction of the motion is determined to be from a first security camera toward a second security camera of a plurality of security cameras and doorbells, the rule 1314 may rank the video stream of the second security camera as the highest ranked video and the video recorded by the first security camera as the second highest ranked video (or vice versa) among the plurality of videos recorded by the plurality of video doorbells and security cameras.

With further reference to FIG. 24, at block 2430 the process 2400 determines whether a ranking is assigned to any of the videos. If the process determines that no ranking is assigned to any of the videos, or all of the videos are ranked the same, the process 2400 presents, at block 2450, one of the videos to the user (e.g., to a client device of the user) based on a default rule 1314 defined for the system. For example, a default rule 1314 may specify that the A/V recording and communication device that is first in the set of A/V recording and communication devices transmits its video stream first. Other embodiments may use other default rules 1314, or use no default rule, to transmit a video to the client device(s). The process then ends.

However, when the process 2400 determines, at block 2430, that at least one video is associated with a ranking, the process 2400 provides, at block 2440, the highest ranked video to the user first. The process then ends. As discussed above, the video that is sent to the client device for viewing might be a higher ranked video that has been recorded recently, or it might be a higher ranked video that is being recorded currently. As such, some embodiments may transmit a recorded video (e.g., from an A/V recording and communication device, from a backend sever, etc.) to one or more client devices, or transmit a streaming video while the video is being recorded by an A/V recording and communication device. Additionally, the process of some embodiments may present multiple video streams to a user at the same time. For example, some of the present embodiments may divide a display of the client device into several portions and present a different video in each portion of the display in order and based on the rankings assigned to the videos. Some such embodiments may display the rank that is assigned to each video when the video is presented.

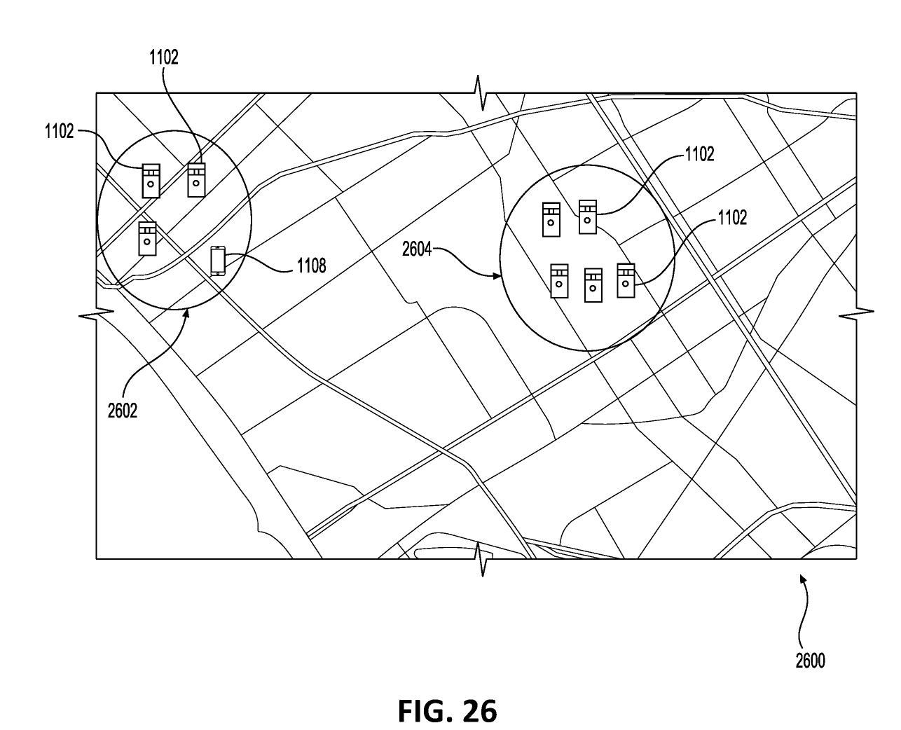

FIG. 25 illustrates an example of displaying, on a display of a client device, videos that are currently being recorded, or have been previously recorded, by one or more A/V recording and communication devices based on the rankings assigned to the videos, according to various aspects of the present embodiments. The figure shows, through three different stages 2505-2515, a user requesting (using his or her finger) to view the videos recorded by a set of A/V recording and communication devices, such as the “Front Door” device 2560, the “Back Door” device 2565, etc. In response to the user's request, the client device displays one or more videos based on the rankings that are assigned to the videos.

The first stage 2505 illustrates a GUI 2570 of an application associated with a plurality of A/V recording and communication devices. The GUI 2570 includes at least two A/V recording and communication devices 2560 and 2565 and an option 2550 for the user, which when selected allows the user to view one or more videos based on their rankings. The first stage 2505 also shows the user selecting the option 2550 (e.g., by tapping, using his or her finger, on or near an area on which the option 2550 is displayed) in order to view the videos.

The second stage 2510 shows that, upon receiving the user's request, the application displays the highest ranked video 2520 in a display area of the display screen of the device. As shown, the highest ranked video 2520 is currently being recorded by the “Back Door” device 2565. As described above, there can be several different reasons for the video 2520 to have the highest ranking. The video 2520 might be the highest ranked video simply because the “Back Door” device 2565 is ranked higher than the other A/V recording and communication devices, or it might be the highest ranked video because there is ongoing suspicious activity taking place at, or near, the “Back Door” device 2565. The second stage 2510 also shows that the user is scrolling the screen up (e.g., by pressing his/her finger against the display screen and dragging his/her finger upward) to view other videos ordered based on their priorities.

The third stage 2515 illustrates that, upon receiving the user's interaction with the screen (e.g., scrolling the screen up), the application scrolls a first display area, in which the video 2520 is displayed, up and displays a second display area in which the second highest ranked video 2530 is displayed. As shown, the second highest ranked video 2530 is currently being recorded by an A/V recording and communication device named “Backyard Floodlight” (not shown in the figure). As described above, the “Backyard Floodlight” device might be installed at the same property at which the “Front Door” and “Back Door” devices are installed (e.g., the home of the user), or the “Backyard Floodlight” device might be installed at a different property (e.g., a vacation home of the user).

It should be understood that the above-described example illustrated in FIG. 25 is one method of presenting the videos to a user and different embodiments may present the videos to the user in different manners. As an example, some embodiments may divide the display screen of a client device into multiple areas (2 areas, 4 areas, etc.) and display several videos, based on their rankings, on the divided areas. Some other embodiments may require the user to scroll to the left or right to view the next or previous videos. Some other embodiments may display only the highest ranked video, instead of several videos, each time the user requests to view a video.

As described herein, many of the present embodiments may comprise learning, over time, what persons, events (e.g., event types), and/or videos are likely to be of interest to the user. Any of these learning processes, as well as recognition algorithms developed as a result of such learning processes, may involve artificial intelligence (AI) and/or machine learning. AI is intelligence exhibited by machines, and may include instances when a machine mimics cognitive functions that humans associate with other human minds, such as learning and problem solving (also known as machine learning). Machine learning is the subfield of computer science that gives computers the ability to learn without being explicitly programmed. Evolved from the study of pattern recognition and computational learning theory in AI, machine learning explores the study and construction of algorithms that can learn from and make predictions on data—such algorithms overcome following strictly static program instructions by making data-driven predictions or decisions, through building a model from sample inputs. Machine learning is employed in a range of computing tasks where designing and programming explicit algorithms with good performance is difficult or unfeasible. Examples approaches of machine learning include, without limitation, decision tree learning, association rule 1314 learning, artificial neural networks, deep learning, inductive logic programming, support vector machines, clustering, Bayesian networks, reinforcement learning, representation learning, similarity and metric learning, sparse dictionary learning, genetic algorithms, rule-based machine learning, and learning classifier systems. Any of these approaches of machine learning, in addition to other approaches described herein, may be employed in the present embodiments.

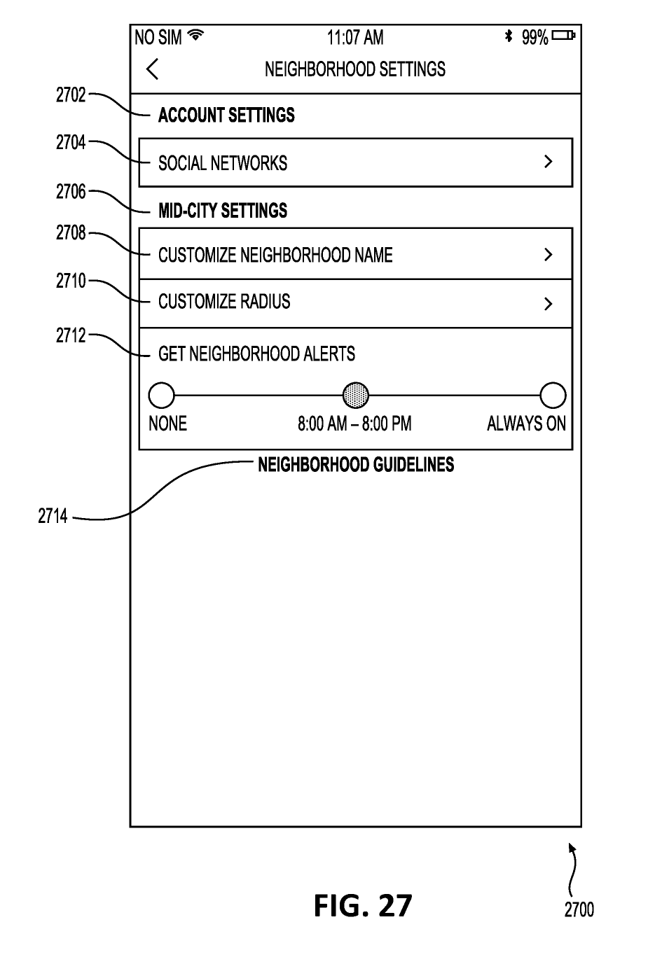

FIG. 26 is a screenshot of a map 2600 illustrating geographic area networks according to various aspects of the present disclosure. As described herein, the location of two or more A/V recording and communication devices 1102 within the same geographic area network (and/or other location based and/or geographic based criteria) may be used to determine an association between the two or more A/V recording and communication devices 1102. The description of FIG. 26 includes various examples of how geographic area networks may be defined and various examples of how a user may subscribe to a neighborhood (e.g., a geographic area network). The examples described herein are not intended to be limiting, and other examples may fall within the scope of the present disclosure.

In some of the present embodiments, each of the geographic area networks may include a subset of the users of the network of users corresponding to a geographical location. In some of the present embodiments, an individual geographic area network of the geographic area networks may include a grouping of A/V recording and communication devices that are located in a geographical location that may be defined using various methods. For example, the individual geographic area network may be a geographical location associated with a street, town, city, state, and/or country. In further examples, the individual geographic area network may be determined by the backend server 1122 based on grouping a particular number of A/V recording and communication devices about a particular vicinity. In a further example, a user may customize a geographic area network, as further described below. In some embodiments, various A/V recording and communication devices may be grouped into only one geographic area network or more than one geographic area network. In other embodiments, various A/V recording and communication devices may not be grouped into any geographic area network. Further, one or more third-party A/V recording and communication devices may also be grouped as part of an individual geographic area network. In other embodiments, one or more third-party A/V recording and communication devices may not be grouped into any geographic area network. In addition, users without A/V recording and communication devices may join a geographic area network using a client device, as further described below. Further, users joining a geographic area network may be verified before allowing full access to geographic area network features, as further described below.

With further reference to FIG. 26, the map 2600 illustrates a first geographic area network 2602 identified as Santa Monica, Calif. In many embodiments, the first geographic area network 2602 may include one or more A/V recording and communication devices, such as (but not limited to) the first A/V recording and communication devices 1102. Further, the map 2600 illustrates a second geographic area network 2604 identified as Mar Vista, Calif. In many embodiments, the second geographic area network 2604 may include one or more A/V recording and communication devices, such as (but not limited to) the second A/V recording and communication devices 1102. Although specific geographic area networks are discussed with respect to FIG. 26, the geographic area networks may comprise geographic area networks with any number of differing characteristics such as (but not limited to) specific location, size of the geographical location, groupings of A/V recording and communication devices, groupings of third-party devices, and/or relative locations of the geographic area networks to each other in accordance with various aspects of the present disclosure. In various embodiments, one or more of the geographic area networks may be coextensive with the boundaries of a community, municipality, town, village, city, county, etc. Similarly, one or more of the geographic area networks may not be coextensive with the boundaries of a community, municipality, town, village, city, county, etc., and/or may overlap with at least parts of multiple communities, municipalities, towns, villages, cities, counties, etc. Additionally, or alternatively, a geographic area network may be based at least in part on the associations between A/V recording and communication devices, such as, for example, devices associated with homes on the same street, homes having similar addresses, homes within sight distance of each other, and/or homes within earshot of each other.

In some embodiments, “neighborhoods” may be a name given to a geographic area that may be defined by any number of geographic coordinates. For example, a user may customize their particular “neighborhood” by defining a geographic area over a portion of a map (e.g., by drawing the region, by positioning markers to define a polygon, by defining a radius of a circle, with the center of the circle being the user's location (or the location of an A/V recording and communication device associated with the user), by positioning a square, a rectangle, a triangle, or any other shape over a geographic area on a portion of a map, etc.). As a result, the defined geographic area may be considered the user's “neighborhood” for purposes of some embodiments of the present disclosure. As such, the user may be able to view and/or access data generated by some or all of the A/V recording and communication devices and/or hub devices of security systems (e.g., generated by the A/V devices and/or hub devices of users who share the data) located within the user's “neighborhood.”

FIG. 27 is a screenshot of a graphical user interface (GUI) 2700 illustrating aspects of a process for accessing and updating neighborhood settings according to various aspects of the present disclosure. As described above, a user may download and run a client application on his or her client device to access shared video footage captured by a plurality of A/V recording and communication devices and/or to share sirens and/or floodlights and allow for activation of the same. In various embodiments, the client application may configure the client device to present one or more GUIs allowing for the user to interact with a neighborhood (and/or other geographic area), as described above. The GUI 2700, which may be presented to a second user on a screen of the second client device 1110, may allow the second user to access neighborhood settings using a menu link. In various embodiments, the GUI 2700 may include a My Devices tab and a Shared Devices tab. In some embodiments, the GUI 2700 may also include a Settings tab that includes a Neighborhoods tab that allows the second user to view and update settings related to neighborhood features. For example, by clicking on the Neighborhoods tab, the second user may be presented with GUI 2700 as illustrated in FIG. 27. The GUI 2700 may include an Account Settings category 2702 that includes a Social Networks tab 2704 and a Mid-City Settings category 2706. In various embodiments, the Mid-City may be any neighborhood that the second user has joined. For example, if the user has joined the Santa Monica neighborhood 2602 (FIG. 26), then the Mid-City Settings category 2706 may be replaced by a Santa Monica Settings category. In many embodiments, the GUI 2700 also may include a Customize Neighborhood Name tab 2708 that allows the second user to change the name of the neighborhood. The GUI 2700 may also include a Customize Size tab 2710 that allows the second user to customize the size of the neighborhood (e.g., the radius or other dimensions, such as length and width where the neighborhood boundary is not circular, or by dragging and dropping markers to define a polygon, and/or using any other process to define a geographic area as the neighborhood boundary), as further described below. In some embodiments, the GUI 2700 may also include a Neighborhood Guidelines link 2714 that may provide the user with various guidelines for using the neighborhood features, as described herein.

Additionally, or alternatively, the GUI 2700 may allow a user to authorize the use of one or more sirens and/or floodlights of A/V recording and communication devices associated with the client device. The user may provide blanket authorization such that any device associated with the neighborhood may utilize the sirens and/or floodlights. Alternatively, the user may provide authorization for certain devices and/or homes and/or user profiles and/or security event criteria (e.g., high threat level security events only). Alternatively, the user may provide authorization to send a user alert indicating a request to utilize sirens and/or floodlights, to which the user may then respond on a case-by-case basis.

FIG. 28 illustrates an example of the client device 1108 showing display of ranked events and/or event indicators according to various aspects of the present disclosure. For example, the display 1520 of the client device 1108 may display a user interface 2802. The user interface 2802 may be displayed based on a selection by a user of a user alert 1234 sent from an A/V recording and communication device 1102, a smart-home hub device 1112, and/or a backend server 1122. The user interface 2802 may display images corresponding to image data 1224 sent to the client device 1108, such as live or near-live streaming video of a field of view of an A/V recording and communication device 1102. Additionally, or alternatively, the user interface 2802 may display one or more indicators of videos and/or image data 1224. The indicators may be displayed in an order based on one or more rules 1314 configured to show a prioritization of the videos and/or image data 1224. The one or more rules 1314 may be identified, determined, and/or generated (using the processes described herein) by, for example, the smart-home hub device 1112, the backend server 1122, and/or the client device 2802. The one or more rules 1314 may be based on, for example, at least one of multiple factors. The factors may include the concepts described above with respect to FIGS. 16-25 and 31-34, for example. Additionally, or alternatively, the factors may include the concepts described above with respect to FIG. 13.

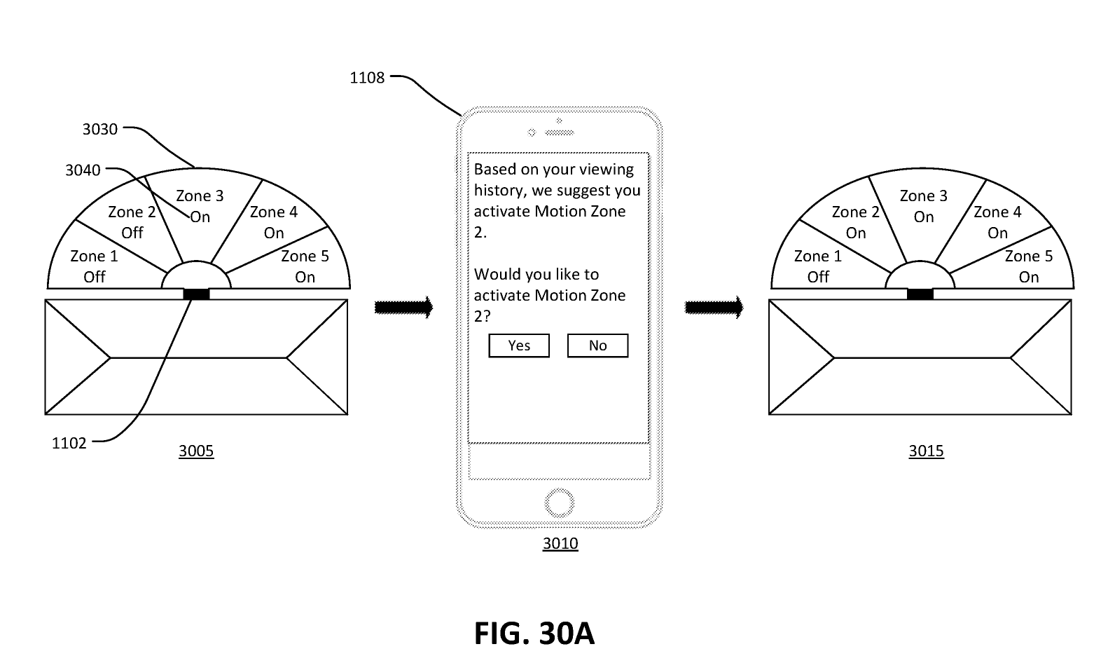

FIG. 29 illustrates an example of the client device 1108 showing display of a communication with suggested videos based on ranking data 1320 according to various aspects of the present disclosure. For example, the display 1520 of the client device 1108 may display a user interface 2902. The user interface 2902 may display communications received via the smart-home hub device 1112, the backend server 1122, and/or an A/V recording and communication device 1102.

The communication may include storage location indicators associated with image data 1224. In examples, the communication may be an email and may include a narrative 2904 indicating the purpose of the communication. As shown in FIG. 29, for example, the narrative 2904 states “You may find the following videos of interest given your previous use of the Application.” The communication may also include the storage location indicators 2906-2912. The storage location indicators 2906-2912 may be associated with videos that have been selected for inclusion in the communication. For example, one or more videos viewed on a user may be classified and/or one or more objects in viewed videos may be classified based on the one or more rules 1314 described herein. Additional videos with the same or a similar classification may be identified and may storage location indicators associated with at least a portion of the additional videos may be included in the communication. For example, the indicator 2906 corresponds to a video with the title “Coyote in My Yard!” The one or more rules 1314 may indicate that the user typically prioritizes videos with raccoons, and therefore the indicator 2906 may be included in the communication. By way of further example, the indicator 2908 corresponds to a video with the title “This Guy Looks Suspicious!” The one or more rules 1314 may indicate that the user typically prioritizes videos where the object depicted in the videos is labeled as a suspicious person. By way of further example, the indicator 2910 corresponds to a video with the title “New UPS Driver.” The one or more rules 1314 may indicate that the user typically prioritizes videos related to delivery of mail, and therefore the indicator 2910 may be included in the communication. By way of further example, the indicator 2912 corresponds to a video with the title “Look Out for Kids in the Road.” The one or more rules 1314 may indicate that the user typically prioritizes videos where the object depicted in the videos is labeled as a child, and therefore may the indicator 2912 may be included in the communication.

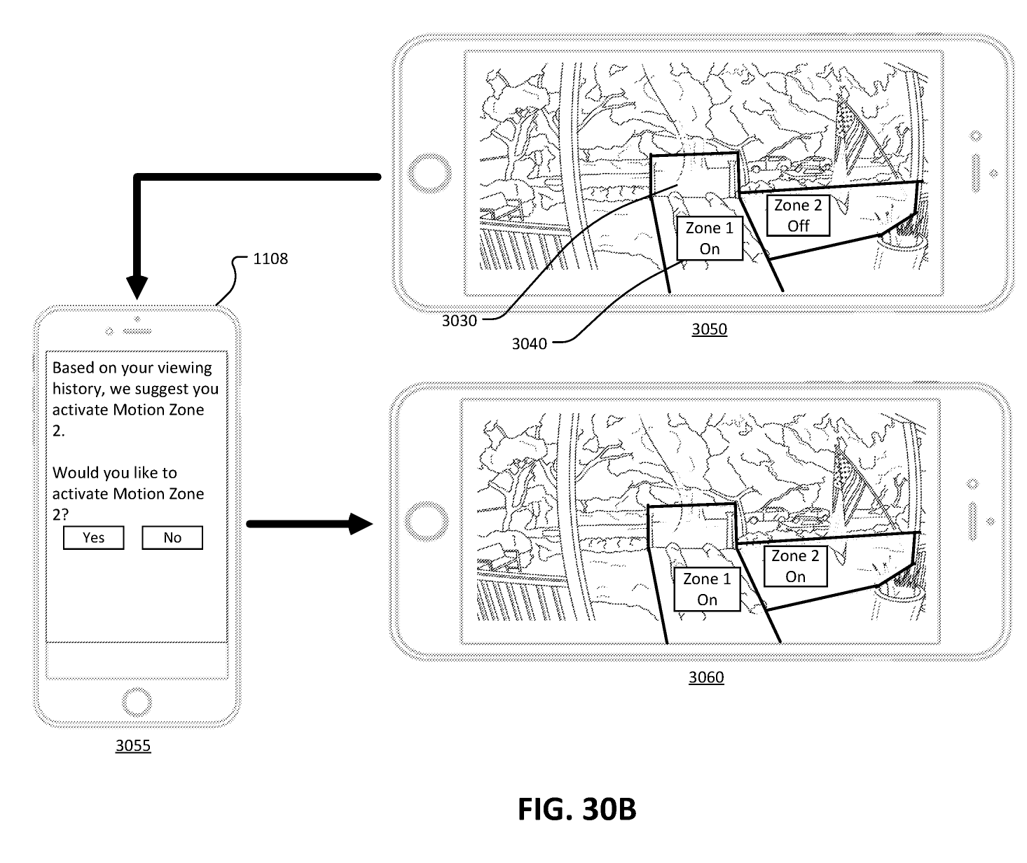

FIG. 30A illustrates an example of motion zone modification based on the ranking data 1320 according to various aspects of the present disclosure. FIG. 30A represents a progression, from left to right. At step 3005, FIG. 30A depicts an environment, such as a home, with the A/V recording and communication device 1102. For example, the A/V recording and communication device 1102 may be associated with a field of view 3030. The field of view 3030 may include one or more zones. As shown in FIG. 30A, the field of view 3030 includes 6 zones. A state indicator 3040 may be associated with one or more of the zones. The state indicator 3040 may provide an indication as to aspects of the state of a particular zone. For example, the state indicator 3040 may indicate whether the zone is activated (e.g., “on”) or deactivated (e.g., “off”). Additionally, or alternatively, the state indicator 3040 may indicate a motion sensitivity associated with a particular zone. As shown in FIG. 30A, zones 3, 4, and 5 have state indicators 3040 showing that those zones are activated, while zones 1 and 2 have state indicators 3040 showing that those zones are deactivated.

Based on image 1224 generated by the A/V recording and communication device 1102, the processor 1404 of the backend server 1122 (and/or the processor 1308 of the hub device 1112) may identify an object depicted in the image data 1224 and determine that the object is located at a location outside a predefined zone of the field of view of a camera of the A/V recording and communication device 1102. Using FIG. 30A as an example, the predefined zone may be a zone including zones 3, 4, and 5. The location of the object may be determined to be in, for example, zone 2. The processor 1404 of the backend server 1122 (and/or the processor 1308 of the hub device) may determine that the object has been prioritized over at least one other object. The prioritization of objects may be performed utilizing the one or more rules 1314 described above. The processor 1404 of the backend server 1122 may transmit, using the communication module 1402 (and/or the processor 1308 of the hub device 1112 may transmit, using the communication module 1304,) data to the client device 1108, where the data represents a request to modify the predefined zone to include the location. The request may ask whether the predefined zone be updated. As used for example in FIG. 30A, the request may include a statement such as “Based on your viewing history, we suggest you activate Motion Zone 2,” and a query “Would you like to active Motion Zone 2?” A user may select an option to confirm activation of “Motion Zone 2,” which is depicted in step 3010 of FIG. 30A. Based on the user selection, the zone modification may be performed. As shown at step 3015 of FIG. 30A, Zone 2 has been activated in response to the user selection.

FIG. 30B illustrates another example of motion zone modification based on the ranking data 1320 according to various aspects of the present disclosure. FIG. 30B represents a progression starting at step 3050 through 3060. At step 3050, FIG. 30B depicts a field of view of a camera, a motion sensor, and/or an A/V recording and communication device 1102. For example, the A/V recording and communication device 1102 may be associated with a field of view that may include one or more zones 3030. A state indicator 3040 may be associated with one or more of the zones. The state indicator 3040 may provide an indication as to aspects of the state of a particular zone. For example, the state indicator 3040 may indicate whether the zone is activated (e.g., “on”) or deactivated (e.g., “off”). Additionally, or alternatively, the state indicator 3040 may indicate a motion sensitivity associated with a particular zone. As shown in FIG. 30B at step 3050, zone 1 has a state indicator 3040 showing that zone 1 is activated, while zone 2 has a state indicator 3040 showing that zone 2 is deactivated.

Based on image 1224 generated by the A/V recording and communication device 1102, the processor 1404 of the backend server 1122 (and/or the processor 1308 of the hub device 1112) may identify an object depicted in the image data 1224 and determine that the object is located at a location outside a predefined zone of the field of view of a camera of the A/V recording and communication device 1102. Using FIG. 30B as an example, the predefined zone may be a zone including zone 1. The location of the object may be determined to be in, for example, zone 2. The processor 1404 of the backend server 1122 (and/or the processor 1308 of the hub device) may determine that the object has been prioritized over at least one other object. The prioritization of objects may be performed utilizing the one or more rules 1314 described above. The processor 1404 of the backend server 1122 may transmit, using the communication module 1402 (and/or the processor 1308 of the hub device 1112 may transmit, using the communication module 1304,) data to the client device 1108, where the data represents a request to modify the predefined zone to include the location. The request may ask whether the predefined zone be updated. As used for example in FIG. 30B, the request may include a statement such as “Based on your viewing history, we suggest you activate Motion Zone 2,” and a query “Would you like to active Motion Zone 2?” A user may select an option to confirm activation of “Motion Zone 2,” which is depicted in step 3055 of FIG. 30B. Based on the user selection, the zone modification may be performed. As shown at step 3060 of FIG. 30B, Zone 2 has been activated in response to the user selection. In examples, the zones may be static. In other examples, the zones may be dynamic such that the shape and/or area of the field of view associated with one or more of the zones may change. For example, a user may manipulate the shape of one or more of the zones, such as via touch input received via the client device 1108/1110.

Each of the processes described herein, including the processes 3100, 3200, 3300, and 3400, are illustrated as a collection of blocks in a logical flow graph, which represent a sequence of operations that may be implemented in hardware, software, or a combination thereof. In the context of software, the blocks represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks may be combined in any order and/or in parallel to implement the processes. Additionally, any number of the described blocks may be optional and eliminated to implement the processes.

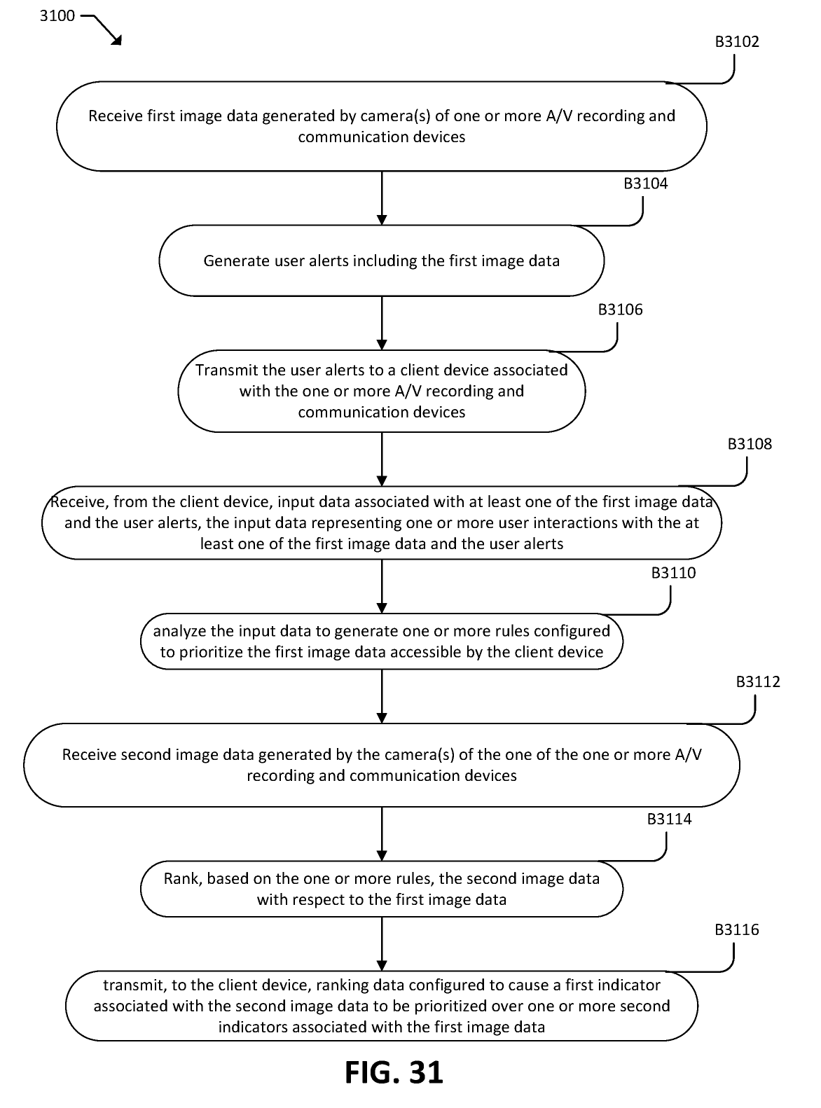

Now with reference to FIG. 31, FIG. 31 is a flowchart illustrating a process 3100 for intelligent event summary, notifications, and video presentation for A/V recording and communication devices according to various aspects of the present disclosure. The process 3100, at block B3102, receives first image data generated by cameras of one or more A/V recording and communication devices. For example, the processor 1406 of the backend server 1122 may receive, using the communication module 1402 (and/or the processor 1308 of the hub device 1112 may receive, using the communication module 1304), the first image data 1224 generated by the cameras 1204 of one or more A/V recording and communication devices 1102 (and/or similarly cameras of the A/V recording and communication devices 1128). The first image data 1224 may be received based on and/or in response to the one or more of the first A/V recording and communication devices 1102 generating the first image data 1224. By way of example, the camera 1204 and/or the motion sensor 1208 of a first A/V recording and communication device 1102 may detect motion within the field of view of the camera 1204 and/or the field of view of the motion sensor 1208, respectively. Based at least in part on the detection of the motion, the camera 1204 may capture images and generate corresponding image data 1224 of the field of view of the camera 1204.

The process 3100, at block B3104, generates user alerts including the first image data. For example, the processor 1406 of the backend server 1122 (and/or the processor 1308 of the hub device 1112) may generate user alerts 1234 including the first image data 1224. Generating the user alerts 1234 may be based on and/or in response to the cameras 1204 of the one or more A/V recording and communication devices 1102 generating the first image data 1224. The user alerts 1234 may include information such as, for example, text associated with the detection of motion, such as “There is motion at your front door.” The information may additionally, or alternatively, include a time of day and/or date that the motion was detected and/or when the user alert 1234 was received at a client device 1108, 1110. The information may additionally, or alternatively, include an amount of time since the motion was detected and/or when the user alert 1234 was received at the client device 1108, 1110. The user alert 1234 may additionally include a selectable portion that, when selected, may cause the client application 1518 stored on and/or accessed by the client device 1108, 1110 to be enabled and/or activate.

In some embodiments, the A/V recording and communication device(s) 1102 may generate the user alert 1238, transmit to the user alert 1238 to the backend server 1122 and/or the hub device 1112, and the backend server 1122 and/or the hub device 1112 may forward the user alert 1234 to the client device 1108, 1110.

The process 3100, at block B3106, transmits the user alerts to a client device associated with the one or more A/V recording and communication devices. For example, the processor 1406 of the backend server 1122 may transmit, using the communication module 1402 (and/or the processor 1308 of the hub device 1112 may transmit, using the communication module 1304), the user alerts 1234 to the client device 1108, 1110 associated with the one or more A/V recording and communication devices 1102. The user alert 1234 may be generated by the hub device 1112, the backend server 1122, and/or the A/V recording and communication device 1102 and transmitted to the client device 1108, 1110 associated with the A/V recording and communication device 1102 (in some embodiments, via the backend server 1122 and/or the hub device 1112, as described herein). A user of the client device 1108, 1110 may select the user alert 1234, which may establish a communication channel between the A/V recording and communication device 1102 and the client device 1108, 1110. The communication channel may allow the user to view, via the client device 1108, 1110, a live or near-live video feed of the field of view as captured from the camera 1204 of the A/V recording and communication device 1102. In addition, the communication channel may include a two-way audio communication between the client device 1108, 1110 and the A/V recording and communication device 1102.

The process 3100, at block B3108, receives, from the client device, input data associated with at least one of the first image data and the user alerts, the input data representing one or more user interactions with the at least one of the first image data and the user alerts. For example, the processor 1406 of the backend server 1122 may receive, using the communication module 1402 (and/or the processor 1308 of the hub device 1112 may receive, using the communication module 1304), and from the client device 1108, 1110, user input data 1316 associated with at least one of the first image data 1224 and the user alerts 1234. The user input data 1316 may represent one or more user interactions with the at least one of the first image data 1224 and the user alerts 1234. The one or more user interactions may include, for example, playing a video, pausing a video, stopping a video, restarting a video, sending a storage location indicator corresponding to the video from the client device 1108, 1110, downloading a video, sharing a video, posting a video to a social network, interacting with an application of the client device 1108, 1110, and/or deleting the video.

The process 3100, at block B3110, analyzes the input data to generate one or more rules configured to prioritize the first image data accessible by the client device. For example, the processor 1406 of the backend server 1122 (and/or the processor 1308 of the hub device 1112), may analyze the user input data 1316 to generate one or more rules 1314 configured to prioritize the first image data 1224 accessible by the client device 1108, 1110.

The process 3100, at block B3112, receives second image data generated by the cameras of one of the one or more A/V recording and communication devices. For example, the processor 1406 of the backend server 1122 may receive, using the communication module 1402 (and/or the processor 1308 of the hub device 1112 may receive, using the communication module 1304), second image data 1224 generated by the camera(s) 1204 of one of the one or more A/V recording and communication devices 1102. Receiving the second image data 1224 may be based on and/or in response to one of the one or more A/V recording and communication devices 1102 generating the second image data 1224.

The process 3100, at block B3114, ranks, based on the one or more rules, the second image data with respect to the first image data. For example, the processor 1406 of the backend server 1122 (and/or the processor 1308 of the hub device 1112) may rank the second image data 1224 with respect to the first image data 1224. The ranking may be based on the one or more rules 1314.

In some embodiments, based on the rules 1314, the first image data 1224 and the second image data 1224 may be assigned a rank, such as a number, a percentage, or another value, and the sorting may be done automatically using the rank (e.g., the image data may be sorted in descending order based on the rank).

The process 3100, at block B3116, transmits, to the client device, ranking data configured to cause a first indicator associated with the second image data to be prioritized over one or more second indicators associated with the first image data. For example, the processor 1406 of the backend server 1122 may transmit, using the communication module 1402 (and/or the processor 1308 of the hub device 1112 may transmit, using the communication module 1304), and to the client device 1108, 1110, ranking data 1320 configured to cause a first indicator associated with the second image data 1224 to be prioritized over one or more second indicators associated with the first image data 1224.

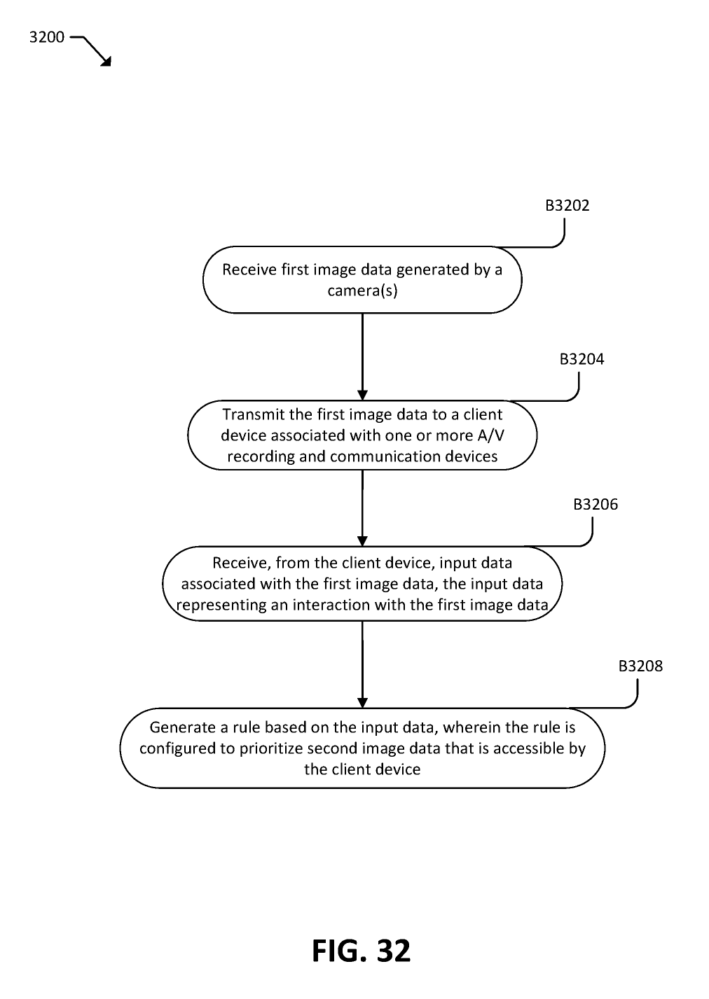

Now with reference to FIG. 32, FIG. 32 is a flowchart illustrating another process 3200 for intelligent event summary, notifications, and video presentation for A/V recording and communication devices according to various aspects of the present disclosure. The process 3200, at block B3202, receives first image data generated by cameras. For example, the processor 1406 of the backend server 1122 may receive, using the communication module 1402 (and/or the processor 1308 of the hub device 1112 may receive, using the communication module 1304), first image data 1224 generated by the cameras 1204. In some embodiments, the first image data 1224 may only be generated by one camera 1204. In addition to the image data 1224, any other data may be generated and received from the A/V recording and communication device(s) 1102.

The process 3200, at block B3204, transmits the first image data to a client device associated with one or more A/V recording and communication devices. For example, the processor 1406 of the backend server 1122 may transmit, using the communication module 1402 (and/or the processor 1308 of the hub device 1112 may transmit, using the communication module 1304), the first image data 1224 (and/or the other data) to the client device 1108, 1110 associated with one or more A/V recording and communication devices 1102.

The process 3200, at block B3206, receives, from the client device, input data associated with the first image data, the input data representing an interaction with the first image data. For example, the processor 1406 of the backend server 1122 may receive, using the communication module 1402 (and/or the processor 1308 of the hub device 1112 may receive, using the communication module 1304), and from the client device 1108, 1110, user input data 1316 associated with the first image data 1224. The user input data 1316 may represent an interaction with the first image data 1224. The interaction may include, for example, playing a video, pausing a video, stopping a video, restarting a video, sending a storage location indicator corresponding to the video from the client device 1108, 1110, downloading a video, sharing a video (e.g., with the user's neighborhood), posting a video to a social network, interacting with an application of the client device 1108, 1110, deleting the video, and/or any other interaction with the image data 1224 (or other data generated by the A/V recording and communication device 1102, such as the audio data 1228).

The process 3200, at block B3208, generates a rule based on the input data, wherein the rule is configured to prioritize second image data that is accessible by the client device. For example, the processor 1406 of the backend server 1122 (and/or the processor 1308 of the hub device 1112) may generate a rule 1314 based on the user input data 1316. The rule 1314 may be configured to prioritize the second image data 1224 that is accessible by the client device 1108, 1110.

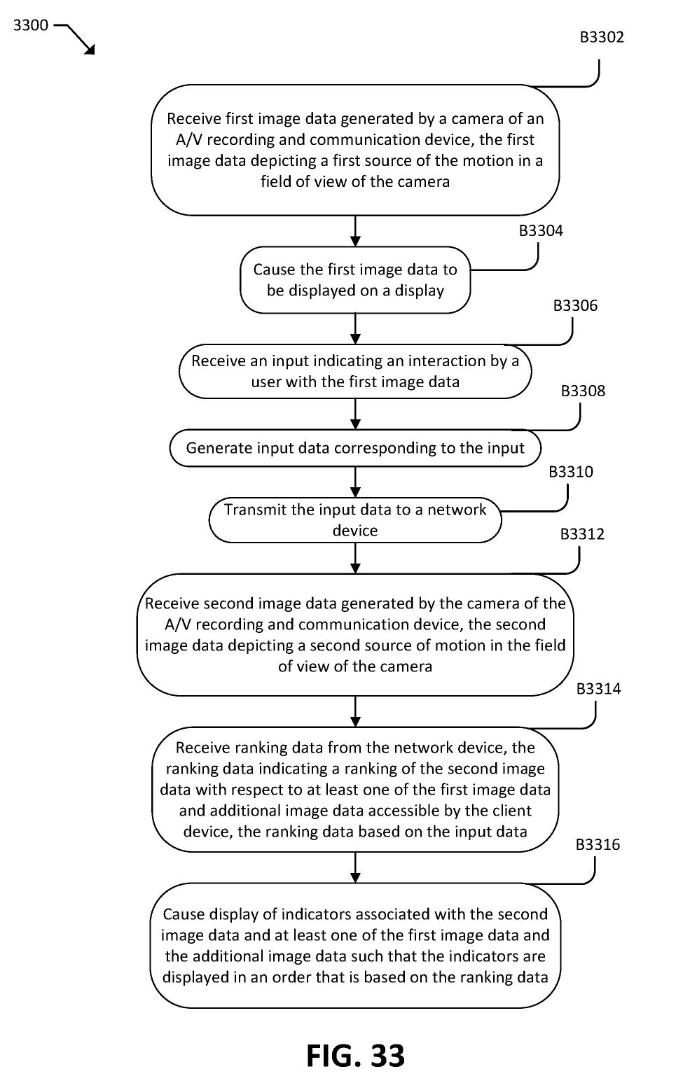

Now with reference to FIG. 33, FIG. 33 is a flowchart illustrating another process 3300 for intelligent event summary, notifications, and video presentation for A/V recording and communication devices according to various aspects of the present disclosure. The process 3300, at block B3302, receives first image data generated by a camera of an A/V recording and communication device, the first image data depicting a first source of the motion in a field of view of the camera. For example, the processor 1512 of the client device 1108, 1110 may receive, using the communication module 1510, first image data 1224 depicting a first source of motion in a field of view of the camera 1204. Receiving the first image data 1224 may be based on and/or in response to an A/V recording and communication device 1102 detecting motion. The processor 1512 of the client device 1108, 1110 may receive the first image data 1224 from the A/V recording and communication device 1102, the backend server 1122, and/or the hub device 1112.

The process 3300, at block B3304, causes the first image data to be displayed on a display. For example, the processor 1512 of the client device 1108, 1110 may cause the first image data 1224 to be displayed on a display 1520 of the client device 1108, 1110.

The process 3300, at block B3306, receives an input indicating an interaction by a user with the first image data. For example, the processor 1512 of the client device 1108, 1110 may receive, using the communication module 1510, an input indicating an interaction by a user with the first image data 1224. The interaction may include, for example, playing a video, pausing a video, stopping a video, restarting a video, sending a storage location indicator corresponding to the video from the client device 1108, 1110, downloading a video, sharing a video, posting a video to a social network, interacting with an application of the client device 1108, 1110, and/or deleting the video, among other possible interactions.

The process 3300, at block B3308, generates input data corresponding to the input. For example, the processor 1512 of the client device 1108, 1110 may generate user input data 1316 corresponding to the input.

The process 3300, at block B3310, transmits the input data to a network device. For example, the processor 1512 of the client device 1108, 1110 may transmit, using the communication module 1510 the input data 1228 to a network device, such as a backend server 1122 and/or a smart-home hub device 1112.

The process 3300, at block B3312, receives second image data generated by the camera of the A/V recording and communication device, the second image data depicting a second source of motion in the field of view of the camera. For example, the processor 1512 of the client device 1108, 1110 may receive, using the communication module 1510, second image data 1224 generated by the camera 1204 of the A/V recording and communication device 1102 (and/or by another camera of another A/V recording and communication device). The second image data 1224 may depict a second source of motion in the field of view of the camera 1204. Receiving the second image data 1224 may be based on and/or in response to the A/V recording and communication device 1102 detecting motion. The processor 1512 of the client device 1108, 1110 may receive the second image data 1224 from the A/V recording and communication device 1102, the backend server 1122, and/or the hub device 1112.

The process 3300, at block B3314, receives ranking data from the network device, the ranking data indicating a ranking of the second image data with respect to at least one of the first image data and additional image data accessible by the client device, the ranking data based on the input data. For example, the processor 1512 of the client device 1108, 1110 may receive, using the communication module 1510, ranking data 1320 from the backend server 1122 and/or the hub device 1112. The ranking data 1320 may indicate a ranking of the second image data 1224 with respect to at least one of the first image data 1224 and additional image data 1224 accessible by the client device 1108, 1110.

The process 3300, at block B3316, causes display of indicators associated with the second image data and at least one of the first image data and the additional image data such that the indicators are displayed in an order that is based on the ranking data. For example, the processor 1512 of the client device 1108, 1110 may cause display of indicators (e.g., indicators 2804-2814 of FIG. 28) associated with the second image data 1224 and at least one of the first image data 1224 and the additional image data 1224, where the indicators may be displayed in an order that is based on the ranking data 1320.

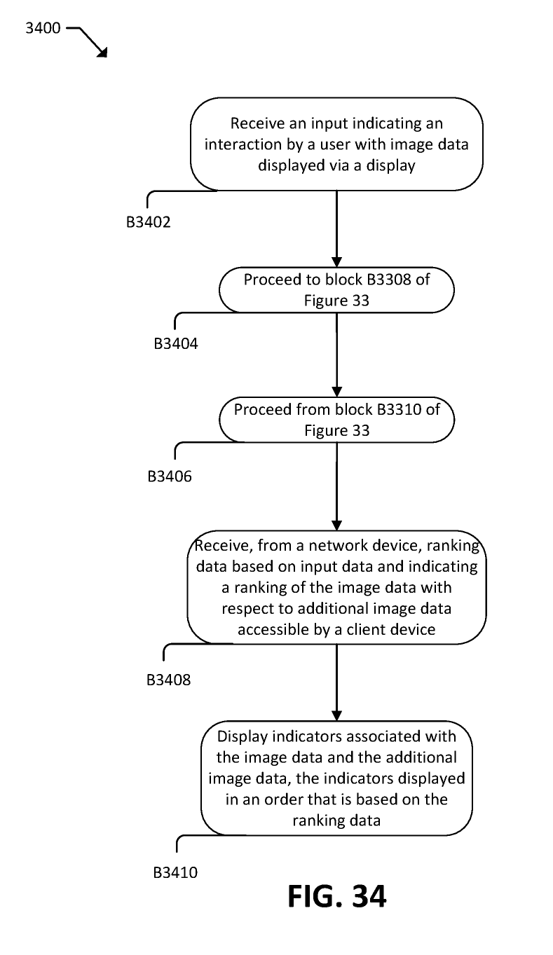

Now with reference to FIG. 34, FIG. 34 is a flowchart illustrating another process 3400 for intelligent event summary, notifications, and video presentation for A/V recording and communication devices according to various aspects of the present disclosure. The process 3400, at block B3402, receives an input indicating an interaction by a user with image data displayed via a display. For example, the processor 1512 of the client device 1108, 1110 may receive an input indicating an interaction by a user with image data 1224 displayed via the display 1520. The interaction may include, for example, playing a video, pausing a video, stopping a video, restarting a video, sending a storage location indicator corresponding to the video from the client device 1108, 1110, downloading a video, sharing a video, posting a video to a social network, interacting with an application of the client device 1108, 1110, and/or deleting the video.

The process 3400, at block B3404, may proceed to block B3308 of the example process 3300 of FIG. 33, described above.

The process 3400, at block B3406 may proceed from block B3310 of the example process 3300 of FIG. 33, described above.

The process 3400, at block B3408, receives, from a network device, ranking data based on input data and indicating a ranking of the image data with respect to additional image data accessible by a client device. For example, the processor 1512 of the client device 1108, 1110 may receive, using the communication module 1510, and from the backend server 1122 and/or the hub device 1112, ranking data 1320 based on the user input data 1316 and indicating a ranking of the image data 1224 with respect to additional image data 1224 accessible by the client device 1108, 1110.

The process 3400, at block B3410, displays indicators associated with the image data and the additional image data, the indicators displayed in an order that is based on the ranking data. For example, the processor 1512 of the client device 1108, 1110 may display indicators associated with the image data 1224 and the additional image data 1224. The indicators may be displayed in an order that is based on the ranking data 1320.

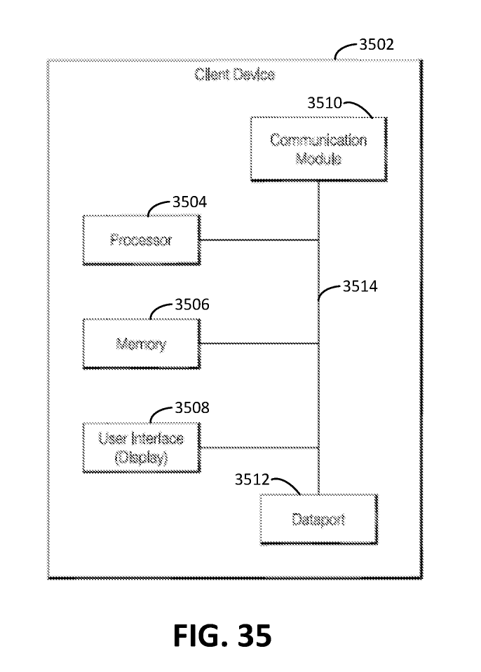

FIG. 35 is a functional block diagram of a client device 3502 on which the present embodiments may be implemented according to various aspects of the present disclosure. The user's client device 114 described with reference to FIG. 1 and/or the client device 1108, 1110 described with reference to FIG. 15 may include some or all of the components and/or functionality of the client device 3502. The client device 3502 may comprise, for example, a smartphone.

With reference to FIG. 35, the client device 3502 includes a processor 3504, a memory 3506, a user interface 3508, a communication module 3510, and a dataport 3512. These components are communicatively coupled together by an interconnect bus 3514. The processor 3504 may include any processor used in smartphones and/or portable computing devices, such as an ARM processor (a processor based on the RISC (reduced instruction set computer) architecture developed by Advanced RISC Machines (ARM).). In some embodiments, the processor 3504 may include one or more other processors, such as one or more conventional microprocessors, and/or one or more supplementary co-processors, such as math co-processors.

The memory 3506 may include both operating memory, such as random-access memory (RAM), as well as data storage, such as read-only memory (ROM), hard drives, flash memory, or any other suitable memory/storage element. The memory 3506 may include removable memory elements, such as a CompactFlash card, a MultiMediaCard (MMC), and/or a Secure Digital (SD) card. In some embodiments, the memory 3506 may comprise a combination of magnetic, optical, and/or semiconductor memory, and may include, for example, RAM, ROM, flash drive, and/or a hard disk or drive. The processor 3504 and the memory 3506 each may be, for example, located entirely within a single device, or may be connected to each other by a communication medium, such as a USB port, a serial port cable, a coaxial cable, an Ethernet-type cable, a telephone line, a radio frequency transceiver, or other similar wireless or wired medium or combination of the foregoing. For example, the processor 3504 may be connected to the memory 3506 via the dataport 3512.

The user interface 3508 may include any user interface or presentation elements suitable for a smartphone and/or a portable computing device, such as a keypad, a display screen, a touchscreen, a microphone, and a speaker. The communication module 3510 is configured to handle communication links between the client device 3502 and other, external devices or receivers, and to route incoming/outgoing data appropriately. For example, inbound data from the dataport 3512 may be routed through the communication module 3510 before being directed to the processor 3504, and outbound data from the processor 3504 may be routed through the communication module 3510 before being directed to the dataport 3512. The communication module 3510 may include one or more transceiver modules capable of transmitting and receiving data, and using, for example, one or more protocols and/or technologies, such as GSM, UMTS (3GSM), IS-95 (CDMA one), IS-2000 (CDMA 2000), LTE, FDMA, TDMA, W-CDMA, CDMA, OFDMA, Wi-Fi, WiMAX, or any other protocol and/or technology.

The dataport 3512 may be any type of connector used for physically interfacing with a smartphone and/or a portable computing device, such as a mini-USB port or an IPHONE®/IPOD® 30-pin connector or LIGHTNING® connector. In other embodiments, the dataport 3512 may include multiple communication channels for simultaneous communication with, for example, other processors, servers, and/or client terminals.

The memory 3506 may store instructions for communicating with other systems, such as a computer. The memory 3506 may store, for example, a program (e.g., computer program code) adapted to direct the processor 3504 in accordance with the present embodiments. The instructions also may include program elements, such as an operating system. While execution of sequences of instructions in the program causes the processor 3504 to perform the process steps described herein, hard-wired circuitry may be used in place of, or in combination with, software/firmware instructions for implementation of the processes of the present embodiments. Thus, the present embodiments are not limited to any specific combination of hardware and software.

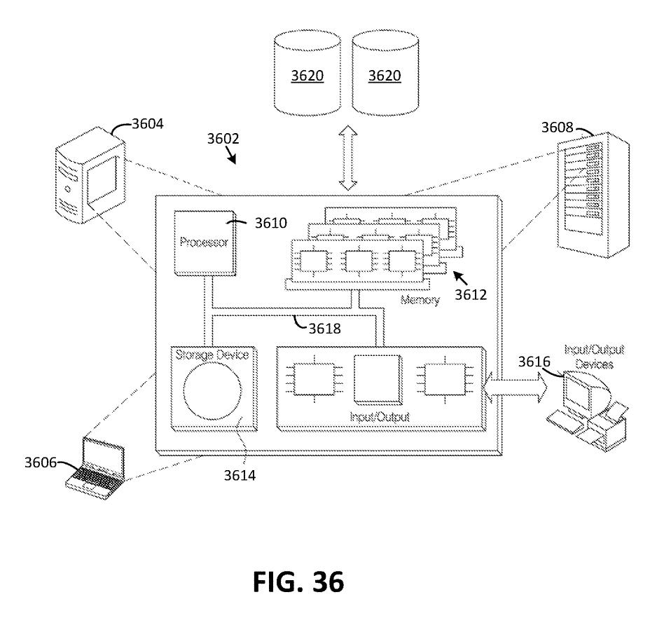

FIG. 36 is a functional block diagram of a general-purpose computing system on which the present embodiments may be implemented according to various aspects of the present disclosure. The computer system 3602 may be embodied in at least one of a personal computer (also referred to as a desktop computer) 3604, a portable computer (also referred to as a laptop or notebook computer) 3606, and/or a server 3608. A server is a computer program and/or a machine that waits for requests from other machines or software (clients) and responds to them. A server typically processes data. The purpose of a server is to share data and/or hardware and/or software resources among clients. This architecture is called the client—server model. The clients may run on the same computer or may connect to the server over a network. Examples of computing servers include database servers, file servers, mail servers, print servers, web servers, game servers, and application servers. The term server may be construed broadly to include any computerized process that shares a resource to one or more client processes.

The computer system 3602 may execute at least some of the operations described above. The computer system 3602 may include at least one processor 3610, memory 3612, at least one storage device 3614, and input/output (I/O) devices 3616. Some or all of the components 3610, 3612, 3614, 3616 may be interconnected via a system bus 3618. The processor 3610 may be single- or multi-threaded and may have one or more cores. The processor 3610 may execute instructions, such as those stored in the memory 3612 and/or in the storage device 3614. Information may be received and output using one or more I/O devices 3616.

The memory 3612 may store information, and may be a computer-readable medium, such as volatile or non-volatile memory. The storage device(s) 3614 may provide storage for the system 3602, and may be a computer-readable medium. In various aspects, the storage device(s) 3614 may be a flash memory device, a hard disk device, an optical disk device, a tape device, or any other type of storage device.

The I/O devices 3616 may provide input/output operations for the system 3602. The I/O devices 3616 may include a keyboard, a pointing device, and/or a microphone. The I/O devices 3616 may further include a display unit for displaying graphical user interfaces, a speaker, and/or a printer. External data may be stored in one or more accessible external databases 3620.

The features of the present embodiments described herein may be implemented in digital electronic circuitry, and/or in computer hardware, firmware, software, and/or in combinations thereof. Features of the present embodiments may be implemented in a computer program product tangibly embodied in an information carrier, such as a machine-readable storage device, and/or in a propagated signal, for execution by a programmable processor. Embodiments of the present method steps may be performed by a programmable processor executing a program of instructions to perform functions of the described implementations by operating on input data and generating output.

The features of the present embodiments described herein may be implemented in one or more computer programs that are executable on a programmable system including at least one programmable processor coupled to receive data and/or instructions from, and to transmit data and/or instructions to, a data storage system, at least one input device, and at least one output device. A computer program may include a set of instructions that may be used, directly or indirectly, in a computer to perform a certain activity or bring about a certain result. A computer program may be written in any form of programming language, including compiled or interpreted languages, and it may be deployed in any form, including as a stand-alone program or as a module, component, subroutine, or other unit suitable for use in a computing environment.

Suitable processors for the execution of a program of instructions may include, for example, both general and special purpose processors, and/or the sole processor or one of multiple processors of any kind of computer. Generally, a processor may receive instructions and/or data from a read only memory (ROM), or a random-access memory (RAM), or both. Such a computer may include a processor for executing instructions and one or more memories for storing instructions and/or data.

Generally, a computer may also include, or be operatively coupled to communicate with, one or more mass storage devices for storing data files. Such devices include magnetic disks, such as internal hard disks and/or removable disks, magneto-optical disks, and/or optical disks. Storage devices suitable for tangibly embodying computer program instructions and/or data may include all forms of non-volatile memory, including for example semiconductor memory devices, such as EPROM, EEPROM, and flash memory devices, magnetic disks such as internal hard disks and removable disks, magneto-optical disks, and CD-ROM and DVD-ROM disks. The processor and the memory may be supplemented by, or incorporated in, one or more ASICs (application-specific integrated circuits).

To provide for interaction with a user, the features of the present embodiments may be implemented on a computer having a display device, such as an LCD (liquid crystal display) monitor, for displaying information to the user. The computer may further include a keyboard, a pointing device, such as a mouse or a trackball, and/or a touchscreen by which the user may provide input to the computer.

The features of the present embodiments may be implemented in a computer system that includes a back-end component, such as a data server, and/or that includes a middleware component, such as an application server or an Internet server, and/or that includes a front-end component, such as a client computer having a graphical user interface (GUI) and/or an Internet browser, or any combination of these. The components of the system may be connected by any form or medium of digital data communication, such as a communication network. Examples of communication networks may include, for example, a LAN (local area network), a WAN (wide area network), and/or the computers and networks forming the Internet.

The computer system may include clients and servers. A client and server may be remote from each other and interact through a network, such as those described herein. The relationship of client and server may arise by virtue of computer programs running on the respective computers and having a client-server relationship to each other.

As used herein, the phrases “at least one of A, B and C,” “at least one of A, B, or C,” and “A, B, and/or C” are synonymous and mean logical “OR” in the computer science sense.

Thus, each of the foregoing phrases should be understood to read on (A), (B), (C), (A and B), (A and C), (B and C), and (A and B and C), where A, B, and C are variables representing elements or features of the claim. Also, while these examples are described with three variables (A, B, C) for ease of understanding, the same interpretation applies to similar phrases in these formats with any number of two or more variables.

The above description presents the best mode contemplated for carrying out the present embodiments, and of the manner and process of practicing them, in such full, clear, concise, and exact terms as to enable any person skilled in the art to which they pertain to practice these embodiments. The present embodiments are, however, susceptible to modifications and alternate constructions from those discussed above that are fully equivalent. Consequently, the present invention is not limited to the particular embodiments disclosed. On the contrary, the present invention covers all modifications and alternate constructions coming within the spirit and scope of the present disclosure. For example, the steps in the processes described herein need not be performed in the same order as they have been presented, and may be performed in any order(s). Further, steps that have been presented as being performed separately may in alternative embodiments be performed concurrently. Likewise, steps that have been presented as being performed concurrently may in alternative embodiments be performed separately.

What is claimed is:

1. A method for presenting a plurality of events captured by a set of audio/video (A/V) recording and communication devices, the method comprising:
receiving first video data representative of a first event of the plurality of events from a first A/V recording and communication device of the set of A/V recording and communication devices;
receiving second video data representative of a second event of the plurality of events from a second A/V recording and communication device of the set of A/V recording and communication devices;
analyzing the first video data and the second video data;
based at least in part on the analyzing, determining at least a first characteristic from among a plurality of characteristics associated with the first event and at least a second characteristic from among the plurality of characteristics associated with the second event;
prioritizing at least the first event and the second event based at least in part on a set of rules related to the plurality of characteristics to create an ordered list, the ordered list including a plurality of list entries including at least a first list entry representative of the first event and a second list entry representative of the second event; and
transmitting the ordered list to a client device for display on a display of the client device.

2. The method of claim 1, wherein at least some of the plurality of list entries are in non-chronological order.

3. The method of claim 1, wherein the determining the at least one first characteristic from among the plurality of characteristics comprises:
determining that first video data is representative of an object;
identifying a class of the object from at least one of a person, a parcel, an animal, or a vehicle; and
determining that the class of the object is one of the at least one first characteristics.

4. The method of claim 3, wherein, when the class of the object is a person, the determining the at least one first characteristic further comprises:
identifying a particular member of the class using at least one of biometric data analysis, computer vision processing, or image processing.

5. The method of claim 1, further comprising:
receiving data representative of a user tag of an object represented by one of the first video data or the second video data,
wherein the prioritizing at least the first event and the second event is based at least in part on the user tag of the object.

6. The method of claim 5, further comprising:
transmitting the user tag of the object to at least one A/V recording and communication device in the set of A/V recording and communication devices or at least one A/V recording and communication device that is not in the set of A/V recording and communication devices.

7. The method of claim 1, wherein the prioritizing at least the first event and the second event based at least in part on the set of rules related to the plurality of characteristics to create the ordered list comprises:
assigning a higher priority to a first set of events, from among the plurality of events, that are associated with video data that is not representative of one or more persons; and
assigning a lower priority to a second set of events, from among the plurality of events, that are associated with video data that is not representative of one or more persons.

8. The method of claim 7, wherein the prioritizing at least the first event and the second event based at least in part on the set of rules related to the plurality of characteristics to create the ordered list further comprises:
assigning a higher priority to a first subset of events, from among the first set of events, that are associated with video data that is representative of one or more specific or predetermined persons; and
assigning a lower priority to a second subset of events, from among the first set of events, that are associated with video data that is not representative of one or more specific or predetermined persons.

9. The method of claim 7, wherein the prioritizing at least the first event and the second event based at least in part on the set of rules related to the plurality of characteristics to create the ordered list further comprises:
assigning a higher priority to a first subset of events, from among the first set of events, that are associated with video data that is not representative of one or more specific or predetermined persons; and
assigning a lower priority to a second subset of events, from among the first set of events, that are associated with video data that is representative of one or more specific or predetermined persons.

10. The method of claim 1, wherein the prioritizing at least the first event and the second event based at least in part on the set of rules related to the plurality of characteristics to create the ordered list comprises:
assigning a higher priority to events, from among the plurality of events, when video data associated with the events is representative of a same person more than a predefined number of times within a predefined length of time.

11. The method of claim 1, wherein the first A/V recording and communication device is assigned a first priority and the second A/V recording and communication device is assigned a second priority, and wherein the prioritizing at least the first event and the second event based at least in part on the set of rules related to the plurality of characteristics to create the ordered list is based at least in part on the first priority and the second priority.

12. The method of claim 1, wherein the prioritizing at least the first event and the second event based at least in part on the set of rules related to the plurality of characteristics to create the ordered list comprises:
assigning a higher priority to a first set of events, from among the plurality of events, that are associated with video data representative of motion in a field of view of a camera; and
assigning a lower priority to a second set of events, from among the plurality of events, that are associated with video data not representative of motion in a field of view of a camera.

13. The method of claim 1, wherein the prioritizing at least the first event and the second event based at least in part on the set of rules related to the plurality of characteristics to create the ordered list comprises:
determining a first amount of bandwidth required to transmit the first video data to the client device and a second amount of bandwidth required to transmit the second video data to the client device; and
prioritizing at least the first event and the second event based on the first amount of bandwidth and the second amount of bandwidth.

14. The method of claim 1, wherein the prioritizing at least the first event and the second event based at least in part on the set of rules related to the plurality of characteristics to create the ordered list comprises:
assigning priorities to the plurality of events based on a time of day when each of the plurality of events were captured.

15. The method of claim 1, wherein the prioritizing at least the first event and the second event based at least in part on the set of rules related to the plurality of characteristics to create the ordered list comprises:
assigning priorities to the plurality of events based on a location of the client device.

16. A system comprising:
one or more communication modules;
one or more processors; and
one or more non-transitory machine-readable media storing instructions that, when executed by the one or more processors, cause the one or more processor to perform operations comprising:
receiving, using the one or more communication modules, first video data representative of a first event from a first A/V recording and communication device;
receiving, using the one or more communication modules, second video data representative of a second event from a second A/V recording and communication device;
analyzing the first video data and the second video data;
based at least in part on the analyzing, determining at least a first characteristic from associated with the first event and at least a second characteristic associated with the second event;
based at least in part on the first characteristic and the second characteristic, prioritizing the first event and the second event to create an ordered list, the ordered list including a plurality of list entries including at least a first list entry representative of the first event and a second list entry representative of the second event; and
transmitting, using the one or more communication modules, the ordered list to a client device for display on a display of the client device.

17. The system of claim 16, wherein the one or more non-transitory machine-readable media further store instructions that, when executed by the one or more processors, cause the one or more processors to perform operations comprising:
learning, based at least in part on user behavior, user preferences,
wherein the prioritizing the first event and the second event to create the ordered list is based at least in part on the user preferences.

18. The system of claim 0, wherein the learning the user preferences comprises:
tracking a first amount of time that a user spends viewing first video footage associated with a third event;
tracking a second amount of time that user spends viewing second video footage associated with a fourth event;
determining that the first amount of time is greater than the second amount of time;
determining a third characteristic associated with the third event;
determining a fourth characteristic associated with the fourth event; and
based at least in part on the first amount of time being greater than the second amount of time, learning to associate a higher priority to events associated with the third characteristic than to events associated with the fourth characteristic for the user.

19. The system of claim 16, wherein the first characteristic and the second characteristic include at least one of video data that is representative of one or more persons, video data that is representative of one or more specific or predetermined persons, or video data is representative of motion in a field of view of a camera.

20. The system of claim 16, wherein the prioritizing the first event and the second event to create an ordered list comprises:
determining that the first video data is representative of at least one of a weapon or a burglary tool; and
based at least in part on the first video data being representative of the at least one of the weapon or the burglary tool, assigning a higher priority to the first event than the second event.
